(19) United States
(12) Patent Application Publication
(10) Pub. No.: US 2026/0016671 A1
(43) Pub. Date: Jan. 15, 2026

(54) APPARATUS, AND SYSTEM OF AN OPTICAL LENS

(71) Applicant: HYPERVISION LTD, Yokneam Illit (IL)

(72) Inventors: Arthur Rabner, Yokneam Illit (IL); Shimon Grabarnik, Yokneam Illit (IL)

(73) Assignee: HYPERVISION LTD, Yokneam Illit (IL)

(21) Appl. No.: 18/880,517

(22) PCT Filed: Jul. 6, 2023
(86) PCT No.: PCT/IB2023/057013

§ 371 Date: Dec. 31, 2024

Related U.S. Application Data
(60) Provisional application No. 63/367,916, filed on Jul. 8, 2022.

(51) Int. Cl. G02B 17/08; G02B 27/01

(52) U.S. Cl. CPC G02B 17/0856; G02B 27/0172

(57) ABSTRACT

For example, a catadioptric lens may configured to direct light from a display to an eye of a user. The catadioptric lens may include a catadioptric folder configured to fold an optical path of the catadioptric lens. For example, the catadioptric folder may include a first surface including a semi-reflective surface; a second surface including a reflective polarizer surface, the second surface opposite to the first surface; and a retarder between the first surface and the second surface, the retarder configured to convert a polarization of the light in a path between the first surface and the second surface. For example, the first and second surfaces may be configured such that, over at least 10% of the catadioptric folder, an inter-surface distance of the catadioptric folder is monotonically decreasing with a distance from a central axis of the catadioptric lens.

### CROSS REFERENCE

This application claims the benefit of and priority from U.S. Provisional Patent Application No. 63/367,916 entitled “DIFFERENTIAL PIXEL PERDEGREE WIDE FIELD OF VIEW PANCAKE LENS COMPATIBLE WITH STITCHED MULTIPLE VISUAL MODULES”, filed Jul. 8, 2022, the entire disclosure of which is incorporated herein by reference.

### TECHNICAL FIELD

Aspects described herein generally relate to an optical lens.

### BACKGROUND

A Near Eye Display (NED) device and/or by a Head Mounted Display (HMD) device may be mounted on a head of a user, e.g., in front of the eye/eyes of the user.

The HMD and/or the NED may be used to display an image to the eyes of the user.

The HMD and/or the NED may be used, for example, for virtual reality games, augmented reality, simulators, metaverse applications, and the like.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic illustration of a system, in accordance with some demonstrative aspects.

FIG. 2 is a schematic illustration of a system, in accordance with some demonstrative aspects.

FIG. 3 is a schematic illustration of a system, in accordance with some demonstrative aspects.

FIG. 4 is a schematic illustration of a system, in accordance with some demonstrative aspects.

FIG. 5 is a schematic illustration of a system, in accordance with some demonstrative aspects.

FIG. 6 is a schematic illustration of a system, in accordance with some demonstrative aspects.

FIG. 7 is a schematic illustration of a system, in accordance with some demonstrative aspects.

FIG. 8A and FIG. 8B are schematic illustrations of a system, in accordance with some demonstrative aspects.

FIG. 9A is a schematic illustration of a system, in accordance with some demonstrative aspects.

FIG. 9B is a schematic illustration of a first graph depicting transmissivity of a semi-reflective surface of the system of FIG. 9A, and a second graph depicting reflectivity of the semi-reflective surface of the system of FIG. 9A, in accordance with some demonstrative aspects.

FIG. 10 is a schematic illustration of a system, in accordance with some demonstrative aspects.

FIG. 11 is a schematic illustration of a system, in accordance with some demonstrative aspects.

FIG. 12 is a schematic illustration of a system, in accordance with some demonstrative aspects.

FIG. 13 is a schematic illustration of a system, in accordance with some demonstrative aspects.

FIG. 14 is a schematic illustration of a first retarder, a second retarder, and a third retarder, in accordance with some demonstrative aspects.

FIG. 15 is a schematic illustration of a system, in accordance with some demonstrative aspects.

FIG. 16 is a schematic illustration of an implementation of a lens-display retarder, in accordance with some demonstrative aspects.

FIGS. 17A, 17B, 17C, 17D, 17E, 17F, and 17G are schematic illustrations of respective configurations of a system, in accordance with some demonstrative aspects.

FIG. 18 is a conceptual illustration of a mixed reality visual system, which may be implemented in accordance with some demonstrative aspects.

FIG. 19 is a conceptual illustration of a mixed reality visual system, to demonstrate a technical issue, which may be addressed in accordance with some demonstrative aspects.

FIG. 20 is a schematic illustration of a catadioptric lens including a catadioptric folder to demonstrate a technical issue, which may be addressed in accordance with some demonstrative aspects.

FIG. 21 is a schematic illustration of a system, in accordance with some demonstrative aspects.

FIG. 22 is a schematic illustration of a system, in accordance with some demonstrative aspects.

FIG. 23 is a schematic illustration of a zoom-in portion of a system, in accordance with some demonstrative aspects.

FIG. 24A is a schematic illustration of a portion of a first system, in accordance with some demonstrative aspects.

FIG. 24B is a schematic illustration of a portion of a second system, in accordance with some demonstrative aspects.

FIG. 25A, FIG. 25B, FIG. 25C, and FIG. 25D are schematic illustrations of the propagation of rays in a lens cutting area of a system, in accordance with some demonstrative aspects.

FIG. 26 is a schematic illustration of a system, in accordance with some demonstrative aspects.

FIG. 27 is a schematic illustration of a system, in accordance with some demonstrative aspects.

FIGS. 28A, 28B, 28C, 28D, and 28E, are schematic illustrations of lens Field of View (FoV) angles, in accordance with some demonstrative aspects.

FIG. 29A is a schematic illustration of a Head Mounted Display (HMD) device, in accordance with some demonstrative aspects.

FIG. 29B is a schematic illustration of a FoV of two stitched lenses of the HMD device of FIG. 29A, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities. As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., control circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

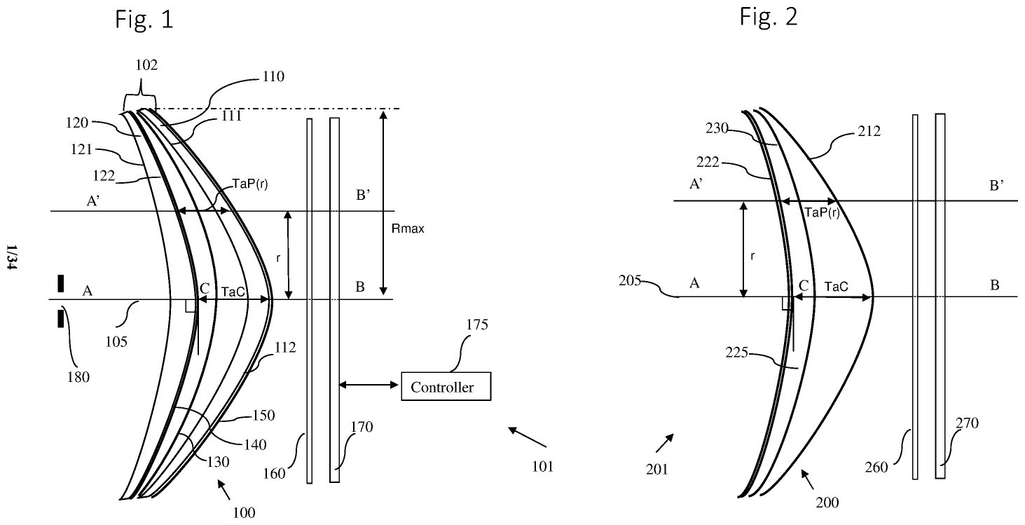

Reference is now made to FIG. 1, which schematically illustrates a system 101, in accordance with some demonstrative aspects.

In some demonstrative aspects, system 101 may include a catadioptric lens 100 and a display 170, e.g., as described below.

In some demonstrative aspects, catadioptric lens 100 may be configured to direct light from display 170 to an eye of a user, e.g., as described below.

In some demonstrative aspects, catadioptric lens 100 may be configured to direct light from display 170 to an exit pupil 180 of catadioptric lens 100, e.g., as described below. For example, exit pupil 180 may coincide with a pupil of the eye of the user.

In some demonstrative aspects, system 101 may include or may be implemented, for example, by a Near Eye Display (NED) device, and/or by a Head Mounted Display (HMD) device, which may be mounted on a head of a user, e.g., in front of the eye/eyes of the user.

In some demonstrative aspects, system 101, e.g., when implemented by an HMD device and/or an NED device, may be configured to display an image to the eye/eyes of the user.

In some demonstrative aspects, system 101, e.g., when implemented by an HMD device and/or an NED device, may be configured, for example, for virtual reality games, augmented reality, simulators, and the like.

In one example, system 101, e.g., when implemented by an HMD device and/or an NED device, may be configured to be mounted and/or positioned in front of the eyes of a user. For example, catadioptric lens 100 may be configured to be worn on a head of a user, or on a helmet, which may be worn on the head of the user.

In some demonstrative aspects, system 101, e.g., when implemented by a HMD device and/or an NED device, may be configured to display an image, e.g., a still image or a video image, to the user.

In some demonstrative aspects, system 101, e.g., when implemented by an HMD device and/or a NED device, may be implemented, for example, for displaying images of an Extended Reality (XR) application, a Virtual Reality (VR) application, an augmented reality application, a gaming application, an aviation application, a simulator, an engineering application, a medical application, and/or to display images of any other additional or alternative applications and/or implementations.

In some demonstrative aspects, system 101 may include a controller 175 configured to control display 170, for example, to display an image, e.g., a still image or a video image, which may be viewed by the eye of the user via catadioptric lens 100.

In one example, at least part of the functionality of controller 175 may be implemented by an integrated circuit, for example, a chip, e.g., a System on Chip (SoC).

In some demonstrative aspects, controller 175 may include, or may be implemented, partially or entirely, by circuitry and/or logic, e.g., one or more processors including circuitry and/or logic, and/or memory circuitry and/or logic. Additionally or alternatively, one or more functionalities of controller 175 may be implemented by logic, which may be executed by a machine and/or one or more processors, e.g., as described below.

In other aspects, controller 175 may be implemented by any other logic and/or circuitry, and/or according to any other architecture.

In one example, controller 175 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 175 may be based on any computer architecture, which may support rendering graphical information to be displayed by display 170.

In some demonstrative aspects, catadioptric lens 100 may be configured to cover a wide Filed of View (FoV) (wFoV), e.g., as described below.

In some demonstrative aspects, catadioptric lens 100 may be configured to cover the wFoV and/or to be in a compact form factor, e.g., as described below.

In some demonstrative aspects, catadioptric lens 100 may be configured to cover a wide FoV, for example, to improve a sense of immersion, presence and/or performance for the user, for example, in tasks requiring peripheral vision, for example, in virtual environments and/or in augmented video-pass-through environments, e.g., as described below.

For example, a peripheral FoV and/or a peripheral vision may include a vision perception, which may occur outside a center of gaze or outside a straight-gaze of the eye of the user. For example, the peripheral FOV may include a FoV of a peripheral vision or indirect vision, which may occur outside a point of visual fixation, e.g., away from a center of gaze or, when viewed at large angles, in (or out of) the corner of the eye.

In some demonstrative aspects, catadioptric lens 100 may be configured to cover a horizontal FoV of at least 140 degrees) (°, e.g., as described below.

In one example, catadioptric lens 100 may be configured to cover a horizontal FoV of about 170°, or even more.

In other aspects, catadioptric lens 100 may be configured to cover any other horizontal FoV.

In some demonstrative aspects, catadioptric lens 100 may be configured to cover a vertical FoV of about 160°, e.g., as described below.

In other aspects, catadioptric lens 100 may be configured to cover any other vertical FoV.

In some demonstrative aspects, catadioptric lens 100 may be configured to cover the wide FoV, for example, even without compromising a compactness, design and/or usability of catadioptric lens 100, e.g., as described below.

In some demonstrative aspects, catadioptric lens 100 may be configured to provide a technical solution to support a sharp big Eye-Box, and/or full vertical FoV vision, for example, for NED and/or HMD devices, e.g., as described below. For example, an Eye-Box of an optical system may include a 3D volume, which may be defined relative to the optical system. For example, the Eye-Box may include substantially all possible positions of the eye pupil relative to the optical system, for which an image quality provided by the optical system is in accordance with one or more criteria for the optical system, e.g., according to a specification of the optical system.

In some demonstrative aspects, catadioptric lens 100 may be configured to provide a technical solution to support an improved and/or increased sharpness acuity and/or contrast acuity, for example, to support the increased vision acuity, e.g., as described below.

In some demonstrative aspects, catadioptric lens 100 may include a catadioptric folder 102 configured to fold an optical path of the rays propagating through the catadioptric lens 100, e.g., as described below.

In some demonstrative aspects, catadioptric folder 102 may include a first surface 112, e.g., as described below.

In some demonstrative aspects, surface 112 may include a semi-reflective surface, e.g., as described below.

In one example, the semi-reflective surface may be formed by a semi-reflective coating 150, which may be, for example, formed as part of, formed on, coated on, and/or attached to, surface 112.

In some demonstrative aspects, catadioptric folder 102 may include a second surface 122, e.g., as described below.

In some demonstrative aspects, second surface 122 may be opposite to the first surface 112, e.g., as described below.

In some demonstrative aspects, surface 122 may include a reflective polarizer surface, e.g., as described below.

In one example, the reflective polarizer surface may be formed by a reflective polarizer 140, which may be, for example, formed as part of, formed on, coated on, and/or attached to, surface 122.

In some demonstrative aspects, catadioptric folder 102 may include a retarder 130 between the first surface 112 and the second surface 122, e.g., as described below.

In some demonstrative aspects, retarder 130 may include and/or may be configured as a Quarter Wave Plate (QWP) retarder, e.g., as described below.

In other aspects, retarder 130 may include any other type of retarder.

In some demonstrative aspects, retarder 130 may be configured to convert a polarization of the light in a path between the first surface 112 and the second surface 122, e.g., as described below.

In some demonstrative aspects, the first surface 112 and the second surface 122 may be configured such that, for example, over at least 10% of the catadioptric folder 102, e.g., over at least 10% of an aperture radius of the catadioptric folder 102, an inter-surface distance of the catadioptric folder 102 may be monotonically decreasing with a distance, denoted r, from a central axis 105 of the catadioptric lens 100, e.g., as described below.

In some demonstrative aspects, the first surface 112 and the second surface 122 may be configured such that, for example, over at least 20% of the catadioptric folder 102, e.g., over at least 20% of the aperture radius of the catadioptric folder 102, the inter-surface distance of the catadioptric folder 102 may be monotonically decreasing with the distance r from the central axis 105, e.g., as described below.

In some demonstrative aspects, the first surface 112 and the second surface 122 may be configured such that, for example, over at least 25% of the catadioptric folder 102, e.g., over at least 25% of the aperture radius of the catadioptric folder 102, the inter-surface distance of the catadioptric folder 102 may be monotonically decreasing with the distance r from the central axis 105, e.g., as described below.

In some demonstrative aspects, the first surface 112 and the second surface 122 may be configured such that, for example, over at least 30% of the catadioptric folder 102, e.g., over at least 30% of the aperture radius of the catadioptric folder 102, the inter-surface distance of the catadioptric folder 102 may be monotonically decreasing with the distance r from the central axis 105, e.g., as described below.

In some demonstrative aspects, the first surface 112 and the second surface 122 may be configured such that, for example, over at least 40% of the catadioptric folder 102, e.g., over at least 40% of the aperture radius of the catadioptric folder 102, the inter-surface distance of the catadioptric folder 102 may be monotonically decreasing with the distance r from the central axis 105, e.g., as described below.

In some demonstrative aspects, the first surface 112 and the second surface 122 may be configured such that, for example, over at least 50% of the catadioptric folder 102, e.g., over at least 50% of the aperture radius of the catadioptric folder 102, the inter-surface distance of the catadioptric folder 102 may be monotonically decreasing with the distance r from the central axis 105, e.g., as described below.

In some demonstrative aspects, the first surface 112 and the second surface 122 may be configured such that, for example, over at least 60% of the catadioptric folder 102, e.g., over at least 60% of the aperture radius of the catadioptric folder 102, the inter-surface distance of the catadioptric folder 102 may be monotonically decreasing with the distance r from the central axis 105, e.g., as described below.

In some demonstrative aspects, the first surface 112 and the second surface 122 may be configured such that, for example, over at least 70% of the catadioptric folder 102, e.g., over at least 70% of the aperture radius of the catadioptric folder 102, the inter-surface distance of the catadioptric folder 102 may be monotonically decreasing with the distance r from the central axis 105, e.g., as described below.

In some demonstrative aspects, the first surface 112 and the second surface 122 may be configured such that, for example, over at least 80% of the catadioptric folder 102, e.g., over at least 80% of the aperture radius of the catadioptric folder 102, the inter-surface distance of the catadioptric folder 102 may be monotonically decreasing with the distance r from the central axis 105, e.g., as described below.

In some demonstrative aspects, the first surface 112 and the second surface 122 may be configured such that, for example, over at least 90% of the catadioptric folder 102, e.g., over at least 90% of the aperture radius of the catadioptric folder 102, the inter-surface distance of the catadioptric folder 102 may be monotonically decreasing with the distance r from the central axis 105, e.g., as described below.

In other aspects, the first surface 112 and the second surface 122 may be configured such that, for example, the inter-surface distance of the catadioptric folder 102 may be monotonically decreasing with the distance r from the central axis 105 with respect to any other suitable portion of the catadioptric folder 102, e.g., any other suitable portion of the aperture radius of the catadioptric folder 102.

In some demonstrative aspects, the criterion “over at least XX % of the catadioptric folder”, when used with respect to the inter-surface distance of the catadioptric folder 102 monotonically decreasing with the distance from the central axis 105 of the catadioptric lens 100, may include a criterion relating to one or more portions along the path folder, which form at least XX % of the length of the catadioptric folder in a direction perpendicular to the central axis of the lens.

In one example, the one or more portions may include a single continuous portion along the catadioptric folder, which forms at least XX % of the length of the catadioptric folder. According to this example, the first and second surfaces of the catadioptric folder may be configured such that, over a single continuous portion along at least XX % of the catadioptric folder, the inter-surface distance of the catadioptric folder is monotonically decreasing with the distance from the central axis of the catadioptric lens.

In another example, the one or more portions may include a plurality of non-continuous portions along the catadioptric folder, which together form at least XX % of the length of the catadioptric folder. According to this example, the inter-surface distance of the catadioptric folder may be monotonically decreasing with the distance from the central axis of the catadioptric lens in each of the one or more portions. For example, the one or more portions may include Q>1 portions, including a first portion along XX1% of the catadioptric folder, and an Q-th portion along XXQ % of the catadioptric folder, for example, such that sum (XX1%, . . . , XXQ %) is at least XX % of the catadioptric folder.

In one example, the inter-surface distance of the catadioptric folder may include a first portion along 3% of the catadioptric folder, in which the inter-surface distance is monotonically decreasing with the distance from the central axis of the catadioptric lens; a second portion along 2% of the catadioptric folder, in which the inter-surface distance is monotonically decreasing with the distance from the central axis of the catadioptric lens; a third portion along 1% of the catadioptric folder, in which the inter-surface distance is monotonically decreasing with the distance from the central axis of the catadioptric lens; and a fourth portion along 5% of the catadioptric folder, in which the inter-surface distance is monotonically decreasing with the distance from the central axis of the catadioptric lens. According to this example, it may be said that the first and second surfaces are configured such that, over 3+2+1+5=11% of the catadioptric folder, the inter-surface distance of the catadioptric folder is monotonically decreasing with the distance from the central axis of the catadioptric lens.

In some demonstrative aspects, a first inter-surface distance of the catadioptric folder 102 at a first distance from the central axis 105 may be, for example, longer than a second inter-surface distance of the catadioptric folder 102 at a second distance from the central axis 105, e.g., as described below.

In some demonstrative aspects, the first distance from the central axis 105 may be shorter than the second distance from the central axis 105, e.g., as described below.

In one example, an inter-surface distance, denoted TaP(r=r2), of the catadioptric folder 102 at a distance r=r2 from the central axis 105 may be shorter than an inter-surface distance TaP(r=r1) of the catadioptric folder 102 at a distance r=r1, from the central axis 105.

For example, the distance r1 may be shorter than the distance 2.

In some demonstrative aspects, a first inter-surface distance of the catadioptric folder 102, e.g., at a Peripheral Distance (PD) from the central axis 105, may be, for example, less than 99% of a second inter-surface distance of the catadioptric folder 102, e.g., at the central axis 105 of the catadioptric lens, e.g., as described below.

In some demonstrative aspects, the first inter-surface distance of the catadioptric folder 102, e.g., at the PD distance from the central axis 105, may be, for example, less than 95% of the second inter-surface distance of the catadioptric folder 102, e.g., at the central axis 105 of the catadioptric lens, e.g., as described below.

In some demonstrative aspects, the first inter-surface distance of the catadioptric folder 102, e.g., at the PD distance from the central axis 105, may be, for example, less than 93% of the second inter-surface distance of the catadioptric folder 102, e.g., at the central axis 105 of the catadioptric lens, e.g., as described below.

In some demonstrative aspects, the first inter-surface distance of the catadioptric folder 102, e.g., at the PD distance from the central axis 105, may be, for example, less than 90% of the second inter-surface distance of the catadioptric folder 102, e.g., at the central axis 105 of the catadioptric lens, e.g., as described below.

In some demonstrative aspects, the first inter-surface distance of the catadioptric folder 102, e.g., at the PD distance from the central axis 105, may be, for example, less than 80% of the second inter-surface distance of the catadioptric folder 102, e.g., at the central axis 105 of the catadioptric lens, e.g., as described below.

In some demonstrative aspects, the first inter-surface distance of the catadioptric folder 102, e.g., at the PD distance from the central axis 105, may be, for example, less than 70% of the second inter-surface distance of the catadioptric folder 102, e.g., at the central axis 105 of the catadioptric lens, e.g., as described below.

In some demonstrative aspects, the first inter-surface distance of the catadioptric folder 102, e.g., at the PD distance from the central axis 105, may be, for example, less than 60% of the second inter-surface distance of the catadioptric folder 102, e.g., at the central axis 105 of the catadioptric lens, e.g., as described below.

In some demonstrative aspects, the first inter-surface distance of the catadioptric folder 102, e.g., at the PD distance from the central axis 105, may be, for example, less than 50% of the second inter-surface distance of the catadioptric folder 102, e.g., at the central axis 105 of the catadioptric lens, e.g., as described below.

In some demonstrative aspects, an inter-surface distance TaP(r) at some particular distance r, from the central axis 105 may be, for example, less than 99% of an inter-surface distance, denoted TaC, of the catadioptric folder 102 at the central axis 105, e.g., as described below.

In some demonstrative aspects, the inter-surface distance TaP(r) at any distance r>0.1Rmax, from the central axis 105 may be, for example, less than 99% of the inter-surface distance TaC, wherein Rmax denotes a radius of a lens mechanical aperture of the catadioptric lens 100.

In some demonstrative aspects, the inter-surface distance TaP(r) at any distance r>0.1Rmax, from the central axis 105 may be, for example, less than 90% of the inter-surface distance TaC.

In some demonstrative aspects, the inter-surface distance TaP(r) at any distance r>0.5Rmax, from the central axis 105 may be, for example, less than 80% of the inter-surface distance TaC, wherein Rmax denotes a radius of a lens mechanical aperture of the catadioptric lens 100.

In some demonstrative aspects, the inter-surface distance TaP(r) at any distance r>0.5Rmax, from the central axis 105 may be, for example, less than 70% of the inter-surface distance TaC.

In some demonstrative aspects, the inter-surface distance TaP(r) at any distance r>0.5Rmax, from the central axis 105 may be, for example, less than 50% of the inter-surface distance TaC.

In some demonstrative aspects, the inter-surface distance of the catadioptric folder 102 at a particular distance from the central axis 105 may be based, for example, on a distance between a first point and a second point, e.g., as described below.

In some demonstrative aspects, the first point may include a point on the first surface 112 at the particular distance from the central axis 105, e.g., as described below.

In some demonstrative aspects, the second point may include a point on the second surface 122 at the particular distance from the central axis 105, e.g., as described below.

In one example, the inter-surface distance TaP(r) may be based, for example, on a distance between a first point on surface 112 at the distance r from the central axis 105, and a second point on surface 122 at the distance r from the central axis 105, e.g., as described below. For example, the first point, the second point, and the central axis 105 may be geometrically located in the same plane, e.g., as described below.

In some demonstrative aspects, catadioptric lens 100 may include a plurality of lenses, e.g., as described below.

In some demonstrative aspects, catadioptric lens 100 may include a first lens 110 and a second lens 120, e.g., as described below.

In other aspects, catadioptric lens 100 may include a single lens, e.g., as described below with reference to FIG. 2.

In some demonstrative aspects, catadioptric folder 102 may be implemented by lens 110 and lens 120, e.g., as described below.

In some demonstrative aspects, the semi reflective surface, e.g., surface 112, may include a surface of the first lens 110, e.g., as described below.

In some demonstrative aspects, lens 110 may include a surface 111 opposite to surface 112, e.g., as described below.

In some demonstrative aspects, the reflective polarizer surface, e.g., surface 122, may include a surface of the second lens 120, e.g., as described below.

In some demonstrative aspects, lens 120 may include a surface 121 opposite to surface 122, e.g., as described below.

In some demonstrative aspects, as shown in FIG. 1, catadioptric lens 100 may include a pancake lens or a catadioptric lens.

In some demonstrative aspects, as shown in FIG. 1, lens 110 may be defined by the surfaces 112 and 111.

In some demonstrative aspects, as shown in FIG. 1, lens 120 may be defined by the surfaces 122 and 121.

In some demonstrative aspects, surfaces 112 and 111, and/or surfaces 122 and 121 may define a spherical lens or an aspherical lens.

In other aspects, surfaces 112 and 111, and/or surfaces 122 and 121 may define a biconic or freeform lens (not shown in FIG. 1).

In some demonstrative aspects, as shown in FIG. 1, a first line, denoted AB, may cross the surface 122 at a point, denoted C, such that the line AB may be normal to the surface 122 at the point C.

In some demonstrative aspects, as shown in FIG. 1, the surface 122 may be symmetric relative to the line AB, at least within some area close to the point C, e.g., in each two or more orthogonal cross-sections of the lens 110 by planes including the line AB.

In some demonstrative aspects, as shown in FIG. 1, the surfaces 111, 112, 121, and 122 may be substantially symmetric relative to two orthogonal planes (“symmetry planes”) including the line AB. For example, one symmetry plane may include the plane of FIG. 1, and a second symmetry plane may be orthogonal to the plane of the FIG. 1. In this case, the surfaces 111, 112, 121 and 122 may be biconic or freeform.

In some demonstrative aspects, as shown in FIG. 1, the inter-surface distance TaC may be measured along the line AB.

In some demonstrative aspects, as shown in FIG. 1, a second line, denoted A′B′, which may be parallel to the line AB, may be located at the distance r from the line AB, and may cross the surface 122.

In some demonstrative aspects, as shown in FIG. 1, the inter-surface distance TaP(r) may be measured along the line A′B′.

In some demonstrative aspects, as shown in FIG. 1, the inter-surface distance TaP(r) may be measured along the line A′B′, for example, in one of the lens symmetry planes. In other aspects, the inter-surface distance TaP(r) may be measured along the line A′B′, for example, in both symmetry planes, e.g., independently, for example, in case the surfaces 111, 112, 121 and 122 are biconic or freeform, e.g., do not have an axial symmetry.

In some demonstrative aspects, the inter-surface distance TaP(r) may be determined based on the inter-surface distance TaC, e.g., as follows:

$$T a P ( r ) = TaC * Kppd ( r )$$

wherein Kppd(r) denotes a monotonically decreasing function of r for r>0, wherein Max (Kppd(r))=Kppd(0)=1, at least over 10, %, e.g., over at least 30%, of the range 0<r<Rmax.

In some demonstrative aspects, catadioptric lens 100 may be configured to magnify the image provided by the display 170 and to create a virtual image of the display 170 projected through the exit pupil 180. For example, the virtual image may be located at infinity or at a certain distance from the exit pupil 180.

For example, the virtual image may be located at a distance of between 1 meter (m) and 4 m, e.g., to the right of the exit pupil 180.

In some demonstrative aspects, a pixel, e.g., each pixel, of the display 170 may be visible through the exit pupil 180 at a FoV angle, e.g., the FoV angle of the catadioptric lens 100, with respect to the line AB.

In some demonstrative aspects, catadioptric lens 100 may be implemented by a single lens, e.g., as described below.

In some demonstrative aspects, catadioptric folder 102 may be formed by the single lens, e.g., as described below.

In some demonstrative aspects, the semi-reflective surface of the catadioptric lens may include a first surface of the single lens, e.g., as described below.

In some demonstrative aspects, the reflective polarizer surface of the catadioptric folder may include a second surface of the single lens, for example, opposite to the first surface of the single lens, e.g., as described below.

In some demonstrative aspects, the retarder 130 may include a retarder layer between the semi-reflective surface and the polarized reflective surface of the single lens, e.g., as described below.

Reference is now made to FIG. 2, which schematically illustrates a system 201, in accordance with some demonstrative aspects. For example, system 201 may include one or more elements of system 101 (FIG. 1), and/or may be configured to perform the functionality of system 101 (FIG. 1).

In some demonstrative aspects, as shown in FIG. 2, system 201 may include a catadioptric lens 200 and a display 270, e.g., as described below.

In some demonstrative aspects, catadioptric lens 200 may be configured to direct light from display 270 to an eye of a user.

In some demonstrative aspects, as shown in FIG. 2, catadioptric lens 200 may be formed by a single lens 225.

In some demonstrative aspects, as shown in FIG. 2, catadioptric lens 200 may include a catadioptric folder. For example, catadioptric lens 200 may be configured to provide at least part of the functionality of catadioptric folder 102 (FIG. 1).

In some demonstrative aspects, as shown in FIG. 2, catadioptric lens 200 may include a first surface 212 and a second surface 222 opposite to the first surface 212. The surfaces 212 and 222 may be spherical, aspherical, biconic or freeform.

In some demonstrative aspects, the first surface 212 may include a semi-reflective surface.

In some demonstrative aspects, the second surface 222 may include a polarized reflective surface.

In some demonstrative aspects, as shown in FIG. 2, catadioptric lens 200 may include a retarder layer 230 between the semi-reflective surface 212 and the polarized reflective surface 222.

In some demonstrative aspects, as shown in FIG. 2, catadioptric lens 200 may be formed as a single lens having a semi-reflective coating, formed on, coated on, and/or attached to, the first surface 212.

In some demonstrative aspects, as shown in FIG. 2, catadioptric lens 200 may be formed as a single lens with a reflective polarizer formed on, coated on, and/or attached to, the second surface 222.

In some demonstrative aspects, retarder 230 may be positioned inside the lens or attached to the surface 222 forming an optical contact with the surface 222. For example, the reflective polarizer may be attached to the surface of the retarder forming an optical contact with the retarder.

In some demonstrative aspects, as shown in FIG. 2, the first surface 212 and the second surface 222 may be configured such that, for example, over at least 10% of the catadioptric lens 200, an inter-surface distance of the catadioptric lens 200 may be monotonically decreasing with the distance r from a central axis 205 of the catadioptric lens 200, e.g., as described below.

In some demonstrative aspects, as shown in FIG. 2, the inter-surface distance TaP(r) of the catadioptric lens 200 at some particular distance r from the central axis 205 may be, for example, shorter than the inter-surface distance TaC at the central axis 205.

In some demonstrative aspects, as shown in FIG. 2, the inter-surface distance TaP(r) may be less than 90% of the inter-surface distance TaC. In one example, the particular distance r may include, for example, a distance from the central axis 205, which may be, for example, at least 10% of an aperture radius of the catadioptric lens 200.

In some demonstrative aspects, as shown in FIG. 2, the inter-surface distance of the catadioptric lens 200, e.g., between the reflective polarizer surface and the semi-reflective surface, may be measured, for example, in a way similar to the measurement of the inter-surface distance described above with respect to FIG. 1.

In some demonstrative aspects, as shown in FIG. 2, the inter-surface distance TaP(r) of the catadioptric lens 200 at the distance r from the central axis 205 may be based, for example, on a distance between a first point on surface 212 at the distance r from the central axis 205, and a second point on surface 222 at the distance r from the central axis 205.

In other aspects, an inter-surface distance of an catadioptric folder of a catadioptric lens, may be defined, for example, based on a normal to the reflective polarizer surface of the catadioptric folder, e.g., as described below.

Referring back to FIG. 1, in some demonstrative aspects, the inter-surface distance of the catadioptric folder 102 of catadioptric lens 100 at the distance r from the central axis 105 may be defined, for example, based on a normal to the surface 122, e.g., as described below.

In some demonstrative aspects, the inter-surface distance of the catadioptric folder 102 at a particular distance from the central axis 105 may be based, for example, on a distance between a first point and a second point, e.g., as described below.

In some demonstrative aspects, the second point may include a point on the second surface 122 at the particular distance from the central axis 105, e.g., as described below.

In some demonstrative aspects, the first point may include a point of intersection between the first surface 112 and a normal to the second surface 122, for example, at the second point, e.g., as described below.

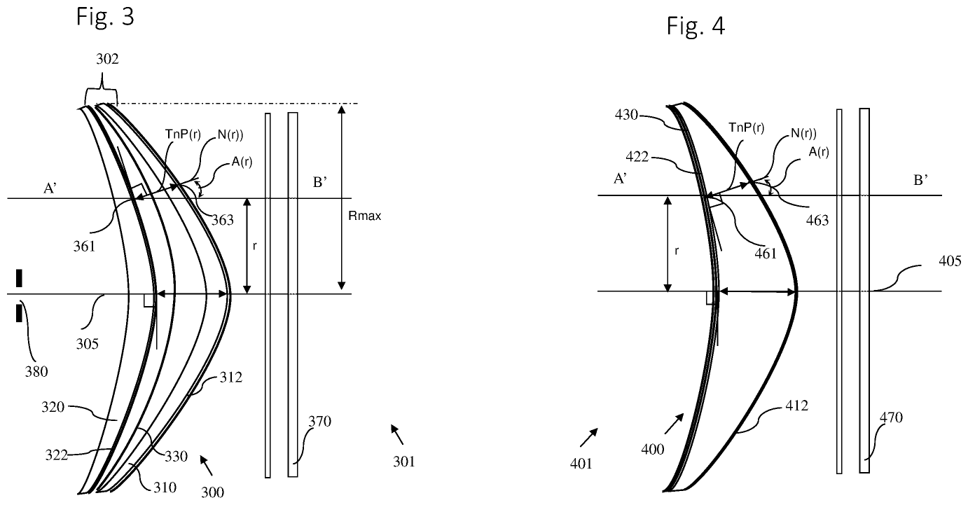

Reference is now made to FIG. 3, which schematically illustrates a system 301, in accordance with some demonstrative aspects. For example, system 301 may include one or more elements of system 101 (FIG. 1), and/or may be configured to provide at least part of the functionality of system 101 (FIG. 1).

In some demonstrative aspects, as shown in FIG. 3, system 301 may include a catadioptric lens 300 and a display 370, e.g., as described below.

In some demonstrative aspects, catadioptric lens 300 may be configured to direct light from display 370 to an exit pupil 380.

In some demonstrative aspects, as shown in FIG. 3, catadioptric lens 300 may include a first lens 310 and a second lens 320.

In some demonstrative aspects, as shown in FIG. 3, lens 310 may include a surface 312 including a semi-reflective surface.

In some demonstrative aspects, as shown in FIG. 3, lens 320 may include a surface 322 including a reflective polarizer surface.

In some demonstrative aspects, as shown in FIG. 3, catadioptric lens 300 may include a retarder 330 between the semi-reflective surface 312 and the polarized reflective surface 322.

In some demonstrative aspects, as shown in FIG. 3, catadioptric lens 300 may include a catadioptric folder 302 including the semi-reflective surface, the reflective polarizer surface and the retarder 330. For example, catadioptric folder 302 may provide at least part of the functionality of catadioptric folder 102 (FIG. 1).

In some demonstrative aspects, as shown in FIG. 3, an inter-surface distance, denoted TnP(r), of the catadioptric folder 302 at a particular distance r from the central axis 305 may be based, for example, on a distance between a first point 361 and a second point 363, e.g., as described below.

In some demonstrative aspects, as shown in FIG. 3, the second point 363 may include a point on the second surface 322 at the particular distance r from the central axis 305, e.g., as described below.

In some demonstrative aspects, as shown in FIG. 3, the first point 361 may include a point of intersection between the first surface 312 and a normal, denoted N(r), to the second surface 322 at the second point 363, e.g., as described below.

In some demonstrative aspects, as shown in FIG. 3, the normal N(r) may be at a point where a line A′B′, which is parallel to the central axis 305, crosses the surface 322.

In some demonstrative aspects, as shown in FIG. 3, the normal N(r) may have an angle, denoted A (r), with the line A′B′.

In some demonstrative aspects, as shown in FIG. 3, the inter-surface distance TnP(r) between the surfaces 322 and 312 may be measured, for example, along the normal N(r).

In other aspects, the inter-surface distance TaP(r) may be measured along the normal N(r) in one of the lens symmetry planes, e.g., as shown in FIG. 1, or in both symmetry planes, e.g., independently, for example, in case the surfaces 111, 112, 121 and 122 (FIG. 1) are biconic or freeform, e.g., do not have an axial symmetry.

In some demonstrative aspects, the inter-surface distance TnP(r) may be a monotonically decreasing function of r, for example, wherein TnP(0)=TaC.

In some demonstrative aspects, the function TnP(r) may be monotonically decreasing, for example, over at least 10% of the lens aperture Rmax of the catadioptric lens 300.

In some demonstrative aspects, a single lens system may be configured according to an inter-surface distance measured along a normal to a reflective polarizer surface of the single lens system, e.g., as described below.

Reference is now made to FIG. 4, which schematically illustrates a system 401, in accordance with some demonstrative aspects. For example, system 401 may include one or more elements of system 101 (FIG. 1), and/or may be configured to provide at least part of the functionality of system 101 (FIG. 1).

In one example, system 401 may include one or more elements of system 201 (FIG. 2), and/or may be configured to perform, at least part of the functionality of system 201 (FIG. 2).

In some demonstrative aspects, as shown in FIG. 4, system 401 may include a catadioptric lens 400 and a display 470, e.g., as described below.

In some demonstrative aspects, as shown in FIG. 4, catadioptric lens 400 may be formed by a single lens. For example, catadioptric lens 200 (FIG. 2) may include the catadioptric lens 400, and/or may provide at least part of the functionality of catadioptric lens 400.

In some demonstrative aspects, as shown in FIG. 4, catadioptric lens 400 may include a first surface 412 and a second surface 422 opposite to the first surface 412.

In some demonstrative aspects, the first surface 412 may include a semi-reflective surface.

In some demonstrative aspects, the second surface 422 may include a reflective polarizer surface.

In some demonstrative aspects, as shown in FIG. 4, catadioptric lens 400 may include a retarder layer 430 between the semi-reflective surface 412 and the reflective polarizer surface 422.

In some demonstrative aspects, as shown in FIG. 4, catadioptric lens 400 may include a catadioptric folder including the semi-reflective surface, the reflective polarizer surface and the retarder layer 430. For example, catadioptric lens 400 may provide at least part of the functionality of catadioptric folder 102 (FIG. 1).

In some demonstrative aspects, as shown in FIG. 4, the first surface 412 and the second surface 422 may be configured such that, for example, over at least 10%, for example, at least 30%, e.g., at least 50%, of the catadioptric lens 400, an inter-surface distance of the catadioptric lens 400 may be monotonically decreasing with a distance, denoted r, from a central axis 405 of the catadioptric lens 400, e.g., as described below.

In some demonstrative aspects, an inter-surface distance, denoted TnP(r), of the catadioptric lens 400 at a particular distance r, from the central axis 405 may be based on a distance between a first point 461 and a second point 463.

In some demonstrative aspects, the first point 461 may include a point on the second surface 422 at the particular distance r from the central axis 405.

In some demonstrative aspects, the second point 463 may include a point of intersection between the first surface 412 and a normal, denoted N(r), to the second surface 422 at the first point.

In some demonstrative aspects, as shown in FIG. 4, the normal N(r) may be at the point where the line A′B′, which is parallel to the central axis 405, crosses the surface 422.

In some demonstrative aspects, as shown in FIG. 4, the normal N(r) may have an angle, denoted A (r) with the line A′B′.

In some demonstrative aspects, as shown in FIG. 4, the inter-surface distance TnP(r) between the surfaces 422 and 412 may be measured, for example, along the normal N(r).

In some demonstrative aspects, the inter-surface distance TnP(r) may be a monotonically decreasing function of r, for example, wherein TnP(0)=TaC.

In some demonstrative aspects, the function TnP(r) may be monotonically decreasing function, for example, over at least 10%, for example, at least 20%, e.g., at least 30%, of the lens aperture Rmax of the catadioptric lens 400.

Referring back to FIG. 1, in some demonstrative aspects, a Peripheral Eye Relief (PER) of the catadioptric lens 100 at a PD distance from the central axis 105 of the catadioptric lens may be shorter than a Central Eye Relief (CER) of the catadioptric lens 100 at the central axis 105 of the catadioptric lens, e.g., as described below.

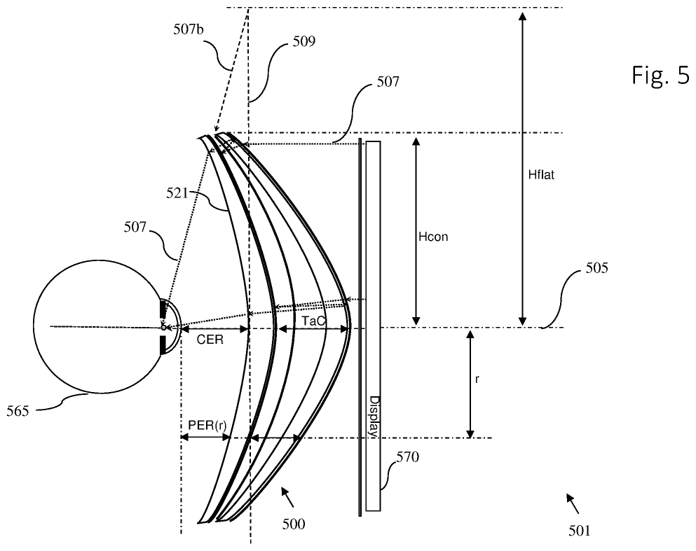

Reference is now made to FIG. 5, which schematically illustrates a system 501, in accordance with some demonstrative aspects. For example, system 501 may include one or more elements of system 101 (FIG. 1), and/or may be configured to provide at least the functionality of system 101 (FIG. 1).

In some demonstrative aspects, as shown in FIG. 5, system 501 may include a catadioptric lens 500 and a display 570. For example, catadioptric lens 100 (FIG. 1) may include catadioptric lens 500, and/or may provide at least part of the functionality of catadioptric lens 500.

In some demonstrative aspects, as shown in FIG. 5, a PER, denoted PER (r), of the catadioptric lens 500 at a PD distance r from the central axis 505 of the catadioptric lens 500 may be shorter than a Central Eye Relief (CER), denoted CER, of the catadioptric lens 500 at the central axis 505.

In some demonstrative aspects, as shown in FIG. 5, surfaces of the catadioptric lens 500 may be spherical, conic or aspherical or biconic or freeform.

In some demonstrative aspects, as shown in FIG. 5, a near-eye surface 521, e.g., a surface closest to the eye 565 may be configured, for example, such that at least at the PD distance, the peripheral eye relief PER (r) may be smaller than the central eye relief CER.

In some demonstrative aspects, as shown in FIG. 5, catadioptric lens 500 may be configured to provide a technical solution to support compactness of catadioptric lens 500.

For example, a lens, e.g., lens 500, which is configured to have a PER smaller than a CER and is configured to support a maximum FOV defined by a ray 507, may be made more compact, for example, compared to a lens with a PER equal to, or larger than, a CER of the lens providing an equal maximum field of view defined by the a ray 507b, which is a continuation of the ray 507.

In some demonstrative aspects, as shown in FIG. 5, catadioptric lens 500 may have an aperture size, denoted Hcon, which may be configured, for example, to support an edge FoV defined by a ray 507.

In some demonstrative aspects, as shown in FIG. 5, the aperture size Hcon of catadioptric lens 500 may be smaller than an aperture radius, denoted Hflat, of a lens with a planar surface 509 closest to the eye 565, which would have been needed to support the same FoV defined by the ray 507b. For example, the aperture radius Hflat may be considerably larger, e.g., compared to the aperture radius Hcon of catadioptric lens 500.

Referring back to FIG. 1, in some demonstrative aspects, the second surface 122 may include a center surface portion and a side surface portion, e.g., as described below.

In some demonstrative aspects, the center surface portion may have a concave shape, e.g., as described below.

In some demonstrative aspects, the side surface portion may have a concave shape or a convex shape, e.g., as described below.

For example, concave and convex surfaces may be defined relative to a particular direction.

For example, a surface may be defined as “concave” when the center of curvature of the surface is located to the left of the surface, e.g., at the same side where the exit pupil 180 of the system 100 is located.

For example, a surface may be defined as “convex” when the center of curvature of the surface is located to the right of the surface, e.g., at the same side where the display 170 of the system 100 is located.

For example, according to this definition all of the surfaces 121, 122, 111, 112 as shown in FIG. 1 may be defined as concave surfaces.

In some demonstrative aspects, a curvature radius of the center surface portion of the surface 122 (FIG. 1) may be between 13-80 millimeters, e.g., as described below.

In other aspects, the center surface portion of the surfaces 121, 122, 111 and 112 may have any other curvature radius.

In some demonstrative aspects, the lens 110 and the lens 120 may be configured as “mostly concave” lenses.

In some demonstrative aspects, a “mostly concave” lens may include a lens where reflective surfaces of the lens that fold a light path, e.g., surfaces 122 and 112, may be concave, for example, at least in a central area of the lens.

In some demonstrative aspects, a radius of curvature of the surfaces 122 and 112 in the central area of a “mostly concave” lens may be in a range between 13 millimeters (mm) and 80 mm.

In some demonstrative aspects, the surface 121 of the lens 120 may be convex, in one portion, e.g., in the central part, and concave in another portion, e.g., in a side part.

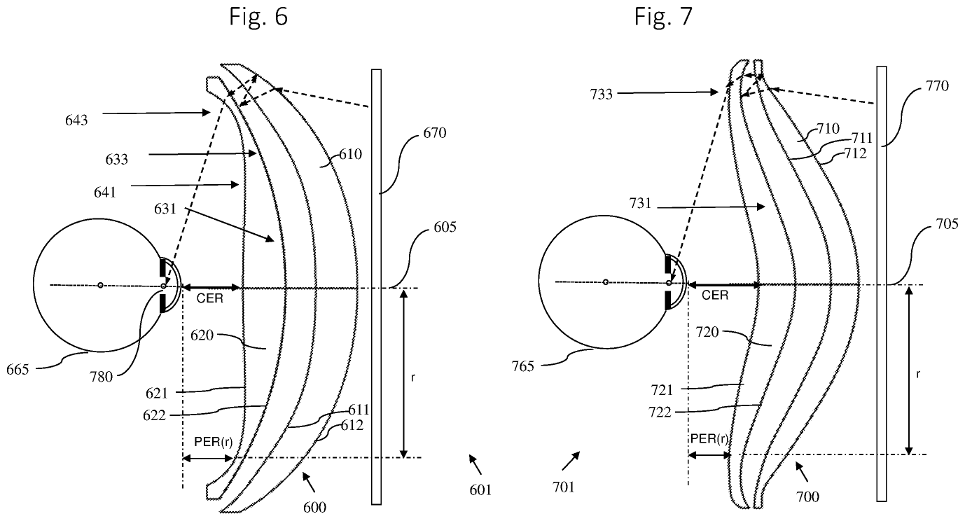

Reference is now made to FIG. 6, which schematically illustrates a system 601, in accordance with some demonstrative aspects. For example, system 101 may include one or more elements of system 601, and/or may be configured to perform the functionality of system 601.

In some demonstrative aspects, as shown in FIG. 6, system 601 may include an catadioptric lens 600 and a display 670, for example, with a retarder (display retarder is not shown in FIG. 6) emitting a circular polarized light, e.g., as described below.

In some demonstrative aspects, catadioptric lens 600 may be configured to direct light from display 670 to an eye 665 of a user.

In some demonstrative aspects, as shown in FIG. 6, catadioptric lens 600 may include a first lens 610, which may include a semi-reflective surface 612, and a surface 611, e.g., opposite to the surface 612.

In some demonstrative aspects, as shown in FIG. 6, catadioptric lens 600 may include a second lens 620, which may include a reflective polarizer surface 622, and a near-eye surface 621, e.g., opposite to the surface 622.

In some demonstrative aspects, a catadioptric folder may be formed by semi-reflective surface 612 and reflective polarizer surface 622.

In some demonstrative aspects, as shown in FIG. 6, reflective polarizer surface 622 may be formed as a concave surface.

In some demonstrative aspects, as shown in FIG. 6, reflective polarizer surface 622 may include a center surface portion 631 having a concave shape, and a side surface portion 633 having a concave shape.

In some demonstrative aspects, the concave surface 622 may include a sphere surface, a conic surface, or an a-sphere surface.

In other aspects, the concave surface 622 may include any other surface shape.

In some demonstrative aspects, as shown in FIG. 6, near-eye surface 621 may have an aspheric, convex shape at a center lens portion 641, and/or a concave shape at the side surface portion 643.

In other aspects, near-eye surface 621 may have any other shape.

In some demonstrative aspects, as shown in FIG. 6, reflective polarizer surface 622 may include a concave surface.

In some demonstrative aspects, as shown in FIG. 6, surface 611 and semi-reflective surface 612 may be concave and aspheric.

In some demonstrative aspects, as shown in FIG. 6, a condition that a PER® of the catadioptric lens 600 at a PD distance r from a central axis 605 of the catadioptric lens 600 may be shorter than the CER of the catadioptric lens 600 at the central axis 605 may be true, e.g., at a lens periphery of catadioptric lens 600.

Reference is now made to FIG. 7, which schematically illustrates a system 701, in accordance with some demonstrative aspects. For example, system 101 may include one or more elements of system 701, and/or may be configured to perform the functionality of system 701.

In some demonstrative aspects, as shown in FIG. 7, system 701 may include an catadioptric lens 700 and a display 770, for example, with a retarder (display retarder is not shown in FIG. 7) emitting a circular polarized light, e.g., as described below.

In some demonstrative aspects, catadioptric lens 700 may be configured to direct light from display 770 to an eye 765 of a user.

In some demonstrative aspects, as shown in FIG. 7, catadioptric lens 700 may include a first lens 710, which may include a semi-reflective surface 712 and a surface 711, e.g., opposite to the surface 712.

In some demonstrative aspects, as shown in FIG. 7, catadioptric lens 700 may include a second lens 720, which may include a reflective polarizer surface 722 and a near-eye surface 721, e.g., opposite to the surface 722.

In some demonstrative aspects, a catadioptric folder may be formed by semi-reflective surface 712 and reflective polarizer surface 722.

In some demonstrative aspects, as shown in FIG. 7, reflective polarizer surface 722 may include a center surface portion 731 having a concave shape, and a side surface portion 733 having a convex shape.

In other aspects, reflective polarizer surface 722 may have any other shape.

In some demonstrative aspects, as shown in FIG. 7, near-eye surface 721 and/or reflective polarizer surface 722 may have a strong asphere shape. For example, near-eye surface 721 and/or reflective polarizer surface 722 may be concave at the central part 731 of the catadioptric lens 700 and convex at the lens periphery 733 of the catadioptric lens 700.

In some demonstrative aspects, as shown in FIG. 7, semi-reflective surface 712 and/or surface 711 may have a strong asphere shape. For example, semi-reflective surface 712 and/or surface 711 may be concave at the central part 731 of the catadioptric lens 700, and convex at the lens periphery 733 of the catadioptric lens 700.

In some demonstrative aspects, as shown in FIG. 7, a condition that the ®(r) of the catadioptric lens 700 at a PER distance r, from a central axis 705 of the catadioptric lens 700 may be shorter than the CER, of the catadioptric lens 700 at the central axis 705 may be true, e.g., at one or more points at lens periphery of catadioptric lens 700.

Referring back to FIG. 1, in some demonstrative aspects, the first surface 112 and the second surface 122 of the catadioptric folder 102 of catadioptric lens 100 may be configured such that, for example, over at least 10%, for example, at least 20%, for example, at least 30%, e.g., at least 50%, of the catadioptric folder 102, an optical path length, e.g., inside the catadioptric folder 102, may be monotonically decreasing with the distance from the central axis 105, e.g., as described below.

In some demonstrative aspects, a first optical path length inside the catadioptric folder 102 at a first distance, r, from the central axis 105 may be, for example, longer than a second optical path length inside the catadioptric folder 102 at a second distance, r′, from the central axis 105, e.g., as described below.

In some demonstrative aspects, the second distance may be, for example, longer than the first distance, e.g., as described below.

In some demonstrative aspects, the first surface 112 and the second surface 122 may be configured such that, for example, over at least 10%, for example, at least 20%, for example, at least 30%, e.g., at least 50%, of the catadioptric folder 102, a length of the optical path between the first surface 112 and the second surface 122 may be monotonically decreasing with the distance from the central axis 105, e.g., as described below.

In some demonstrative aspects, a first length of the optical path between the first surface 112 and the second surface 122 at a first distance from the central axis 105 may be, for example, longer than a second length of the optical path between the first surface 112 and the second surface 122 at a second distance from the central axis 105, e.g., as described below.

In some demonstrative aspects, the second distance may be, for example, longer than the first distance, e.g., as described below.

in some demonstrative aspects, the first surface 112 and the second surface 122 may be configured such that, for example, over at least 10%, for example, at least 20%, for example, at least 30%, e.g., at least 50%, of the catadioptric folder 102, a number of Pixels PerDegree (PPD) of the catadioptric lens 100 may be monotonically decreasing with the distance from the central axis 105, e.g., as described below. For example, the PPD of an optical system may represent the number of display pixels projected by the optical system within an angular range of 1 degree.

In some demonstrative aspects, a region of the catadioptric folder 102, over which the PPD is decreasing, may be located at any suitable location inside the catadioptric folder 102.

In one example, the PPD may be constant over the region of the catadioptric folder 102 close to the center of the lens, while the PPD may decrease in the peripheral region of the catadioptric folder 102.

In another example, the lens may have a maximal PPD, for example, at an area substantially around the visual axis of a straight gazing eye, for example, for a biconic lens or a freeform lens, where the lens optical axis may be non-colinear with the visual axis of the straight gazing eye.

In some demonstrative aspects, a first number of PPD of the catadioptric lens 100 at a first distance from the central axis 105 may be, for example, higher than a second number of PPD at a second distance from the central axis 105, e.g., as described below.

In some demonstrative aspects, the second distance may be, for example, longer than the first distance, e.g., as described below.

In some demonstrative aspects, the first surface 112 and the second surface 122 may be configured such that, for example, over at least 10%, for example, at least 20%, for example, at least 30%, e.g., at least 50%, of the catadioptric folder 102, a focal length of the catadioptric lens 100 may be monotonically decreasing with the distance from the central axis 105, e.g., as described below.

In some demonstrative aspects, a first focal length of the catadioptric lens 100 at a first distance from the central axis 105 may be, for example, longer than a second focal length of the catadioptric lens 100 at a second distance from the central axis 105, e.g., as described below.

In some demonstrative aspects, the second distance may be, for example, longer than the first distance, e.g., as described below.

In some demonstrative aspects, the first surface 112 may be configured to reflect light of a first-handedness circular polarization from a first direction into light of a second-handedness circular polarization in a second direction, e.g., as described below.

In some demonstrative aspects, the first direction may be from the second surface 122 to the first surface 112, e.g., as described below.

In some demonstrative aspects, the second direction may be from the first surface 112 to the second surface 122, e.g., as described below.

In some demonstrative aspects, the second-handedness circular polarization may be orthogonal to the first-handedness circular polarization, e.g., as described below.

In some demonstrative aspects, the second surface 122 may be configured to reflect light of a first linear polarization from the second direction to the first direction, and to transfer light of a second linear polarization in the second direction, e.g., as described below.

In some demonstrative aspects, the second linear polarization may be orthogonal to the first linear polarization, e.g., as described below.

In some demonstrative aspects, the retarder 130 may be configured to convert the light of the first linear polarization into the light of the first-handedness circular polarization in the first direction, e.g., as described below.

In some demonstrative aspects, the retarder 130 may be configured to convert the light of the second-handedness circular polarization into the light of the second linear polarization in the second direction, e.g., as described below.

In some demonstrative aspects, the first surface 112 may be configured to transfer light from the second direction having the first-handedness circular polarization, e.g., as described below.

In some demonstrative aspects, the retarder 130 may be configured to convert the light from the second direction having the first-handedness circular polarization into the light of the first linear polarization in the second direction, e.g., as described below.

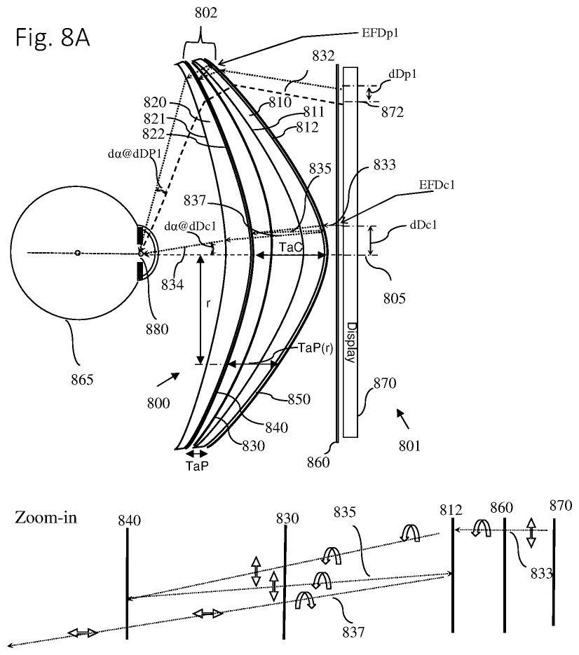

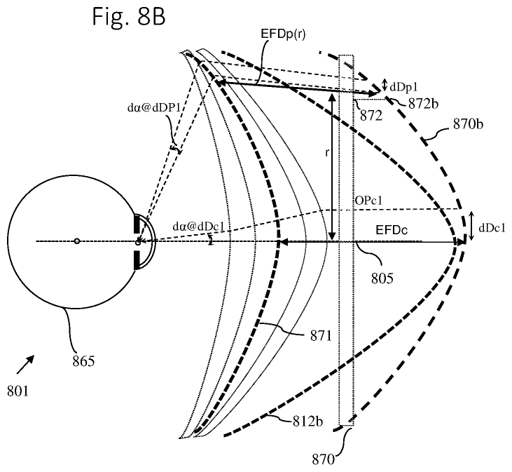

Reference is now made to FIG. 8A, which schematically illustrates a system 801, in accordance with some demonstrative aspects. For example, system 101 (FIG. 1) may include one or more elements of system 801, and/or may be configured to perform the functionality of system 801.

In some demonstrative aspects, as shown in FIG. 8A, system 801 may include a catadioptric lens 800 and a display 870, e.g., as described below.

In some demonstrative aspects, catadioptric lens 800 may be configured to direct light from display 870 to an eye 865 of a user.

In some demonstrative aspects, as shown in FIG. 8A, catadioptric lens 800 may include a first lens 810 including a surface 811 and a semi-reflective surface 812, e.g., including a semi-reflective coating 850.

In some demonstrative aspects, as shown in FIG. 8A, catadioptric lens 800 may include a second lens 820 including a near-eye surface 821 and a reflective polarizer surface 822, e.g., including a polarizer 840.

In some demonstrative aspects, as shown in FIG. 8A, catadioptric lens 800 may include a retarder 830, e.g., a QWP retarder, between the first lens 810 and the second lens 820.

In some demonstrative aspects, as shown in FIG. 8A, a catadioptric folder 802 may be formed by semi-reflective surface 812, reflective polarizer surface 822, and the retarder 830.

In some demonstrative aspects, as shown in FIG. 8A, semi-reflective surface 812 and/or reflective polarizer surface 822 may be configured such that, for example, over at least 10% of the catadioptric folder 802, an inter-surface distance TaP(r) of the catadioptric folder 802 may be monotonically decreasing with the distance r from a central axis 805 of catadioptric lens 800, e.g., as described below.

In some demonstrative aspects, as shown in FIG. 8A, the inter-surface distance TaP(r) of the catadioptric folder 802 may be shorter than the inter-surface distance TaC, at the central axis 805, e.g., as described below.

In some demonstrative aspects, as shown in FIG. 8A, semi-reflective surface 812 and/or reflective polarizer surface 822 may be configured such that, for example, over at least 10% of the catadioptric folder 802, a number of PPD of the catadioptric lens 800 may be monotonically decreasing with the increasing distance from the central axis 805.

In some demonstrative aspects, a region of the folder 802, over which the PPD is decreasing, may be located at any suitable location inside the folder 802.

In one example, the PPD may be constant over the region of the folder close to the center of the lens, while the PPD may decrease in the peripheral region of the lens folder.

In some demonstrative aspects, as shown in FIG. 8A, a first portion of the display 870 extending over a length denoted dDp1, may be projected in a first FoV angular range, denoted da@dDP1. For example, in case the display pixel pitch is Pd, the number of PPD corresponding to the first FoV angular range may be determined as NPPD1=(dDp1/Pd)/da@dDP1.

In some demonstrative aspects, as shown in FIG. 8A, a second portion of the display 870 extending over a length, denoted dDc1, may be projected in a second FoV angular range, denoted da@dDc1, which may be closer to the central FOV of the lens. For example, in case the display pixel pitch is Pd, the number of PPD corresponding to the second FoV angular range may be determined as NPPD2=(dDc1/Pd)/da@dDc1.

In some demonstrative aspects, the second number of PPD NPPD2, may be larger than the first number of PPD NPPD1.

In some demonstrative aspects, as shown in FIG. 8A, semi-reflective surface 812 and/or reflective polarizer surface 822 may be configured such that, for example, over at least 10% of the catadioptric folder 802, a length of an optical path between semi-reflective surface 812 and reflective polarizer surface 822 may be monotonically decreasing with the distance from the central axis 805.

In some demonstrative aspects, as shown in FIG. 8A, a first length of an optical path represented by chief ray 832, e.g., originated from pixel 872, between the semi-reflective surface 812 and the reflective polarizer surface 822, which may be at a first distance from the central axis 805, may be, for example, longer than a second length of an optical path 834 between the semi-reflective surface 812 and the reflective polarizer surface, which may be at a second distance from the central axis 805.

In some demonstrative aspects, the first distance from the central axis 805 may be shorter than the second distance from the central axis 805, e.g., as described below.

In some demonstrative aspects, as shown in FIG. 8A, semi-reflective surface 812 and/or reflective polarizer surface 822 may be configured such that, for example, over at least 10%, for example, at least 20%, for example, at least 30%, e.g., at least 50%, of the catadioptric folder 802, an optical path length, e.g., inside the catadioptric folder 802, may be monotonically decreasing with the distance from the central axis 805.

In some demonstrative aspects, a region of the catadioptric folder 802, over which the optical path length is decreasing, may be located at any suitable location inside the catadioptric folder 802.

In some demonstrative aspects, as shown in FIG. 8A, a first optical path length inside the catadioptric folder, which may be at a first distance from the central axis 805, for example, may be longer than a second optical path length inside the catadioptric folder, which may be at a second distance from the central axis 805.

In some demonstrative aspects, the first distance from the central axis 805 may be shorter than the second distance from the central axis 805, e.g., as described below.

In some demonstrative aspects, as shown in FIG. 8A, semi-reflective surface 812 and/or reflective polarizer surface 822 may be configured such that, for example, over at least 10%, for example, at least 20%, for example, at least 30%, e.g., at least 50%, of the catadioptric folder 802, a focal length, denoted EFD, of the catadioptric lens 800 may be monotonically decreasing with an increasing distance from the central axis 805.

In some demonstrative aspects, a focal length in the peripheral region of the catadioptric lens 800, denoted EFDp1, of the catadioptric lens 800 (FIG. 8A) at the second distance from the central axis 805 may be, for example, shorter than a focal length in the central region of the catadioptric lens 800, denoted EFDc1, of the catadioptric lens 800 at the first distance from the central axis 805, e.g., as described below.

In some demonstrative aspects, as shown in FIG. 8A, a light beam 833 emitted from the display 860 may arrive at the semi-reflective surface 812 as a circular polarized light beam. A zoom-in of the ray trajectory through the catadioptric lens 800 is shown in the bottom part of FIG. 8A, and the light polarization is shown by arrows.

In some demonstrative aspects, as shown in FIG. 8A, a QWP retarder 860, for example, between display 870 and semi-reflective surface 812, may be configured to convert a polarization of the light beam 833 into a circular polarization, for example, when display 870 emits the light beam 833 with a linear polarization.

In some demonstrative aspects, a QWP axis of QWP retarder 860 may be oriented, for example, at 45 degrees, with respect a linear polarization emitted by the display 870. Accordingly, polarization of the light beam 833 may become circular after passing the QWP retarder 860.

In some demonstrative aspects, the polarization of the light beam 833 may become a linear polarization e.g., a first linear polarization, for example, after passing the retarder QWP 830.

In some demonstrative aspects, as shown in FIG. 8A, light beam 833 with the first linear polarization may be reflected from the polarizer 840 at the polarizing reflective surface 822.

In some demonstrative aspects, as shown in FIG. 8A, a back reflected beam 835 of light beam 833 may propagate towards the semi-reflective surface 812, e.g., through the QWP retarder 830.

In some demonstrative aspects, as shown in FIG. 8A, the polarization of the back reflected bean 835 may be converted from the first linear polarization into a circular polarization with a first-handedness circular orientation, for example, after passing the QWP retarder 830.

In some demonstrative aspects, as shown in FIG. 8A, the beam 835 may be reflected from the semi-reflective surface 812 as a beam 837 with a second-handedness circular orientation, which may be, for example, orthogonal to the first-handedness circular orientation.

In some demonstrative aspects, as shown in FIG. 8A, the polarization of the beam 837 may pass through the QWP retarder 830 and may be converted from the second-handedness circular orientation into a second linear polarization, which may be, for example, oriented orthogonal to the first linear polarization.

In some demonstrative aspects, as shown in FIG. 8A, the beam 837 having the second linear polarization may be transmitted through the reflective polarizer 840 at the surface 822, and may further propagate towards an exit pupil 880 of the catadioptric lens 800.

In some demonstrative aspects, as shown in FIG. 8A, exit pupil 880 may coincide with a pupil of the eye 865 of the user.

In some demonstrative aspects, as shown in FIG. 8A, a shape of lens 810 and/or lens 820 may be configured such that, for example, an optical path of beams may vary over a FoV of catadioptric lens 800. For example, this variation in the optical path over the FoV may be achieved by the inter-surface variable distance TaP(r).

In some demonstrative aspects, as shown in FIG. 8A, an optical path, e.g., optical path 834, may be close to the maximum, for example, close to a FoV center of the catadioptric lens 800 in the FoV angular range da@dDc1. Accordingly, a focal length, e.g., the focal length EFDc1, of the catadioptric lens 800 may be close to maximum too. Therefore, a number of display pixels projected inside the fixed angle interval da@dDc1 may be substantially maximal close to the FoV center.

In some demonstrative aspects, as shown in FIG. 8A, as the view angle increases, the optical path may decrease, and the system focal length may decrease. Therefore, a number of display pixels projected inside the fixed angle interval da@dDp1, which may be with a distance of view angle from the center, may decrease.

In some demonstrative aspects, system 801 may be configured to provide a technical solution to support a human eye to view a best resolution, e.g., close to the center of the FoV.

In some demonstrative aspects, system 801 may be configured to provide a technical solution to support a relatively quick decrease of a resolution viewed by the human eye, e.g., with the increasing view angle inside the FOV.

In some demonstrative aspects, system 801 may be configured to provide a technical solution to support using available display pixels in a relatively optimal, e.g., a most optimal, way, for example, as an eye's rotation comfort zone may be limited, e.g., to about 30 degrees. For example, inside an eye's rotation comfort zone of a view angle of 30 degrees, a close to maximal PPD number may be preserved. For example, beyond the 30 degree view angle, the PPD number may decreasing, e.g., with the increasing angle of view.

In some demonstrative aspects, a dependence of the optical path on the FoV angle may be achieved by the specific shape of the curved lenses 810 and 820. For example, a distance of the optical path between the semi-reflective surface 812 and the reflective polarizer surface 822 may decrease, e.g., with an increase of a view angle.

In some demonstrative aspects, as shown in FIG. 8A, the inter-surface distance TaP(r) at the distance r from the central axis 805 may be based, for example, on the inter-surface distance TaC and on a monotonically decreasing function, denoted Kppd. For example, the function Kppd may be decreasing, e.g., over at least 10% e.g., over at least 30%, of the lens aperture radius Rmax, e.g., as follows:

$$T a P ( r ) = TaC * Kppd ( r )$$

Reference is made to FIG. 8B, which schematically illustrates the system 801, in accordance with some demonstrative aspects.

In some demonstrative aspects, as shown in FIG. 8B, an optical path of the catadioptric lens 800 may be unfolded, for example, to illustrate a variable optical path length concept. For example, FIG. 8B may illustrate the system 801 with an unfolded optical path.

In some demonstrative aspects, to correlate illustration of the unfolded path with the catadioptric lens and display, a dashed line 871 in FIG. 8B depicts a virtual thin lens surface. For example, a dashed line 870b in FIG. 8B represents a virtual display surface, where the pixel 872 on the real display surface may be positioned as a virtual pixel 872b on the virtual display surface 870b. For example, the beam of rays around the chief ray associated with a virtual pixel 872b may be collimated, e.g., to emulate infinity virtual distance, or almost collimated, e.g., to emulate other than infinity virtual distance, for example, after crossing the virtual thin lens surface 871 and propagating towards the eye pupil. For example, as shown in FIG. 8B, a virtual surface 812b may correspond to the real surface 812 (FIG. 8A).

In some demonstrative aspects, the Effective Focal Distance (EFD) between the virtual lens surface 871 and the virtual display surface 870b may include the partial optical path of the corresponding chief ray originated from pixel 872b to the virtual lens surface 812b, and an optical path fragment from the virtual lens surface 812b until becoming collimated (or almost collimated) by the virtual lens surfaces 871.

In some demonstrative aspects, as shown in FIG. 8B, the EFD between virtual lens surface 871 and virtual display surface 870b may be an effective focal length, denoted EFDp(r), e.g., of a double dual “mostly-concave” module, as a function of distance r from the central axis 805 may be based, for example, on a center effective focal length, denoted EFDc, and on the monotonically decreasing function Kppd, e.g., as follows:

$$EFDp ( r ) = EFDc * Kppd 2 ( r )$$

Referring back to FIG. 1, in some demonstrative aspects, reflectivity and/or transmissivity of the first surface 112 may be configured, for example, based on an angle of incidence of light from the display 170 with respect to the first surface 112, e.g., as described below.

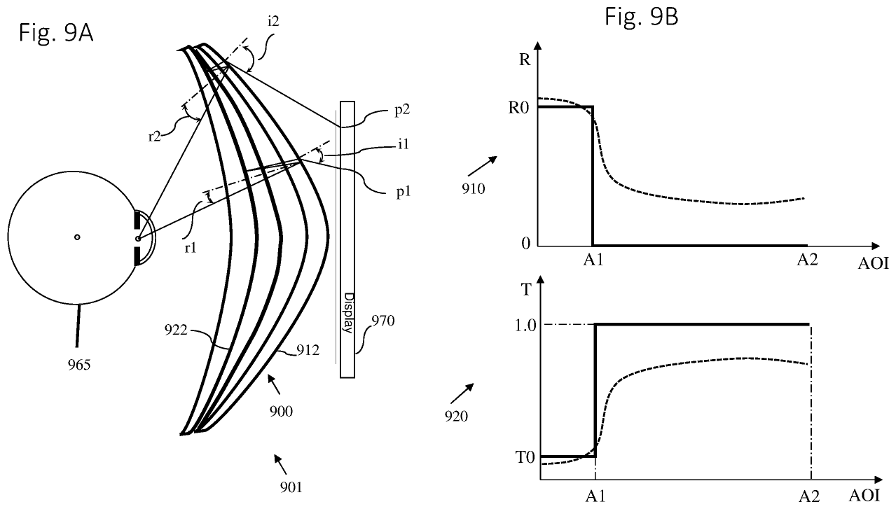

Reference is now made to FIG. 9A, which schematically illustrates a system 901, in accordance with some demonstrative aspects. For example, system 101 (FIG. 1) may include one or more elements of system 901, and/or may be configured to perform the functionality of system 901.

In one example, system 901 may include one or more elements of system 801 (FIG. 8A), and/or may be configured to perform at least part of the functionality of system 801 (FIG. 8A).

In some demonstrative aspects, as shown in FIG. 9A, system 901 may include a catadioptric lens 900 and a display 970, e.g., as described below.

In some demonstrative aspects, as shown in FIG. 9A, catadioptric lens 900 may be configured to direct light from display 970 to an eye 965 of a user. in some demonstrative aspects, reflectivity and/or transmissivity of a semi-reflective surface 912 of the catadioptric lens 900 may be configured, for example, based on an angle of incidence of light from the display 970 with respect to the semi-reflective surface 912, e.g., as described below.

In some demonstrative aspects, as shown in FIG. 9A, light from a first pixel, denoted p1, and light from a second pixel, denoted p2, may propagate towards a pupil of the eye 965.

In some demonstrative aspects, the catadioptric lens 900 may be configured using “mostly concave” surfaces, e.g., a “mostly concave” semi-reflective surface 912, and/or a “mostly concave” reflective polarizer surface 922.

In some demonstrative aspects, as shown in FIG. 9A, the “mostly concave” semi-reflective surface 912 and/or “mostly concave” reflective polarizer surface 922 may be configured, for example, such that light from the first pixel p1 may be reflected by the semi-reflective surface 912 at a first reflection angle, denoted r1.

In some demonstrative aspects, as shown in FIG. 9A, the “mostly concave” semi-reflective surface 912 and/or “mostly concave” reflective polarizer surface 922 may be configured, for example, such that the first reflection angle r1 may be, for example, smaller than an angle of incidence, denoted i1, of the light from the first pixel p1 on the semi-reflective surface 912.

In some demonstrative aspects, as shown in FIG. 9A, the “mostly concave” semi-reflective surface 912 and/or the “mostly concave” reflective polarizer surface 922 may be configured, for example, such that light from the second pixel p2 may be reflected by the semi-reflective surface 912 at a second reflection angle, denoted r2.

In some demonstrative aspects, as shown in FIG. 9A, the “mostly concave” semi-reflective surface 912 and/or the “mostly concave” reflective polarizer surface 922 may be configured, for example, such that the second reflection angle r2 may be, for example, smaller than an angle of incidence, denoted i2, of the light from the second pixel p2 on the semi-reflective surface 912.

In some demonstrative aspects, as shown in FIG. 9A, the “mostly concave” semi-reflective surface 912 and/or “mostly concave” reflective polarizer surface 922 may be configured, for example, such that the incidence angle i2 may increase, for example, with an increase in a distance of the pixel p2 from a central pixel of display 970.

In some demonstrative aspects, as shown in FIG. 9A, the “mostly concave” semi-reflective surface 912 and/or the “mostly concave” reflective polarizer surface 922 may be configured, for example, such that the reflection angle r2 stays within a relatively limited range, for example, with the increase in the distance of the pixel p2 from a central pixel of display 970.

Reference is made to FIG. 9B, which schematically illustrates a first graph 910 depicting transmissivity of a semi-reflective surface 912 of a lens, and a second graph 920 depicting reflectivity of the semi-reflective surface 912 of the lens, in accordance with some demonstrative aspects.

In some demonstrative aspects, the first graph 910 may depict the reflectivity (R) of the semi-reflective surface 912 (FIG. 9A) versus an Angle of Incidence (AOI) of light with respect to semi-reflective surface 912 (FIG. 9A).

In some demonstrative aspects, the reflectivity of the semi-reflective surface 912 (FIG. 9A) versus the AOI may be defined by the plot in graph 910 (FIG. 9B), e.g., with the parameter R0=0.5. In other aspects, a different value of RO may be used.

In some demonstrative aspects, the second graph 920 may depict the transmissivity (T) of the semi-reflective surface 912 (FIG. 9A) versus the AOI of light with respect to the semi-reflective surface 912 (FIG. 9A).

In some demonstrative aspects, the transmissivity of the semi-reflective surface 912 (FIG. 9A) versus the AOI may be defined by the plot in graph 920 (FIG. 9B), e.g., with the parameter T0=0.5. In other aspects, a different value of TO may be used.

In some demonstrative aspects, an angle, denoted A0 may represent a maximal value of the reflection angle r2, e.g., over substantially all pixels.

In some demonstrative aspects, as shown in FIG. 9B, an AOI value, denoted A1, may represent an AOI corresponding to the angle A0. For example, the AOI value A1 may be determined based on the following relationship (Snell's law):

$$sin ( A 1 ) = ( NL / N ) * sin ( A 0 )$$

wherein NL denotes a refractive index of the material of the lens, and N denotes the refractive index of the media surrounding the lens.

In some demonstrative aspects, as shown in FIG. 9B, an AOI value, denoted A2, may represent a maximal value of the angle of incidence i2, e.g., over substantially all pixels.

In some demonstrative aspects, a semi-reflective surface of a lens, e.g., semi-reflective surface 912 (FIG. 9A), may be formed by a coating characterized according to the characteristics of graph 910 and/or graph 920.

In some demonstrative aspects, a semi-reflective surface of a lens, e.g., semi-reflective surface 912 (FIG. 9A), may be coated by a coating, which may be configured, for example, based on characteristics of an ideal coating e.g., depicted by the solid lines in graphs 910 and 920.

In some demonstrative aspects, a semi-reflective surface of a lens, e.g., semi-reflective surface 912 (FIG. 9A), may be coated by a coating, which may be configured, for example, to have characteristics, which are similar to the ideal coating, e.g., as depicted by the dashed lines in graphs 910 and 920.

In some demonstrative aspects, as shown in FIG. 9B, an catadioptric lens, e.g., catadioptric lens 900 (FIG. 9A), may be configured to provide a technical solution to support a theoretical maximum catadioptric lens transmission efficiency LE=R*T, e.g., assuming there are no optical losses in any of the lens elements, where R and T are the reflectivity and transmissivity of the semi-reflective coating of the surface 912 respectively. Preferably, the optical losses of the semi-reflecting coating are negligible, and substantially, R+T=1.

In some demonstrative aspects, as shown in FIG. 9B, a catadioptric lens, e.g., catadioptric lens 900 (FIG. 9A), may be configured to have a semi-reflecting coating similar to the ideal coating, e.g., as shown by the solid lines in FIG. 9B. For example, in case R0=T0=0.5, the lens 900 (FIG. 9A) may provide a maximal theoretical efficiency for a peripheral FoV of about 50%, and/or a lens efficiency for the central FoV of about 25%.

In some demonstrative aspects, a semi-reflective surface of a lens, e.g., semi-reflective surface 912 (FIG. 9A), may be formed by a coating having properties, e.g., reflectivity and/or transmissivity, which may vary over the surface. For example, for the central zone of the surface 912, the angle A1 may be equal to A1C. For example, for the peripheral zone, the angle A1 may be equal to the angle A1P. For example, the angle A1P may be larger than the angle A1C. According to this example, the surface 912 may have at least two zones with the semi-reflective coatings according to the FIG. 9B, but with the different angle parameters A1.

In another example, the surface 912 may be divided into more than two zones, each zone having a semi-reflective coating according to the FIG. 9B, but with a different parameter A1.

In another example, the parameters RO and TO of the coating on the surface 912 may be equal to any other values different from 0.5, for example, in at least some of the coating zones on the surface 912.

In another example, in at least some of the zones of the semi-reflecting coating of the surface 912, the parameter RO may be equal to, or close to, 1.0, for example, to provide the optical transmission efficiency of the parts of the catadioptric folder corresponding to the coating zones with RO equal to, or being close to, 1.0, for example, reaching, or being close to, the maximum theoretical value of 100%.

In another example, the transition between the zones of the semi-reflecting coating on the surface 912 may be continuous, e.g., with continuously varying coating parameters A1, RO and TO.

Referring back to FIG. 1, in some demonstrative aspects, catadioptric folder 102 may include a Diffractive Optical Element (DOE) between the first surface 112 and the second surface 122, e.g., as described below.

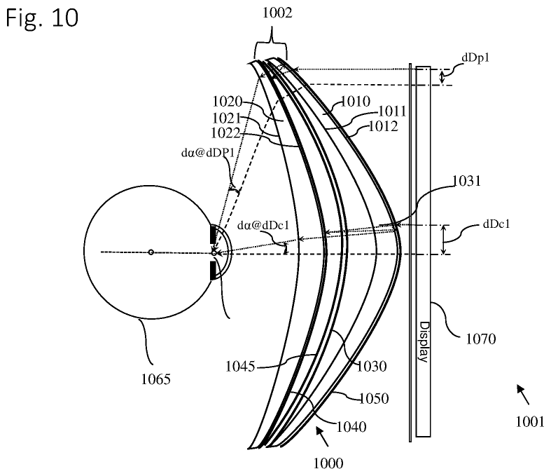

Reference is now made to FIG. 10, which schematically illustrates a system 1001, in accordance with some demonstrative aspects. For example, system 101 (FIG. 1) may include one or more elements of system 1001, and/or may be configured to perform the functionality of system 1001.

In one example, system 1001 may include one or more elements of system 801 (FIG. 8A), and/or may be configured to perform at least part of the functionality of system 801 (FIG. 8A).

In some demonstrative aspects, as shown in FIG. 10, system 1001 may include an optical lens 1000 and a display 1070, e.g., as described below.

In some demonstrative aspects, catadioptric lens 1000 may be configured to direct light from display 1070 to an eye 1065 of a user.

In some demonstrative aspects, as shown in FIG. 10, catadioptric lens 1000 may include a first lens 1010 including a surface 1011 and a semi-reflective surface 1012, e.g., including a semi-reflective coating 1050.

In some demonstrative aspects, as shown in FIG. 10, catadioptric lens 1000 may include a second lens 1020 including a near-eye surface 1021 and a reflective polarizer surface 1022, e.g., including a polarizer 1040.

In some demonstrative aspects, as shown in FIG. 10, catadioptric lens 1000 may include a retarder 1030, e.g., a QWP retarder or any other type of retarder, between the first lens 1010 and the second lens 1020.

In some demonstrative aspects, as shown in FIG. 10, a catadioptric folder 1002 may be formed by the semi-reflective surface 1012, the reflective polarizer surface 1022, and the retarder 1030.

In some demonstrative aspects, as shown in FIG. 10, catadioptric folder 1002 may include a DOE 1045 between the semi-reflective surface 1012 and the reflective polarizer surface 1022, e.g., between the first lens 1010 and the second lens 1020.

In some demonstrative aspects, DOE 1045 may include a Holographic Optical Element (HOE), a kinoform, a diffraction lens based on a surface relief grating structure, and/or any other additional and/or alternative diffractive element.

In some demonstrative aspects, DOE 1045 may be configured to provide a technical solution to reduce chromatic aberration of system 1001, and/or any other types of aberrations of system 1001.

In some demonstrative aspects, as shown in FIG. 10, an optical path 1031 of a light beam propagating from the display 1070 towards the eye 1065 may cross the DOE 1045 three times. Accordingly, the DOE 1045 may diffract the light beam, e.g., three times.

In some demonstrative aspects, a diffraction structure provided by DOE 1045 may have a pitch, which may be, for example, about three times larger than a single-pass DOE applied in a single pass, e.g., a non-folded path, to achieve a same light bending effect as the DOE 1045.

In some demonstrative aspects, DOE 1045 may be located to the left or to the right of the QWP retarder 1030.

Referring back to FIG. 1, in some demonstrative aspects, catadioptric folder 102 may include a segmented dioptric adjuster (not shown in FIG. 1), for example, between the first surface 112 and the second surface 122, e.g., as described below.

In some demonstrative aspects, the segmented dioptric adjuster may be configured to apply a plurality of diopter adjustments to a respective plurality of diopter adjuster segments, e.g., as described below.

In some demonstrative aspects, the plurality of diopter adjustments may include at least first and second different diopter adjustments, e.g., as described below.

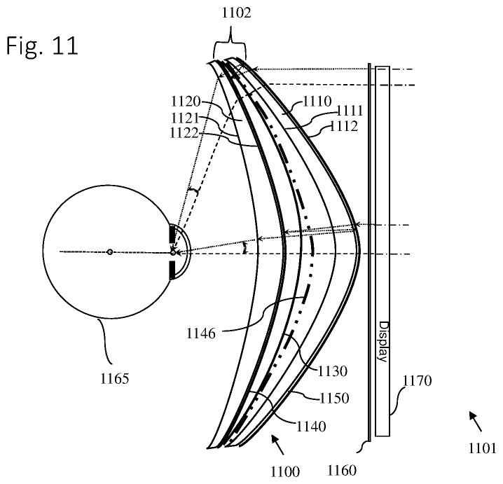

Reference is now made to FIG. 11, which schematically illustrates a system 1101, in accordance with some demonstrative aspects. For example, system 101 (FIG. 1) may include one or more elements of system 1101, and/or may be configured to perform the functionality of system 1101.

In one example, system 1101 may include one or more elements of system 801 (FIG. 8A), and/or may be configured to perform at least part of the functionality of system 801 (FIG. 8A).

In some demonstrative aspects, as shown in FIG. 11, system 1101 may include a catadioptric lens 1100 and a display 1170, e.g., as described below.

In some demonstrative aspects, catadioptric lens 1100 may be configured to direct light from display 1170 to an eye 1165 of a user.

In some demonstrative aspects, as shown in FIG. 11, catadioptric lens 1100 may include a first lens 1110 including a surface 1111 and a semi-reflective surface 1112, e.g., including a semi-reflective coating 1150.

In some demonstrative aspects, as shown in FIG. 11, catadioptric lens 1100 may include a second lens 1120 including a near-eye surface 1121 and a reflective polarizer surface 1122, e.g., including a polarizer 1140.

In some demonstrative aspects, as shown in FIG. 11, catadioptric lens 1100 may include a retarder 1130, e.g., a QWP retarder, between the first lens 1110 and the second lens 1120.

In some demonstrative aspects, as shown in FIG. 11, a catadioptric folder 1102 may be formed by semi-reflective surface 1112, reflective polarizer surface 1122, and the retarder 1130.

In some demonstrative aspects, as shown in FIG. 11, catadioptric folder 1102 may include a segmented dioptric adjuster 1146 between the semi-reflective surface 1112 and reflective polarizer surface 1122, e.g., between the first lens 1110 and the second lens 1120.

In some demonstrative aspects, segmented dioptric adjuster 1146 may include a Diopter Adjustment Layer (DAL), and/or any other additional or alternative optical element and/or layer.

In some demonstrative aspects, segmented dioptric adjuster 1146 may include a segmented optical element with tunable optical power.

In some demonstrative aspects, segmented dioptric adjuster 1146 may be configured to change an optical path of beams emitted by some or all of the pixels of the display 1170.

In some demonstrative aspects, segmented dioptric adjuster 1146 may be configured to provide a technical solution to support changing optical paths of beams passing through different segments of the DAL 1146, e.g., independently.

In some demonstrative aspects, segmented dioptric adjuster 1146 may be configured to change the optical paths of the beams passing through different segments of the DAL 1146, for example, such that different objects in a projected image of the display 1170 may be projected to the eye 1165 of the user as being placed at different focal distances.

In some demonstrative aspects, segmented dioptric adjuster 1146 may be configured to provide a technical solution to a Vergence Accommodation Conflict (VAC), for example, when implemented with a system for eye pupil tracking and an image processor.

Referring back to FIG. 1, in some demonstrative aspects, system 101 may include a lens-display retarder 160, which may be configured to convert a polarization, e.g., a linear polarization, of the light propagating from the display 170 to the first surface 112, e.g., as described below.

In some demonstrative aspects, the lens-display retarder 160 may be configured to convert the linear polarization of the light from the display 170 into a circular polarization to be transferred by the first surface 112, e.g., as described below.

In some demonstrative aspects, an optical axis of the retarder 130 may be orthogonal to an optical axis of the lens-display retarder 160, e.g., as described below.

In some demonstrative aspects, the retarder 130 and the lens-display retarder 160 may have substantially identical optical configurations, e.g., as described below.

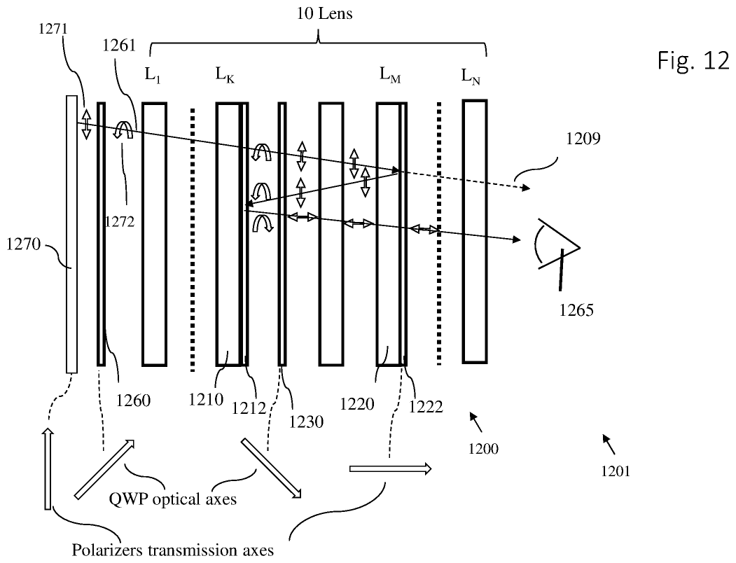

Reference is now made to FIG. 12, which schematically illustrates a system 1201, in accordance with some demonstrative aspects. For example, system 101 (FIG. 1) may include one or more elements of system 1201, and/or may be configured to perform the functionality of system 1201.

In one example, system 1201 may include one or more elements of system 801 (FIG. 8A), and/or may be configured to perform at least part of the functionality of system 801 (FIG. 8A).

In some demonstrative aspects, as shown in FIG. 12, system 1201 may include a catadioptric lens 1200 and a display 1270, e.g., as described below.

In some demonstrative aspects, catadioptric lens 1200 may be configured to direct light from display 1270 to an eye 1265 of a user.

In some demonstrative aspects, as shown in FIG. 12, catadioptric lens 1200 may include a plurality of lenses including N, denoted LI-LN, e.g., ten lenses or any other number of lenses.

In some demonstrative aspects, catadioptric lens 1200 may include a first lens 1210, denoted Lx, which may include a semi-reflective surface 1212.

In some demonstrative aspects, as shown in FIG. 12, catadioptric lens 1200 may include a second lens 1220, denoted LM, which may include a reflective polarizer surface 1222.

In some demonstrative aspects, as shown in FIG. 12, catadioptric lens 1200 may include a retarder 1230, e.g., a QWP retarder or any other retarder, between the first lens 1210 and the second lens 1220.

In some demonstrative aspects, as shown in FIG. 12, a catadioptric folder may be formed by the semi-reflective surface 1212, the reflective polarizer surface 1222, and the retarder 1230.

In some demonstrative aspects, as shown in FIG. 12, system 1201 may include a lens-display retarder 1260 between the display 1270 and the semi-reflective surface 1212.

In some demonstrative aspects, lens-display retarder 1260 may be configured to convert a polarization of light from the display 1270 into a circular polarization to be transferred by the semi-reflective surface 1212.

In some demonstrative aspects, as shown in FIG. 12, lens-display retarder 1260 may be configured to convert light 1261 from the display 1270 having a linear polarization 1271 into light having a first handedness circular polarization 1272.

In some demonstrative aspects, an optical axis of the retarder 1230 may be orthogonal to an optical axis of the lens-display retarder 1260.

In some demonstrative aspects, the retarder 1230 and the lens-display retarder 1260 may have substantially identical optical configurations.

In some demonstrative aspects, as shown in FIG. 12, system 1201 may be configured to support a folded light path, for example, by applying a polarization control, e.g., based on the reflective polarizer surface 1222.

In some demonstrative aspects, as shown in FIG. 12, system 1201 may include the display 1270, the set of lenses LI-LN, two Quarter Wave Plate (QWP) retarders, e.g., the retarder 1230 and the lens-display retarder 1260, a semi-reflective mirror, e.g., semi-reflective surface 1212 on the surface of the lens LK, and a reflecting polarizer, e.g., reflective polarizer surface 1222 on the surface of the lens LM.

In some demonstrative aspects, the lens-display retarder 1260 may be configured to provide a technical solution to address one or more imperfections of polarization elements in system 1201, e.g., as described below.

In one example, light from display 1270 may not be fully linearly polarized, for example, when the light arrives at the reflective polarizer surface 1222.

For example, the light from display 1270 may have some degree of elliptical polarization. As a result, a ray 1209 of the light may not be fully reflected back by the reflective polarizer surface 1222, and may partially propagate through the reflective polarizer surface 1222, e.g., in an unwanted manner.

In one example, unwanted rays, e.g., such as ray 1209, may form a parasitic image at the eye 1265, e.g., through a ghost image.

In one example, an imperfection of a QWP retarder 1230, e.g., a chromatic dispersion, may be one of major contributors to a polarization elasticity of the light from display 1270. For example, the chromatic dispersion may result in a situation where a retardance of the QWP retarder 1230 may equal to lamda/4, e.g., only at wavelengths of a limited wavelength range. For example, at other wavelengths, the retardance of the QWP retarder 1230 may not be equal to lamda/4. Accordingly, the retarder 1230 may convert the linearly polarized light into elliptically polarized light, e.g., at the other wavelengths.

In some demonstrative aspects, as shown in FIG. 12, the QWP retarder 1230 and the lens-display retarder 1260 may be arranged, for example, such that the optical axes, e.g., the slow optical axes, of retarder 1230 and retarder 1260 are substantially orthogonal to one another.

In some demonstrative aspects, a transmission axis of a polarizer of the display 1270 may be orthogonal to an axis of the reflective polarizer surface 1222.

In some demonstrative aspects, the axes of the QWP retarder 1230 and the lens-display retarder 1260 may be configured to be orthogonal to each other, and/or the QWP retarder 1230 and the lens-display retarder 1260 are made from a same material, for example, to provide a technical solution where a phase delay, e.g., any phase delay, introduced by the lens-display retarder 1260 may be canceled, e.g., substantially precisely canceled, by the QWP retarder 1230.

In some demonstrative aspects, the QWP retarder 1230 and the lens-display retarder 1260 may be made from the same material and/or manufactured using a same technology, for example, to provide a technical solution where the QWP retarder 1230 may substantially perfectly cancel the phase shift introduced by the lens-display retarder 1260.

In some demonstrative aspects, the QWP retarder 1230 and the lens-display retarder 1260 may be made from the same material and/or manufactured using a same technology, for example, to provide a technical solution where the light from the display 1270 may arrive at the reflective polarizer 1222 substantially linearly polarized, for example, at a same polarization after the display 1270, and may be efficiently reflected back by the reflective polarizer 1222.

In some demonstrative aspects, an intensity of light that can still pass through the reflective polarizer 1222 may be defined by an imperfect extinction ratio of the reflective polarizer 1222.

Referring back to FIG. 1, in some demonstrative aspects, system 111 may include one or more reflectors (not shown in FIG. 1) at a peripheral area outside the optical path of the catadioptric lens 100, e.g., as described below.

In some demonstrative aspects, the one or more reflectors may be configured to reflect towards the display 170 reflected light from the first surface 112, e.g., as described below.

In some demonstrative aspects, the reflected light from the first semi-reflective surface 112 may include a portion of the light from the display 170, which may be reflected by the semi-reflective surface 112, e.g., as described below.

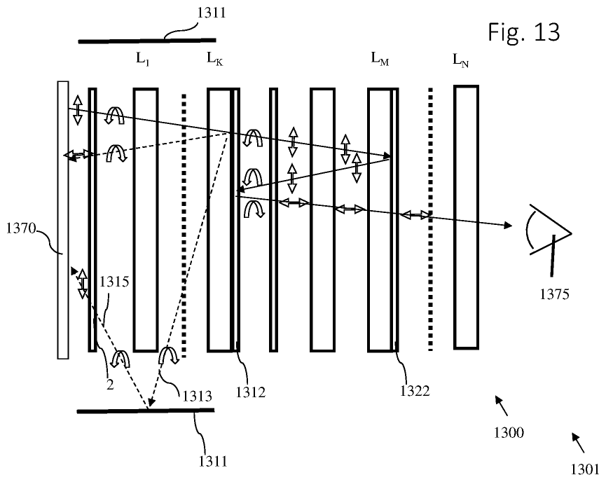

Reference is now made to FIG. 13, which schematically illustrates a system 1101, in accordance with some demonstrative aspects. For example, system 101 (FIG. 1) may include one or more elements of system 1301, and/or may be configured to perform the functionality of system 1301.

In one example, system 1301 may include one or more elements of system 1201 (FIG. 12), and/or may be configured to perform at least part of the functionality of system 1201 (FIG. 12).

In some demonstrative aspects, as shown in FIG. 13, system 1301 may include a catadioptric lens 1300 and a display 1370, e.g., as described below.

In some demonstrative aspects, catadioptric lens 1300 may be configured to direct light from display 1370 to an eye 1375 of a user.

In some demonstrative aspects, as shown in FIG. 13, system 1301 may include one or more reflectors 1311 at a peripheral area outside the optical path of catadioptric lens 1300, e.g., as described below.

In some demonstrative aspects, as shown in FIG. 13, the one or more reflectors 1311 may be configured to reflect towards the display 1370 reflected light 1313 from a semi-reflective surface 1312 of the catadioptric lens 1300.

In some demonstrative aspects, the reflected light 1313 from the semi-reflective surface 1312 may include a portion of the light from the display 1370, which may be reflected by the semi-reflective surface 1312.

In some demonstrative aspects, as shown in FIG. 13, a catadioptric folder, e.g., catadioptric folder 102 (FIG. 1), may be formed by the semi-reflective surface 1312, and a reflective polarizer surface 1322 of the catadioptric lens 1300.

In one example, a non-reflective system, e.g., a system without the reflectors 1311, may be able to provide a transmission efficiency of about 25% with respect to the light from the display 1370 to the eye 1375. This degraded level of the transmission efficiency may be due to the light “wasted” by a semi-reflective mirror of the semi-reflective surface 1312.

For example, a transmission efficiency, denoted E, of a system may be calculated, e.g., as follows:

$$E = T 1 * R 2 * R 1 * T 2 = 0.25$$

wherein R1 denotes a reflectivity of the semi-reflective surface 1312, e.g., may be equal to about 0.5, e.g., R1=0.5, or any other value; T1 denotes a transmission of the semi-reflective surface 1312, which may be based on the reflectivity of the semi-reflective surface 1312, e.g., T1=1−R1; wherein R2 denotes a reflectivity of the reflective polarizer surface 1322, e.g., may be equal to one, e.g., R2=1, or any other value; and T2 denotes a transmission of the reflective polarizer surface 1322 for a transmitted polarization, e.g., may be equal to 1, e.g., T2=1, or any other value.

In some demonstrative aspects, the reflective polarizer surface 1322 may reflect 50% of light emitted by the display 1370 at a first pass. This light may be lost or may be a source of stray light.

In some demonstrative aspects, as shown in FIG. 13, the one or more reflectors 1311 may be configured to collect at least some of the reflected light 1313, which may be reflected by the semi-reflective surface 1312. For example, the one or more reflectors 1311 may be configured to direct the reflected light 1313 towards the display 1370, for example, for “light recycling”.

In one example, the display 1370 may emit linear polarized light, denoted by a vertical arrow, for example, when display 1370 includes an LCD with a backlight panel.

In some demonstrative aspects, as shown in FIG. 13, a polarization of the reflected light 1315, which is reflected by the one or more reflectors 1311 towards the display 1370, may be substantially the same as a polarization of the light emitted by the display 1370, e.g., they may both have a same linear polarization. Accordingly, the reflected light 1315 may be able to pass to the backlight panel of display 1370, and to be recycled.

In some demonstrative aspects, the one or more reflectors 1311 may be configured to provide a technical solution to increase the display brightness, and/or to improve an overall lens system efficiency.

Referring back to FIG. 1, in some demonstrative aspects, the retarder 130 may include folded edges (not shown in FIG. 1), which may be folded between inner surfaces of the first lens 110 and the second lens 120, e.g., as described below.

In some demonstrative aspects, the retarder 130 may include radial cuts (not shown in FIG. 1) on edges of the retarder 130. For example, the radial cuts may be folded between inner surfaces of the first lens 110 and the second lens 120, e.g., as described below.

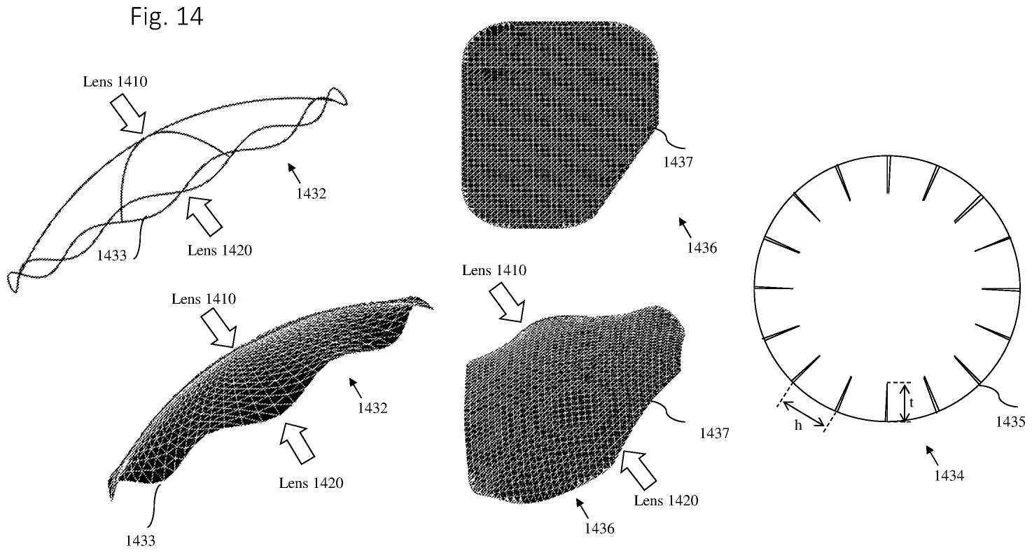

Reference is made to FIG. 14, which schematically illustrates a first retarder 1432, a second retarder 1436, and a third retarder 1434, in accordance with some demonstrative aspects.

In one example, retarder 130 (FIG. 1) may include the first retarder 1432, the second retarder 1436, or the third retarder 1434, and/or may provide at least the functionality of the first retarder 1432, the second retarder 1436, or the third retarder 1434.

In some demonstrative aspects, as shown in FIG. 14, the retarder 1432 may include corrugated (or folded) edges 1433, which may allow the retarder film to fit between inner surfaces of a first lens 1410 and a second lens 1420, e.g., as described below.

In some demonstrative aspects, the retarder 1436 may include a nose cut 1437, e.g., if the lens aperture is ergonomically cut to have a similar form factor to sun glasses, on a side of the retarder 1436, e.g., as described below.

In some demonstrative aspects, the retarder 1434 may include radial cuts 1435 on edges of the retarder 1434, e.g., as described below.

In some demonstrative aspects, the radial cuts 1435 may be folded between the inner surfaces of the lenses 1410 and 1420, e.g., as described below.

In one example, a retarder may be laminated, e.g., directly laminated, on a surface of a reflective polarizer. However, in some implementations, it may be a challenging task to laminate a retarder film on a non-planar surface. For example, a polymer film retarder may include a single or multi-layered stack of polymer birefringent films.

According to this example, the polymer film retarder may be heated above or slightly above a film material glass transition temperature, for example, in order to deform the polymer film retarder and to laminate the polymer film retarder on a non-planar surface. As a result, at such a temperature, the polymer film retarder may be likely to lose its retardance properties.

In some demonstrative aspects, a retarder, e.g., a planar QWP retarder film, may be used as a stand-alone film, for example, with Anti Reflective (AR) coating on both sides.

In some demonstrative aspects, the retarder may be configured to deform, for example, as it is placed between two curved surfaces.

In one example, the retarder may deform with corrugation or wrinkles, which may be formed at the film surface of the retarder at an area, which may be close to the film edges.

In some demonstrative aspects, the corrugation may have a limited impact on an optical performance of a lens, e.g., if such a corrugation is not significant.

In some demonstrative aspects, as shown in FIG. 14, the retarder 1432 may include folded edges, which may be configured to reduce the corrugation or wrinkles on the film surface of the retarder 1432.

In some demonstrative aspects, a lens with a circular aperture may be ergonomically cut, for example, to make the lens more comfortable for a user.

In some demonstrative aspects, the lens may be ergonomically cut, for example, to provide a cut for a user nose.

In some demonstrative aspects, as shown in FIG. 14, the retarder 1436 may include a nose cut 1437, e.g., at a bottom right area of a retarder film of retarder 1436.

In some demonstrative aspects, the nose cut 1437 may be configured to provide a technical solution to allow the retarder film of retarder 1436 to fit between the two curved lenses 1410 and 1420, for example, without the corrugation of the film edges or wrinkles, e.g., by combination of non-normal to optical axis planar orientation and cylindric wrapping with limited corrugation (or folding) of the film edges.

In some demonstrative aspects, as shown in FIG. 14, retarder 1436 may include some corrugations or folds, e.g., folded edges 1433, which may be configured, for example, such that the retarder film may fit in between curved lenses surfaces of lenses 1410 and 1420.

In some demonstrative aspects, the retarder 1434 may include the radial cuts 1435 on the edges of the retarder 1434, for example, to prevent a fold of the retarder film.

In some demonstrative aspects, as shown in FIG. 14, a series of uniform radial cuts 1435 may be formed in a retarder film of retarder 1434.

In some demonstrative aspects, as shown in FIG. 14, the retarder 1434 may be configured, for example, such that when the retarder 1434 is placed between the lenses 1410 and 1420, the inner parts of the lenses 1410 and 1420 between the radial cuts 1435 may be bended and the cuts may be closed. Accordingly, a surface of the retarder 1434 may become uniform, e.g., without missing material within the radial cuts 1435.

In some demonstrative aspects, after bending retarder film parts, for example, to close the radial cuts 1435, joints between the film edges along the cut lines 1435 may be, e.g., seamlessly, bonded together, e.g., with an optical cement and/or a glue, or may be fused together, e.g. by heat, chemical melting, and/or ultra-sonic fusion.

In some demonstrative aspects, the joints between the film edges along the cut lines 1435 may be bonded together, e.g., with an optical cement and/or glue, for example, to make cut lines 1335 less visible for an eye of a user and/or less disturbing to the user.

In some demonstrative aspects, retarder 1434 may be configured to provide a technical solution to support strongly curved lens surfaces, for example, when folds of a retarder film become too large for the retarder film to function in a satisfactory manner, for example, by molding or casting the curved retarder surface, e.g., while having precise control over the spatial thickness to apply stretching at the following to molding or casting phase to get final shape with appropriate slow and/or fast axes.

In some demonstrative aspects, retarder 1434 may be configured to provide a technical solution to support strongly curved lens surfaces. For example, in order to support surfaces with a higher curvature, the length of the cuts may be increased and/or the distance between two adjacent cuts may be decreased, e.g., as compared to the retarder supporting less curved surfaces.

Referring back to FIG. 1, in some demonstrative aspects, lens-display retarder 160 may include a spatially-variable optical axis orientation configured, for example, based on optical parameters of the first surface 112 and/or the second surface 122, e.g., as described below.

In some demonstrative aspects, lens-display retarder 160 may include a spatially-variable phase delay configured, for example, based on optical parameters of the first surface 112 and/or the second surface 122, e.g., as described below.

In some demonstrative aspects, the spatially-variable phase delay may include a phase delay, which may be monotonically changing, for example, over at least 20%, for example, at least 30%, e.g., at least 50%, of the lens-display retarder 160, with the distance from the central axis 105, e.g., as described below.

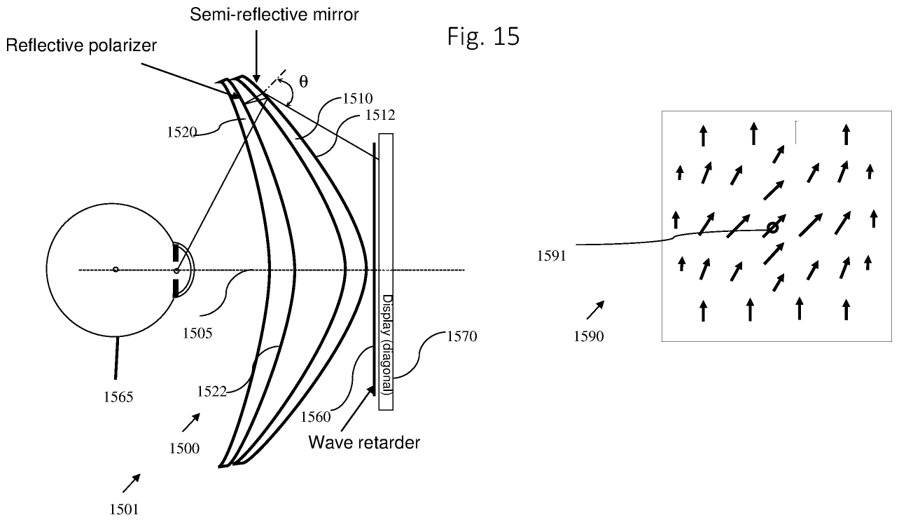

Reference is now made to FIG. 15, which schematically illustrates a system 1501, in accordance with some demonstrative aspects. For example, system 101 (FIG. 1) may include one or more elements of system 1501, and/or may be configured to perform the functionality of system 1501.

In one example, system 1501 may include one or more elements of system 801 (FIG. 8A), and/or may be configured to perform at least part of the functionality of system 801 (FIG. 8A).

In some demonstrative aspects, as shown in FIG. 15, system 1501 may include a catadioptric lens 1500 and a display 1570, e.g., as described below.

In some demonstrative aspects, as shown in FIG. 15, catadioptric lens 1500 may be configured to direct light from display 1570 to an eye 1565 of a user.

In some demonstrative aspects, as shown in FIG. 15, catadioptric lens 1500 may include a first lens 1510 including a semi-reflective surface 1512.

In some demonstrative aspects, as shown in FIG. 15, catadioptric lens 1500 may include a second lens 1520 including a reflective polarizer surface 1522.

In some demonstrative aspects, as shown in FIG. 15, system 1501 may include a lens-display retarder 1560 between display 1570 and the semi-reflective surface 1512 of the lens 1510.

In some demonstrative aspects, as shown in FIG. 15, lens-display retarder 1560 may include a lens retarder 1590, which may be configured to have a spatially-variable optical axis orientation, which may be based, for example, on optical parameters of the semi-reflective surface 1512 and/or the reflective polarizer surface 1522, e.g., as described below.

In some demonstrative aspects, a direction of the arrows in FIG. 15 may represent a local direction of the optical axis of lens retarder 1590.

In some demonstrative aspects, a length of the arrows in FIG. 15 may be proportional to a local phase delay magnitude of the lens retarder 1590.

In some demonstrative aspects, as shown in FIG. 15, a lens optical axis 1505 of lens 1500 may cross a center 1591 of lens retarder 1590.

In some demonstrative aspects, lens-display retarder 1560 may include a spatially-variable phase delay, which may be based, for example, on optical parameters of semi-reflective surface 1512 and/or reflective polarizer surface 1522, e.g., as described below.

In some demonstrative aspects, light from the display 1560 may hit the surfaces of the lenses 1510 and 1520 at high angles of incidence, for example, at high view angles.

In some demonstrative aspects, a difference between reflection, transmission, and phase coefficients for S-polarization components and P-polarization components of the light may increase, for example, as an angle of incidence, denoted θ, at a refracting interface becomes higher.

For example, as shown in FIG. 15, for a high view angle, the angle of incidence θ may be quite high. Accordingly, the semi-reflective mirror surface 1512 may introduce an additional phase delay between the S and P polarization components.

According to this example, an incident circular polarization may change its state and may become an elliptical polarization, for example, after passing through the semi-reflective mirror surface 1512. For example, the elliptical polarization effect may prevent an efficient blocking of the light by the polarizing reflective surface 1522.

In some demonstrative aspects, lens-display retarder 1560 may be configured to have the spatially varying orientation 1590 of the optical axis, for example, in order to compensate for the elliptical polarization effect.

In some demonstrative aspects, lens-display retarder 1560 may be configured to provide a technical solution to support a combined effect of a waveplate and coating retardance at a high angle, which may result in a circular polarization of light, e.g., instead of the elliptical polarization.

In some demonstrative aspects, lens-display retarder 1560 may be configured to have a spatially variable phase delay.

In one example, a phase delay at a center of lens-display retarder 1560 may be Lamda/4, and the phase delay may be gradually reduced, e.g., to become Lamda/5.

In some demonstrative aspects, lens-display retarder 1560 may be configured to combine both axis orientation and phase delay variability, e.g., over a waveplate surface of lens-display retarder 1560.

In some demonstrative aspects, lens-display retarder 1560 may be manufactured as a waveplate with a variable axis orientation or a variable retardance.

In one example, lens-display retarder 1560 may be manufactured by a mechanical method, a method using an engineered meta-surface, and/or a method using a Liquid Crystals (LC) based retarder, e.g., a Liquid Crystals QWP (LCQWP) retarder.

In some demonstrative aspects, the method using the LC based retarder may be implemented to create a QWP retarder with variable axis orientation and/or variable retardance, e.g., over the retarder area.

In some demonstrative aspects, the method using the LC may include a technology, which may be based on incorporating liquid crystal molecules in a host polymer.

In one example, a host polymer may be utilized to provide alignment of LC molecules, for example, by mechanical stress induced during coating.

In another example, a host polymer may include a photo-polymer, in which an orientation of embedded LC molecules may be defined, for example, by a polarization of curing light.

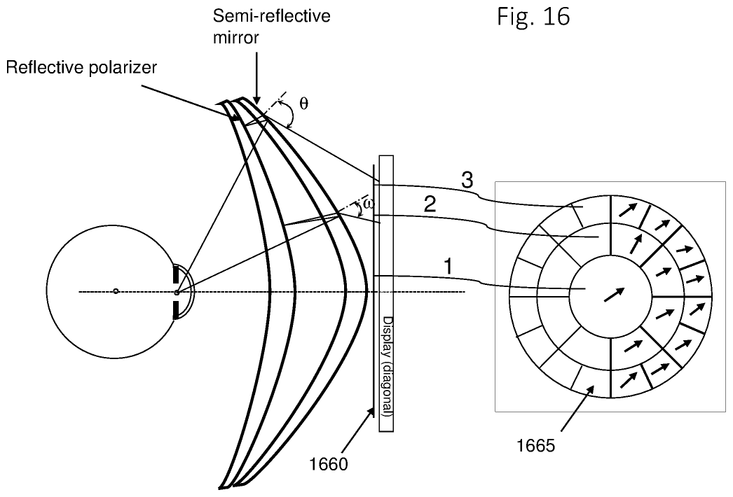

Reference is made to FIG. 16, which schematically illustrates an implementation of a lens-display retarder 1660, in accordance with some demonstrative aspects.

In some demonstrative aspects, lens-display retarder 1560 (FIG. 15) may include lens-display retarder 1660, and/or may provide at least part of the functionality of lens-display retarder 1660.

In some demonstrative aspects, lens-display retarder 1660 may be produced, for example, using the mechanical method.

In some demonstrative aspects, as shown in FIG. 16, lens-display retarder 1660 may be assembled from a plurality of stacked pieces 1665, e.g., a plurality of precisely stacked pieces.

In some demonstrative aspects, as shown in FIG. 16, a stack piece 1665, e.g., each stack piece 1665, may have a different axis orientation.

In some demonstrative aspects, light beams emitted from a display central zone may experience a small angle of incidence at a semi-reflective surface. Accordingly, a phase difference induced by the semi-reflective surface may be relatively small.

In some demonstrative aspects, as shown in FIG. 16, a circular piece 1665, e.g., only one circular piece 1665, denoted 1, may be enough to implement a central region of lens-display retarder 1660, e.g., as the phase difference induced by the semi-reflective surface may be relatively small.

In some demonstrative aspects, as shown in FIG. 16, the further from the display and lens center a display pixel emitting a ray, the larger the angle of incidence of the ray at the semi-reflective surface, e.g., θ>ω. Accordingly, a phase difference introduced by the semi-reflective surface may increase as the angle of incidence increases.

In some demonstrative aspects, as shown in FIG. 16, a plurality of circular pieces 1665, denoted 2 and 3, may be implemented for peripheral regions of lens-display retarder 1660.

In one example, a variation of the direction of the waveplate axis may be stronger, e.g., as the phase difference induced by the semi-reflective surface increases. Accordingly, the plurality of radial segments 1665 may be utilized, for example, to approximate a function of the axis orientation of the lens-display retarder 1660. In another example, a variable retarder may be manufactured with the plurality of radial segments 1665. For example, the retarder may first be molded or casted, e.g., with spatial control of thickness, and may then be spatially stretched multiple times, e.g., starting from outside, for example, to starch the complete structure, and then by stretching internal structures, for example, such that outer structures may already have a required localization of slow and fast axes.

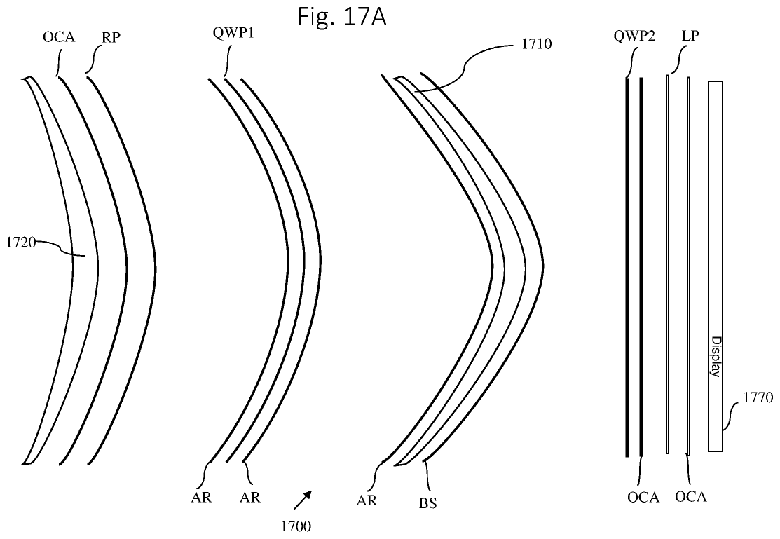

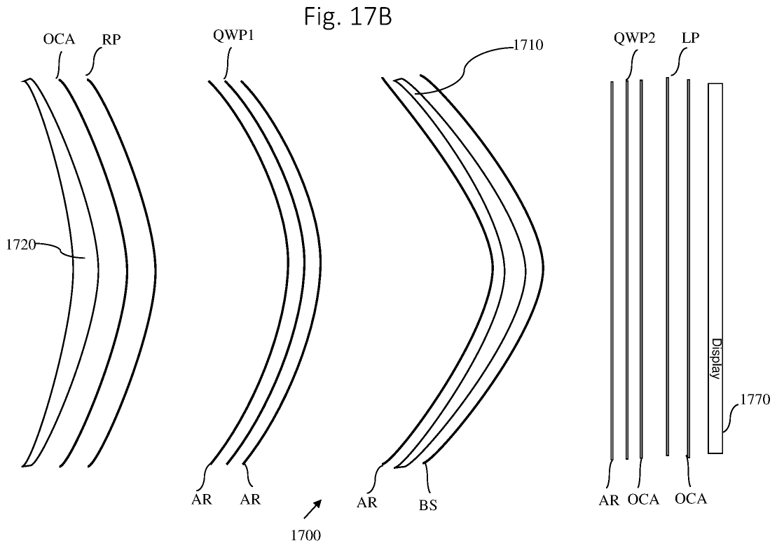

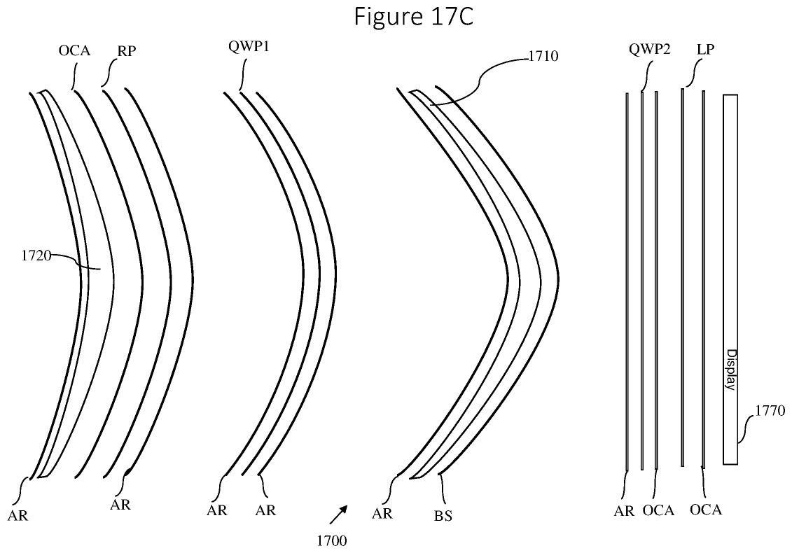

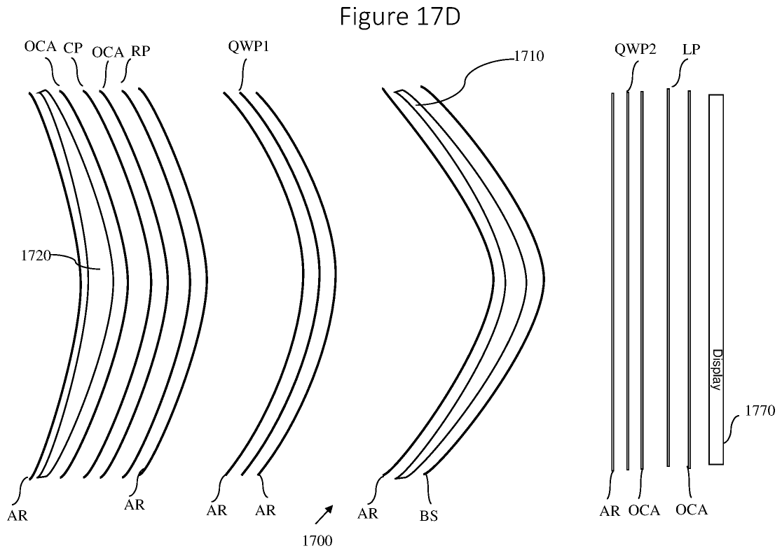

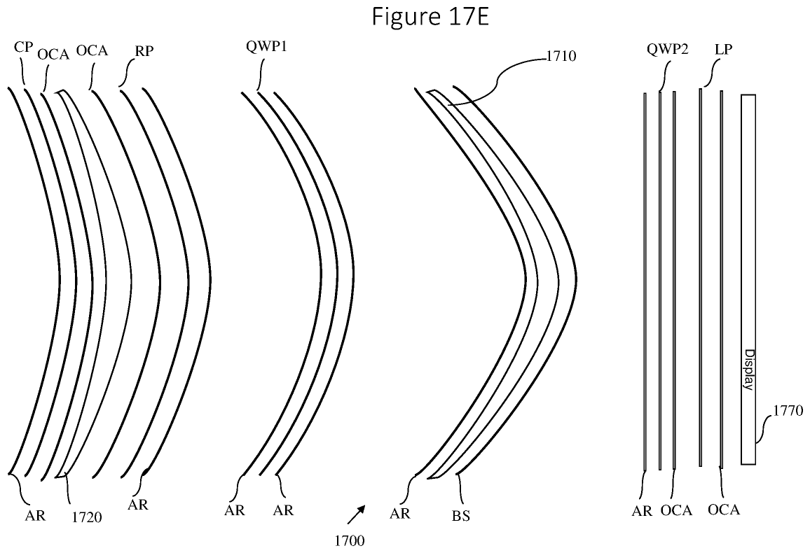

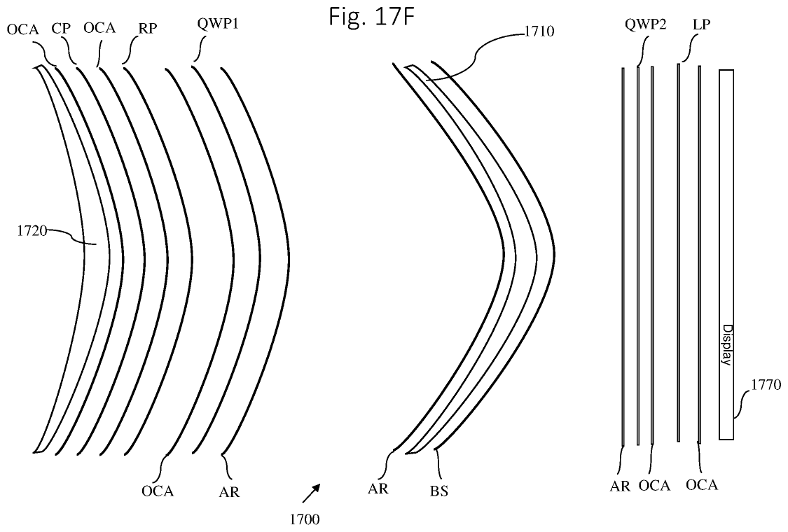

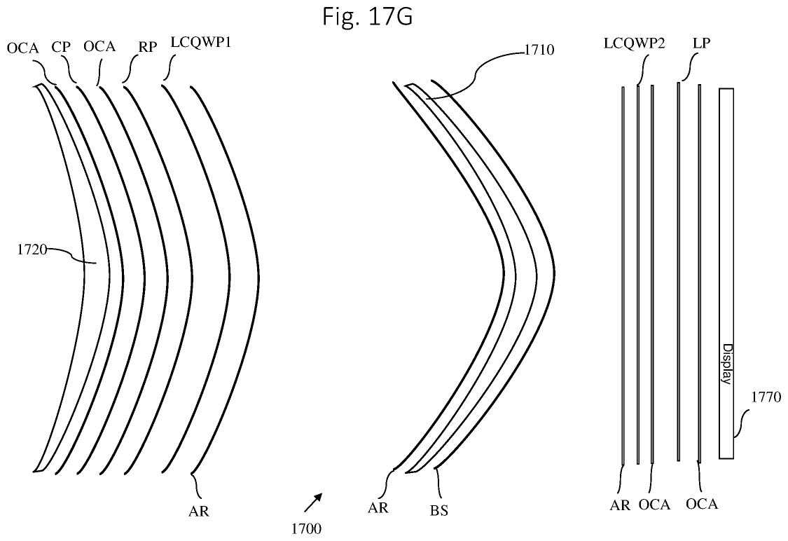

Reference is made to FIGS. 17A, 17B, 17C, 17D, 17E, 17F, and 17G, which schematically illustrate respective configurations of a catadioptric lens 1700, in accordance with some demonstrative aspects.

In some demonstrative aspects, as shown in FIGS. 17A, 17B, 17C, 17D, 17E, 17F, and 17G, catadioptric lens 1700 may include a catadioptric lens 1700 and a display 1770.

In some demonstrative aspects, catadioptric lens 1700 may be configured to direct light from display 1770 to an exit pupil of catadioptric lens 1700.

In some demonstrative aspects, as shown in FIGS. 17A, 17B, 17C, 17D, 17E, 17F, and 17G, catadioptric lens 1700 may include a first lens 1710 and a second lens 1720.

In some demonstrative aspects, as shown in FIGS. 17A, 17B, 17C, 17D, 17E, 17F, and 17G, catadioptric lens 1700 may include a QWP retarder, denoted QWP1, between the first lens 1710 and the second lens 1720.

In some demonstrative aspects, as shown in FIGS. 17A, 17B, 17C, 17D, 17E, 17F, and 17G, catadioptric lens 1700 may include a reflective polarizer, denoted RP, between the second lens 1720 and the QWP retarder.

In some demonstrative aspects, as shown in FIGS. 17A, 17B, 17C, 17D, 17E, 17F, and 17G, catadioptric lens 1700 may include a semi-reflective surface, for example, a semi-reflective mirror, e.g., including a beam splitter coating, denoted BS, between the first lens 1710 and the display 1770.

In some demonstrative aspects, as shown in FIGS. 17A, 17B, 17C, 17D, 17E, 17F, and 17G, catadioptric lens 1700 may include a catadioptric folder formed by the reflective polarizer surface RP and the semi-reflecting beam splitter surface BS.

In some demonstrative aspects, as shown in FIGS. 17A, 17B, 17C, 17D, 17E, 17F, and 17G, catadioptric lens 1700 may include a lens-display QWP retarder, denoted QWP2, between the first lens 1710 and the display 1770.

In some demonstrative aspects, as shown in FIGS. 17A, 17B, 17C, 17D, 17E, 17F, and 17G, catadioptric lens 1700 may include a plurality of anti-reflective (AR) coating layers.

In some demonstrative aspects, an AR coating layer may include a thin film vacuum deposited coating, and/or a nano-surface based coating, and/or a moth-eye type coating, which may be configured to substantially prevent light reflections from a surface coated with the AR coating layer.

In some demonstrative aspects, as shown in FIGS. 17A, 17B, 17C, 17D, 17E, 17F, and 17G, catadioptric lens 1700 may include one or more Optical Clear Adhesive (OCA) layers.

In some demonstrative aspects, an OCA layer may include a very thin adhesive layer, which may be configured to create an optical contact between two elements.

In some demonstrative aspects, an OCA layer between two elements may be configured to bond the two elements together, for example, to provide an optical contact over at least part of, e.g., substantially the entirety of, optical inner surfaces of the two elements.

In some demonstrative aspects, as shown in FIGS. 17A, 17B, 17C, 17D, 17E, 17F and 17G, catadioptric lens 1700 may include a linear polarizer, denoted LP, which may be configured to convert light of display 1770 into a linear polarization, for example, in case display 1770 does not emit light having a linear polarization.

In one example, the liner polarizer may be bonded to the display 1170, for example, using an OCA layer to polarize light, e.g., in case the display 1170 emits non-polarized light.

In some demonstrative aspects, as shown in FIGS. 17A, 17B, 17C, 17D, 17E, 17F and 17G, lens-display QWP retarder and/or QWP retarder may be laminated or stand alone.

In some demonstrative aspects, as shown in FIG. 17A, system 1701 may include a stand-alone retarder QWP1 between the lenses 1710 and 1720.

In some demonstrative aspects, as shown in FIG. 17A, the retarder QWP1 may be covered by AR coatings, e.g., on both sides.

In one example, an AR coating may be made using a vacuum-deposited thin film coating technology, for example, directly on the surfaces of the retarder QWP1.

In another example, an AR coating may be made using a replication process, for example, by the replication of the moth-eye type structure directly on the surfaces of the retarder film.

In another example, the retarder QWP1 may be laminated with AR films on both sides. For example, the AR films may have an AR coating, e.g., a thin film or a moth-eye type film, on a first side, and/or an OCA layer on a second side.

In some demonstrative aspects, the AR films may be configured as to not substantially change a polarization of light passing through them.

In some demonstrative aspects, as shown in FIG. 17B, catadioptric lens 1700 may include the catadioptric lens 1700 of FIG. 17A with an AR coating on retarder QWP2, e.g., on a side opposite to the display 1770.

In some demonstrative aspects, as shown in FIG. 17C, catadioptric lens 1700 may include the catadioptric lens 1700 of FIG. 17B with an AR coating on the reflective polarizer RP, e.g., on a side opposite to the lens 1720.

In some demonstrative aspects, as shown in FIG. 17C, catadioptric lens 1700 may include the catadioptric lens 1700 of FIG. 17B with an AR coating on the left side of the lens 1720, for example, in order to prevent possible light reflections at the air-lens 1720 interface.

In some demonstrative aspects, as shown in FIG. 17D, catadioptric lens 1700 may include the catadioptric lens 1700 of FIG. 17C with a Clean-up Polarizer CP between the lens 1720 and the reflective polarizer RP. In one example, the Clean-up Polarizer CP may be attached to the surface of the lens 1720 and to the surface of the RP using an OCA layer.

In some demonstrative aspects, the Clean-up Polarizer CP may include a linear absorption polarizer, which may be configured to have its transmission axis aligned with the transmission axis of the reflective polarizer RP.

In some demonstrative aspects, as shown in FIG. 17E, catadioptric lens 1700 may include the catadioptric lens 1700 of FIG. 17C with a Clean-up Polarizer CP attached to the left surface of the lens 1720, e.g., using an OCA layer.

In some demonstrative aspects, as shown in FIG. 17F, catadioptric lens 1700 may include the catadioptric lens 1700 of FIG. 17D with the retarder QWP1 laminated over the reflective polarizer RP, for example, using an OCA layer.

In some demonstrative aspects, the Clean-up Polarizer CP may be included in the systems shown in FIGS. 17A, 17B and 17C, e.g., similar to the way shown in FIG. 17D.

In some demonstrative aspects, a group of layers, e.g., including the layers Clean-up Polarizer-OCA-RP, may be attached to the left surface of the lens 1720, for example, using an OCA layer between the RP and the left surface of the lens 1720 (not shown in FIGS. 17A-17G), for example, instead of the right surface of the lens 1720 as shown in FIG. 17D.

In some demonstrative aspects, the lens-display QWP retarder QWP2 and/or the QWP retarder QWP1 may include a QWP retarder formed with a Liquid Crystals based Technology, e.g., an LCQWP retarder.

In some demonstrative aspects, a QWP retarder formed with the LC-based Technology, e.g., an LCQWP retarder, may be deposited directly on a surface of another element.

In some demonstrative aspects, as shown in FIG. 17G, QWP retarder QWP1 may include an LCQWP retarder, denoted LCQWP1.

In some demonstrative aspects, as shown in FIG. 17G, lens-display QWP retarder QWP2 may include a lens-display LCQWP retarder, denoted LCQWP2.

In some demonstrative aspects, as shown in FIG. 17G, a retarder film of LCQWP retarder LCQWP1 may be attached to a surface of the reflective polarizer RP, e.g., even without an OCA layer.

In one example, the retarder film of LCQWP retarder LCQWP1 may be attached to the surface of the reflective polarizer RP, e.g., even without an OCA layer, for example, as a host polymer of the LCQWP retarder may include LC molecules deposited directly on the target surface, for example, in a liquid state, e.g., before the host polymer is polymerized.

In some demonstrative aspects, as shown in FIGS. 17A, 17B, 17C, 17D, 17E, 17F and 17G, where OCA is used to attach a film element (e.g., polarizer RP, CP or retarder QWP1) to the surface of the lens 1720, a co-molding manufacturing process may be used to manufacture the lens 1720 together with the film elements on the sides of the lens. For example, co-molding may utilize an OCA layer for the adhesion and optical contact between the film and the lens surfaces.

In some demonstrative aspects, as shown in FIGS. 17A, 17B, 17C, 17D, 17E, 17F and 17G, an OCA layer may not be required to attach film elements (e.g., RP, CP or QWP1) to the surfaces of the lens 1720 manufactured using a co-molding process, e.g., thanks to the molecular fusion of the film materials with the lens.

In some demonstrative aspects, as shown in FIGS. 17A, 17B, 17C, 17D, 17E, 17F and 17G, an OCA layer may not be required to attach film elements (e.g., RP, CP or QWP1) to the surfaces of the lens 1720 manufactured using a co-molding process, e.g., thanks to the tight mechanical contact between the lens and films surfaces, which may be supported by vacuum between the touching surfaces of the lens and co-molded films. The vacuum between the surfaces may be protected, e.g., by sealing around the lens perimeter (for example using an adhesive).

In some demonstrative aspects, as shown in FIGS. 17A, 17B, 17C, 17D, 17E, 17F and 17G, the AR layer on the surfaces of the lenses 1720 and 1710 may be provided by a moth-eye type anti-reflection structure, which may be manufactured on the surfaces of the lenses, e.g., during the lens molding process. For example, a moth-eye structure may be made on the surfaces of the molds used for lens manufacturing (for example in injection-molding process).

Referring back to FIG. 1, in some demonstrative aspects, a cutting line (not shown in FIG. 1) of the catadioptric lens 100 may be external to a catadioptric box (not shown in FIG. 1) enclosing a folded portion of a maximal-rotation optical path (not shown in FIG. 1) folded between the first surface 112 and the second surface 122, e.g., as described below.

In some demonstrative aspects, the maximal-rotation optical path may be associated with a maximal nasal rotation angle and/or a maximal temporal rotation angle of the eye, e.g., as described below.

In some demonstrative aspects, the catadioptric box may be configured to provide a technical solution to support a mixed reality visual system, e.g., as described below.

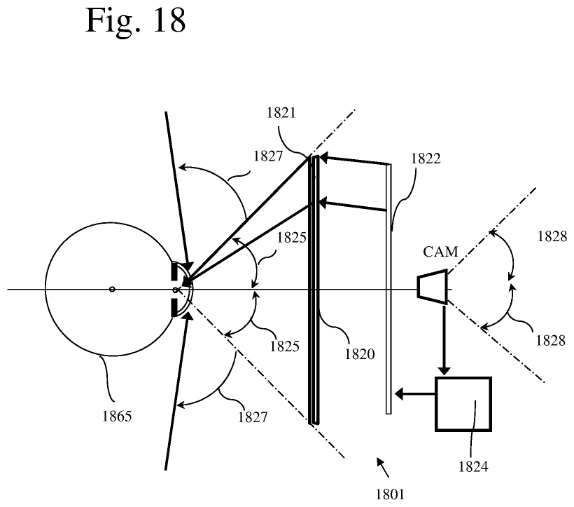

Reference is made to FIG. 18, which conceptually illustrates a mixed reality visual system 1801, which may be implemented in accordance with some demonstrative aspects. In one example, mixed reality visual system 1801 may demonstrate a concept of an catadioptric lens 1820 having an aperture 1821, which may be configured to not substantially cause an obscuration to a real scene.

As shown in FIG. 18, catadioptric lens 1820 may be configured to project into a pupil of an eye 1865 an image displayed by a display 1822.

As shown in FIG. 18, the image may be extended over a FoV angle 1825, while the real scene may be observed through a remaining view angle 1827. For example, human peripheral vision may support sensation of visual stimulation up to about 105 deg of the peripheral view angle, e.g., providing for left and right eyes peripheral sensation of about 210 degree foV. For example, in the mixed reality configuration, an external world camera 1823 and a controller 1824 may be used to display the central FoV of a real scene, e.g., as-is or in amended manner (“video pass-through”).

As shown in FIG. 18, catadioptric lens 1820 may enable a sharp transition inside the complete eye FoV, for example, between the virtual image corresponding to a view angle 1825 or real “pass-through” image corresponding to a view angle 1828, and the real scene, e.g., up to the maximally perceived view angle 1827. This may be achieved, for example, as the aperture 1821 may be configured to be substantially equal to the external dimension of the lens 1820. For example, catadioptric lens 1820 may enable a sharp transition between view angle 1825 and view angle 1827, for example, as a boundary between the virtual image over view angle 1825 or/and view angle 1828 and the real scene over view angle 1827 may be sharp.

Reference is made to FIG. 19, which conceptually illustrates a mixed reality visual system 1901, to demonstrate a technical problem, which may be addressed in accordance with some demonstrative aspects.

In one example, mixed reality visual system 1901 may demonstrate a concept of a catadioptric lens 1920 having an aperture 1921, which may cause an obscuration to a real scene.

As shown in FIG. 19, catadioptric lens 1920 may project into a pupil of an eye 1965 an image displayed by a display 1922.

As shown in FIG. 19, the image may be extended over a view angle 1925, while the real scene may be observed through a pass-through camera having a FoV corresponding to a view angle 1928, e.g., which may be equal to the image view angle 1925, and a remaining view angle 1927.

As shown in FIG. 19, a size of aperture 1921 may be smaller than a mechanical size of catadioptric lens 1920.

As shown in FIG. 19, the mechanical aperture 1921 may obscure a part, e.g., a view angle sector 1926, of the real scene over the view angle 1927. As a result, the mixed reality scene may have a “dead-zone” corresponding to view angle sector 1926.

In some demonstrative aspects, an catadioptric lens, e.g., catadioptric lens 100 (FIG. 1), may be configured to provide a technical solution to reduce, e.g., minimize, the obscuration illustrated by FIG. 19, which may not be desired in mixed reality systems, e.g., as described below.

In some demonstrative aspects, an catadioptric lens, e.g., catadioptric lens 100 (FIG. 1), may be configured to provide a technical solution to reduce, e.g., minimize, the obscuration illustrated by FIG. 19, for example, in an implementation of a catadioptric folder, e.g., as described below.

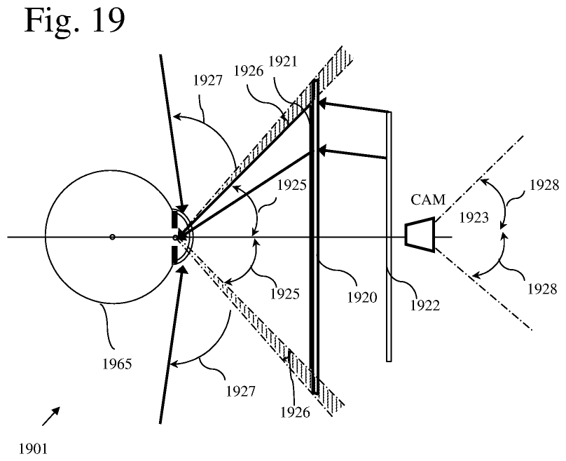

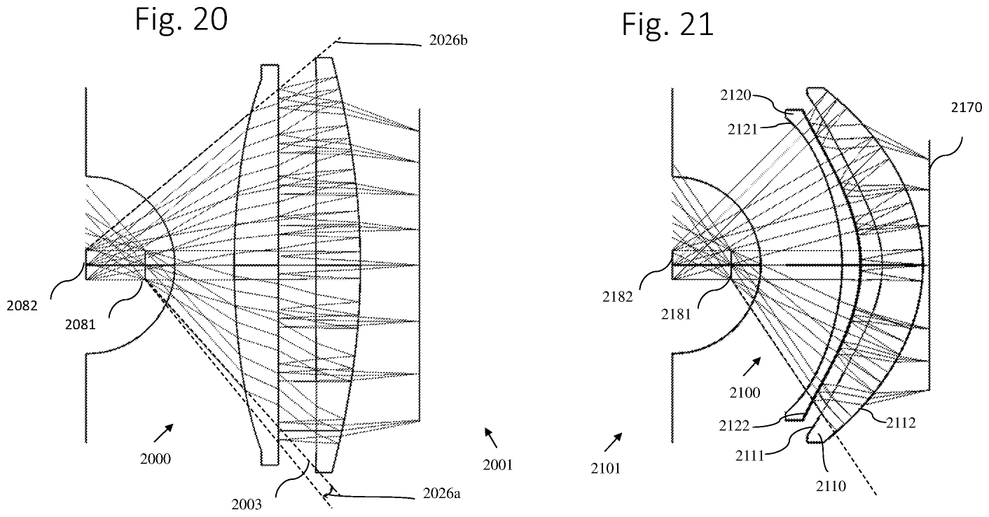

Reference is made to FIG. 20, which schematically illustrate a catadioptric lens 2000 including an catadioptric folder to demonstrate a technical problem, which may be addressed in accordance with some demonstrative aspects.

For example, as shown in FIG. 20, catadioptric lens 2000 may suffer a technical issue of obscuration, which may result from a light path folding.

For example, as shown in FIG. 20, catadioptric lens 2000 may project a virtual image through an exit pupil 2081 of catadioptric lens 2000, which coincides with a pupil of an eye.

For example, as shown in FIG. 20, exit pupil 2081 may correspond to a peripheral vision of the eye.

For example, as shown in FIG. 20, catadioptric lens 2000 may project the virtual image through an exit pupil 2082, which coincides with the eye center of the eye.

For example, as shown in FIG. 20, exit pupil 2082 may correspond to a rotational vision of the eye.

For example, as shown in FIG. 20, a larger FoV image may be projected through the exit pupil 2081, e.g., compared to a FoV image projected through the exit pupil 2082, for example, as the exit pupil 2081 is closer than the exit pupil 2082 to the lens 2000.

For example, as shown in FIG. 20, due to light folding, catadioptric lens 2000 may block part of the peripheral FoV.

For example, as shown in a bottom part of FIG. 20, there may be an obscuration angular sector 2026a for the peripheral FoV.

For example, as shown in a top part of FIG. 20, a last ray of the rotational FoV may corresponds to an angle 2026b. However, as shown on the bottom pat of FIG. 20, there is an angular sector 2026a where there may be no peripheral rays in angular sector 2026a and the range of view angles corresponding to the angular sector 2026a may create a “dead-zone” or zone of obstruction in the mixed reality scene.

In some demonstrative aspects, a cutting line of a catadioptric lens, e.g., catadioptric lens 100 (FIG. 1), may be configured according to a catadioptric box, for example, to provide a technical solution to minimize or eliminate blockage and/or obscuration or obstruction of the peripheral FoV and/or the rotational FoV, e.g., as described below.

Reference is now made to FIG. 21, which schematically illustrates a system 2101, in accordance with some demonstrative aspects. For example, system 101 (FIG. 1) may include one or more elements of system 2101, and/or may be configured to perform the functionality of system 2101.

In some demonstrative aspects, as shown in FIG. 21, system 2101 may include a catadioptric lens 2100 and a display 2170. For example, catadioptric lens 100 (FIG. 1) may include one or more elements of catadioptric lens 2100, and/or may be configured to provide at least part of the functionality of catadioptric lens 2100.

In some demonstrative aspects, as shown in FIG. 21, catadioptric lens 2100 may be configured to project a virtual image through an exit pupil 2181 of catadioptric lens 2100, which coincides with a pupil of an eye.

In some demonstrative aspects, as shown in FIG. 21, exit pupil 2181 may correspond to a peripheral vision of the eye.

In some demonstrative aspects, as shown in FIG. 21, catadioptric lens 2100 may be configured to project the virtual image through an exit pupil 2182, which coincides with the eye center of the eye.

In some demonstrative aspects, as shown in FIG. 21, exit pupil 2182 may correspond to a rotational vision of the eye.

In some demonstrative aspects, as shown in FIG. 21, catadioptric lens 2100 may include a first lens 2110 including a surface 2111 and a semi-reflective surface 2112.

In some demonstrative aspects, as shown in FIG. 21, catadioptric lens 2100 may include a second lens 2120 including a near-eye surface 2121 and a reflective polarizer surface 2122.

In some demonstrative aspects, there may be a QWP retarder (not shown in FIG. 21) between the lenses 2110 and 2120.

In some demonstrative aspects, as shown in FIG. 21, catadioptric lens 2100 may be configured to substantially not obscure, or to minimally obscure, a peripheral FoV and a rotational FoV.

In some demonstrative aspects, as shown in FIG. 21, light folding by catadioptric lens 2100 may not obscure the peripheral FoV and/or the rotational FoV.

In some demonstrative aspects, as shown in FIG. 21, catadioptric lens 2100 may be configured to provide a technical solution to support zero obscuration, for example, due to a concave shape of reflective folding surfaces of catadioptric lens 2100, e.g., semi-reflective surface 2112 and reflective polarizer surface 2122.

Referring back to FIG. 1, in some demonstrative aspects, system 101 may include a central lens configured to direct light from a first display to the eye of the user, e.g., as described below.

In some demonstrative aspects, system 101 may include a peripheral lens configured to direct light from a second display to the eye of the user, e.g., as described below.

In some demonstrative aspects, the central lens and/or the peripheral lens may include the catadioptric lens 100, e.g., as described below.

In some demonstrative aspects, the central lens may include the catadioptric lens 100, and the peripheral lens may include a Fresnel lens, e.g., as described below.

In some demonstrative aspects, a first near-eye surface of the central lens and a second near-eye surface of the peripheral lens may form a continuous surface, e.g., as described below.

In some demonstrative aspects, system 101 may include a baffle between the central lens and the peripheral lens (not shown in FIG. 1), e.g., as described below.

In some demonstrative aspects, an optical axis of the central lens may be tilted by a tilting angle with respect to a direct gaze of the eye (not shown in FIG. 1), e.g., as described below.

In some demonstrative aspects, the tilting angle may be greater than 0.5 degrees, e.g., as described below.

In other aspects, the tilting angle may include any other angle.

In some demonstrative aspects, system 101 including the central lens and the peripheral lens may be configured to provide a technical solution to cover a wide FoV, e.g., as described below.

In some demonstrative aspects, system 101 may be configured to cover a wide FoV, for example, to improve a sense of immersion, presence and/or performance for the user, for example, in tasks requiring peripheral vision, for example, in virtual environments and/or in augmented video-pass-through environments, e.g., as described below.

For example, a peripheral FoV and/or a peripheral vision may include a vision perception, which may occur outside a center of gaze or outside a straight-gaze of the eye of the user. For example, the peripheral FOV may include a FoV of a peripheral vision or indirect vision, which may occur outside a point of visual fixation, e.g., away from a center of gaze or, when viewed at large angles, in (or out of) the corner of the eye.

In some demonstrative aspects, system 101 may be configured to cover, e.g., to completely cover, a human FoV, for example, including an extra FoV, which may be covered, for example, by eye rotations in a comfort zone, e.g., as described below.

In one example, the comfort zone may be defined as a zone in an angular radius of 30 degrees relative to a visual axis of the eye.

In one example, providing a FoV completely covering the human FoV may provide an improved user experience, for example, for pass-through extended reality (pass-through XR) applications, for example, by having a “Reality” and “Virtuality” FoV that corresponds and simulates a human natural FoV.

In some demonstrative aspects, system 101 may be configured to cover a horizontal FoV of about 240°.

In other aspects, system 101 may be configured to cover any other horizontal FoV, e.g., less than or more than 240°.

In some demonstrative aspects, system 101 may be configured to cover a vertical FoV of about 160°.

In other aspects, system 101 may be configured to cover any other vertical FoV, e.g., less than or more than 160°.

In some demonstrative aspects, system 101 may be configured to cover the wide FoV, for example, even without compromising a continuous FoV and/or visual clarity throughout the continuous FoV, e.g., as described below.

In some demonstrative aspects, system 101 may be configured to maintain the continuous FoV and/or the visual clarity, for example, for different eye gazes of the eye of the user, e.g., as described below.

In some demonstrative aspects, system 101 may be configured to maintain the continuous FoV and/or the visual clarity, for example, for peripheral vision of the eye of the user, e.g., as described below.

In some demonstrative aspects, system 101 may be configured to cover the wide FoV, for example, even without compromising visual clarity in an area of eye rotation comfort-zone, e.g., in an angular radius of up to about 30° from the straight gaze of the eye; and/or in an area of eye enforced rotation, e.g., in an angular radius of up to about 45° from the straight gaze of the eye.

In some demonstrative aspects, system 101 may be configured to cover the wide FoV, for example, in a manner such that panoramic images and/or videos may be seen substantially continuously by the user, e.g., as described below.

In some demonstrative aspects, system 101 may be configured to cover the wide FoV, for example, even without compromising a compactness, design and/or usability of system 101, e.g., as described below.

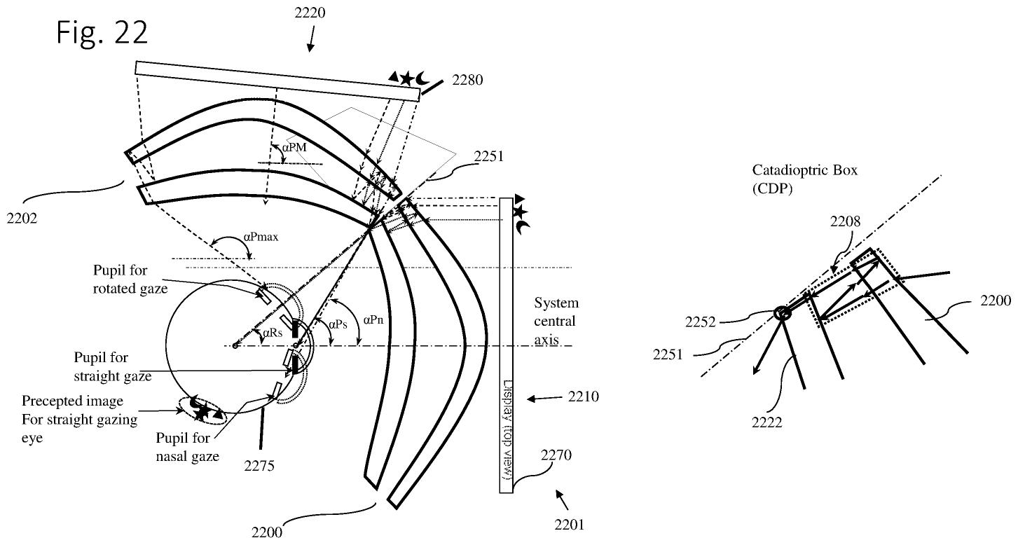

Reference is now made to FIG. 22, which schematically illustrates a system 2201, in accordance with some demonstrative aspects. For example, system 101 (FIG. 1) may include one or more elements of system 2201, and/or may be configured to perform at least part of the functionality of system 2201.

In some demonstrative aspects, as shown in FIG. 22, system 2201 may include a central lens 2200 configured to direct light from a first display 2270 to an eye 2275 of the user.

In some demonstrative aspects, as shown in FIG. 22, system 2201 may include a peripheral lens 2202 configured to direct light from a second display 2280 to the eye 2275 of the user.

In some demonstrative aspects, the central lens 2200 may include a first catadioptric lens, e.g., including the lens 100 (FIG. 1).

In some demonstrative aspects, the peripheral lens 2202 may include a second catadioptric lens, e.g., including the lens 100 (FIG. 1).

In some demonstrative aspects, two or more lenses may be joined together, for example, in order to extend a FoV of a catadioptric lens system, e.g., a pancake lens system or a catadioptric system.

In some demonstrative aspects, as shown in FIG. 22, system 101 may include two catadioptric lenses, e.g., two lenses 100 (FIG. 1), which may be stitched together.

In some demonstrative aspects, as shown in FIG. 22, the lenses 2200 and 2202 may provide a continuous FoV to the eye 2265 of the user.

In some demonstrative aspects, as shown in FIG. 22, lens 2200 may have its own display 2270, and/or lens 2202 may have its own display 2280.

In some demonstrative aspects, as shown in FIG. 22, the lens 2200 and the lens 2202 may be joined along a cutting line 2251.

In some demonstrative aspects, as shown in FIG. 22, the cutting line 2251 may be the line along which the lens 2200 and/or the lens 2202 are cut.

In some demonstrative aspects, the cutting line 2251 may be based on one or more rotation angles of the eye 2275.

In one example, a central visual module stitching-angles-set may be defined by maximal angles of support of the eye 2275.

In some demonstrative aspects, as shown in FIG. 22, the maximal angles of support may include a maximal rotation angle, denoted αRs, e.g., “eye rotation”, a maximal temporal angle for strait gaze, denoted αPs, e.g., “temporal peripheral”, and a maximal nasal-rotation-temporal-peripheral angle, denoted αPn, e.g., “nasal peripheral”.

In some demonstrative aspects, as shown in FIG. 22, a peripheral Visual Module (VM) 2220, e.g., including lens 2202 and display 2280, may be rotated by a rotation angle, denoted αPM, relative to a “System Central Axis”.

In some demonstrative aspects, as shown in FIG. 22, the peripheral visual module 2220 may be adjacent to a central visual module 2210, for example, through a vertical stitching curve, e.g., where surfaces 121 (FIG. 1) or central and peripheral lenses of the modules 2210 and 2220 meet.

In some demonstrative aspects, as shown in FIG. 22, the central visual module 2210 may include lens 2200 and display 2270.

In some demonstrative aspects, one or more settings and/or configurations, e.g., display intensities, zoom, pre-distortions and/or color-gamut, of displays 2210 and/or 2220 may be adjusted, for example, by controller 175 (FIG. 1), for example, to provide substantially continuous, and/or seamless panoramic vision, e.g., in combination of the central visual module 2201 and the peripheral visual module 2202.

Referring back to FIG. 20, as shown in FIG. 20, in case two catadioptric lenses 2000 are joined together along a cut line, which may cut a lens 2000 at an edge FoV, for example, along a chief ray 2003, a respective light beam may be vignetted by the cut line. Accordingly, a user may see a black area between FoVs provided by each lens.

Referring back to FIG. 22, in some demonstrative aspects, system 2201 and/or a design of lenses 2200 and/or 2202 may be configured to provide a technical solution to eliminate the vignetting of light beams and/or the black or dark area between the FoVs of two joined lenses.

In some demonstrative aspects, as shown in FIG. 22, cutting line 2251 may be external to a Catadioptric box (CDB) 2208, and may intersect closest to eye surface of 2222, e.g., at the edge point 2252.

In some demonstrative aspects, as shown in FIG. 22, the CDB 2208 may include a volume, e.g., a smallest volume, which encloses a chief ray at a folded part of an optical path.

In some demonstrative aspects, as shown in FIG. 22, the CDB 2208 may include a volume defined by a back and forth chief ray, e.g., from a pixel to the middle of a pupil, which may travel between reflecting surfaces.

In some demonstrative aspects, the design of lens 2200 and/or lens 2202 may be configured, for example, such that a cutting line of the lens 2200 and/or a cutting line of the lens 2202 may be external to a CDB. For example, this design of the cutting line of the lens 2200 and/or the cutting line of the lens 2202 may provide a technical solution to eliminate the vignette of light beams and/or black or dark area between the FoVs of the lenses 2200 and 2202, e.g., as described below.

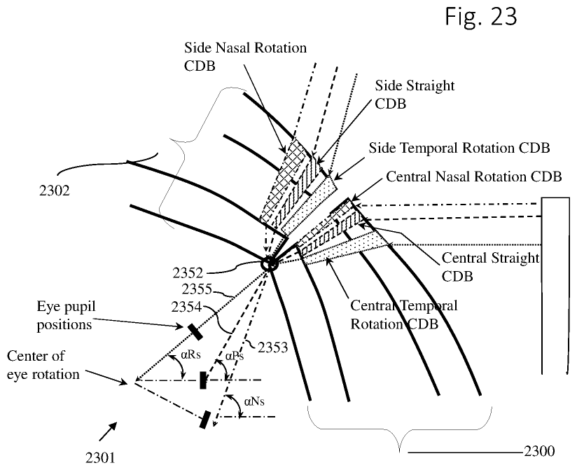

Reference is now made to FIG. 23, which schematically illustrates a zoom-in portion of a system 2301, in accordance with some demonstrative aspects. For example, system 101 (FIG. 1) may include one or more elements of system 2301, and/or may be configured to provide at least part of the functionality of system 2301.

In one example, system 2301 may provide at least part of the functionality of system 2201 (FIG. 22), and/or the zoom-in portion of system 2301 may include one or more elements of system 2201 (FIG. 22).

In some demonstrative aspects, as shown in FIG. 23, the zoom-in portion of system 2301 may include a portion of a central lens 2300, and a portion of a peripheral lens 2302.

In some demonstrative aspects, as shown in FIG. 23, the central lens 2300 and the peripheral lens 2302 may be stitched together.

In some demonstrative aspects, a CDB of a lens may be defined with respect to a chief ray associated with a gaze of an eye.

In some demonstrative aspects, as shown in FIG. 23, one or more CDBs may be defined with respect to central lens 2300, e.g., as described below.

In some demonstrative aspects, as shown in FIG. 23, a first CDB, denoted, central nasal rotation CDB, may enclose a folded portion of a maximal-nasal-rotation optical path via lens 2300, which may be associated with a maximal nasal rotation peripheral sensation angle αNs.

In some demonstrative aspects, as shown in FIG. 23, a second CDB, denoted, central straight CDB, may enclose a folded portion of an optical path via lens 2300, which may be associated with a peripheral sensation angle αPs for straight gazing eye.

In some demonstrative aspects, as shown in FIG. 23, a third CDB, denoted, central temporal rotation CDB, may enclose a folded portion optical path via lens 2300 for a maximal-temporal eye-rotation, which may be associated with a sensation angle αRs.

In some demonstrative aspects, the chief rays of all 3 central CDBs may intersect at point 2352, which may be substantially at the edge between near-eye surface of 2300 and lens 2300 cut.

In some demonstrative aspects, as shown in FIG. 23, one or more CDBs may be defined with respect to peripheral lens 2302, e.g., as described below.

In some demonstrative aspects, as shown in FIG. 23, a first CDB, denoted, side temporal rotation CDB, may enclose a folded portion of an optical path via lens 2302 for maximal-temporal eye-rotation, which may be associated with the sensation angle αRs.

In some demonstrative aspects, as shown in FIG. 23, a second CDB, denoted, side straight CDB, may enclose a folded portion of an optical path via lens 2302, which may be associated with a peripheral sensation angle αPs for straight gazing eye.

In some demonstrative aspects, as shown in FIG. 23, a third CDB, denoted, side nasal rotation CDB, may enclose a folded portion of a maximal-nasal-rotation optical path via lens 2302, which may be associated with a maximal nasal rotation peripheral sensation angle αNs.

In some demonstrative aspects, the chief rays of all 3 side CDBs may intersect at point 2352, which is substantially at the edge between near-eye surface of 2302 and lens 2302 cut.

In some demonstrative aspects, as shown in FIG. 23, a cutting line or a cutting surface of lens 2300, e.g., on the side close to lens 2302, may be configured, for example, such that the cutting line or cutting surface of lens 2300 may not intersect with the central nasal rotation CDB associated with the maximal nasal rotation peripheral sensation angle αNs, but may pass through the CDB corner, e.g., at a single point 2352, for example, for Visual Modules (VMs) sharing a same chief-ray set including rays 2353, 2354, and 2355.

In some demonstrative aspects, as shown in FIG. 23, a cutting line or a cutting surface of lens 2300, e.g., on the side close to lens 2302, may be configured, for example, such that the cutting line or cutting surface of lens 2300 may not intersect with the central straight CDB associated with peripheral sensation angle αPs for straight gazing eye, but may pass through the CDB corner, e.g., at a single point 2352, for example, for VMs) sharing a same chief-ray set, e.g., including rays 2353, 2354, and 2355.

In some demonstrative aspects, as shown in FIG. 23, a cutting line or a cutting surface of lens 2302, e.g., on the side close to lens 2300, may be configured, for example, such that the cutting line or cutting surface of lens 2302 may not intersect with the CDB side temporal rotation CDB associated with the maximal temporal rotation angle αRs, for example, for VMs sharing a same chief-rays set. For example, the cutting line or the cutting surface of lens 2302 may be tangential to, or from the side of, lens 2300.

In some demonstrative aspects, the side CDBs may be associated with a peripheral Visual Module (VM), and/or central CDBs may be associated with a central VM. For example, The VMs planar cuts may intersect at the point 2352. For example, the chief ray 2353 may be colinear with a chief ray exiting from a central Nasal Rotation CDB, and colinear with a chief ray exiting from a Side Temporal Rotation CDB. For example, the chief ray 2354 may be colinear with a chief ray exiting from a central Straight CDB, and colinear with a chief ray exiting from a Side Straight CDB. For example, the chief ray 2355 may be colinear with a chief ray exiting from a central Temporal Rotation CDB, and colinear with a chief ray exiting from a Side Nasal Rotation CDB. For example, the chief rays 2353, 2354 and/or 2355 may intersect at point 2352.

In some demonstrative aspects, two or more VMs may be stitched, for example, for extension of field of view.

In one example, a vertical cut-surface, e.g., typically a plane surface, may interrupt a visual module, for example, for vertically stitched VMs.

In another example, a horizontal cut-surface, e.g., typically a plane surface, may interrupt a visual module, for example, for horizontally stitched VMs.

In some demonstrative aspects, “interrupted” near-eye surfaces of neighboring visual modules may be adjacent, for example, at least through a line closest to the eye-side, e.g., to support continuous image preservation.

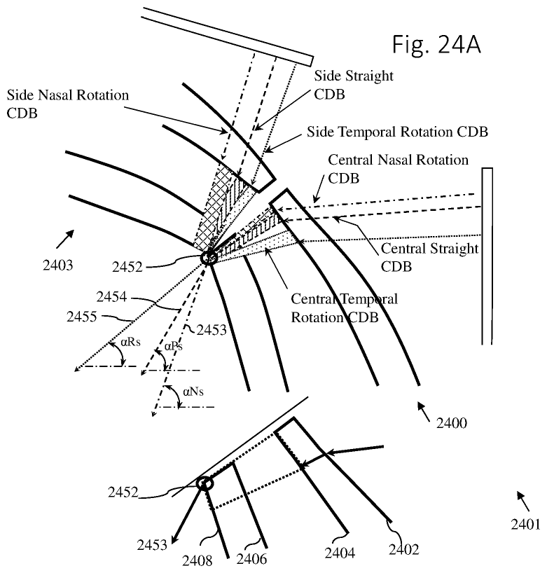

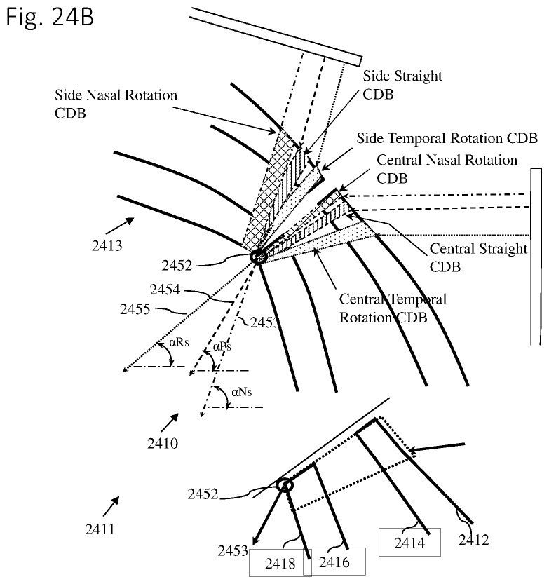

Reference is now made to FIG. 24A, which schematically illustrates a portion of a first system 2401, in accordance with some demonstrative aspects. For example, system 101 (FIG. 1) may include one or more elements of system 2401, and/or may be configured to provide the functionality of system 2401.

In one example, system 2401 may include one or more elements of system 2201 (FIG. 22), and/or may be configured to provide at least part of the functionality of system 2201 (FIG. 22).

In some demonstrative aspects, as shown in FIG. 24A, system 2401 may include a central lens 2400 and a peripheral lens 2403, which may be stitched together, for example, such that their planar cut may cross point 2452.

In some demonstrative aspects, as shown in FIG. 24A, central lens 2400 and/or peripheral lens 2403 may include a first lens, which may include a first surface 2402 and a second surface 2404.

In some demonstrative aspects, as shown in FIG. 24A, central lens 2400 and/or peripheral lens 2403 may include a second lens, which may include a first surface 2406 and a second surface 2408.

In some demonstrative aspects, as shown in FIG. 24A, a plurality of CDBs may be formed by a respective plurality of chief rays relative to the central lens 2400 and/or the peripheral lens 2403. For example, these rays may intersect point 2452, and may be colinear with the associated chief rays 2453, 2454, 2455 directed into corresponding to CDB pupil position.

In some demonstrative aspects, as shown in FIG. 24A, the plurality of chief rays may be folded between two surfaces, e.g., between the surface 2404 and the surface 2408. For example, these rays may intersect point 2452, and may be colinear with the associated chief rays 2453, 2454, 2455 directed into corresponding to CDB pupil position.

Reference is now made to FIG. 24B, which schematically illustrates a portion of a second system 2411, in accordance with some demonstrative aspects. For example, system 101 (FIG. 1) may include one or more elements of system 2403, and/or may be configured to provide the functionality of system 2403.

In one example, system 2411 may include one or more elements of system 2201 (FIG. 22), and/or may be configured to provide at least part of the functionality of system 2201 (FIG. 22).

In some demonstrative aspects, as shown in FIG. 24B, system 2403 may include a central lens 2410 and a peripheral lens 2413, which may be stitched together, for example, such that their planar cut crosses point 2452.

In some demonstrative aspects, as shown in FIG. 24B, central lens 2410 and/or peripheral lens 2413 may include a first lens, which may include a first surface 2412 and a second surface 2414.

In some demonstrative aspects, as shown in FIG. 24B, central lens 2410 and/or peripheral lens 2413 may include a second lens, which may include a first surface 2416 and a second surface 2418.

In some demonstrative aspects, as shown in FIG. 24B, a plurality of CDBs may be formed by a respective plurality of chief rays relative to the central lens 2410 and/or the peripheral lens 2413. For example, these rays may intersect point 2452, and may be colinear with the associated chief rays 2453, 2454, 2455 directed into corresponding to CDB pupil position.

In some demonstrative aspects, as shown in FIG. 24B, the plurality of chief rays may be folded between two surfaces, e.g., between the surface 2412 and the surface 2418. For example, these rays may intersect point 2452, and may be colinear with the associated chief rays 2453, 2454, 2455 directed into corresponding to CDB pupil position.

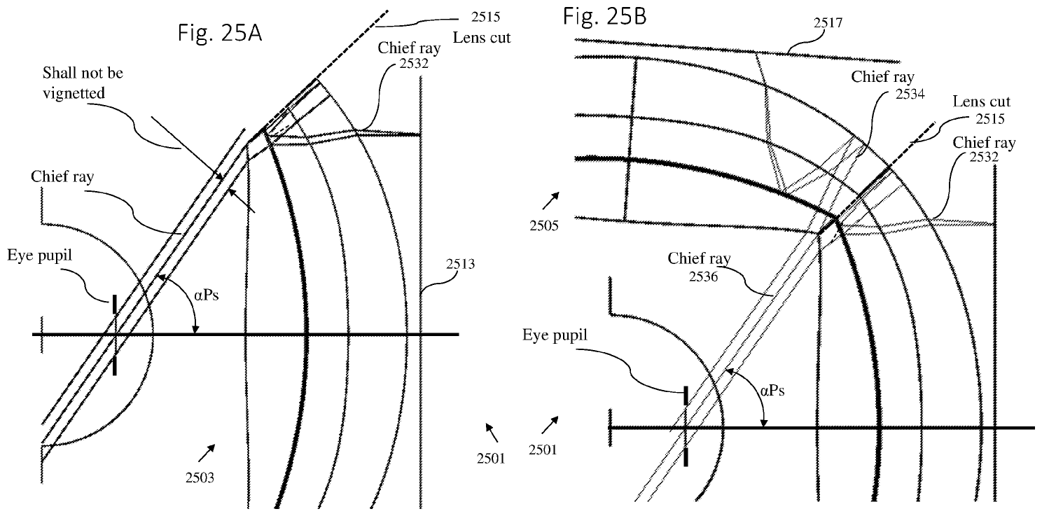

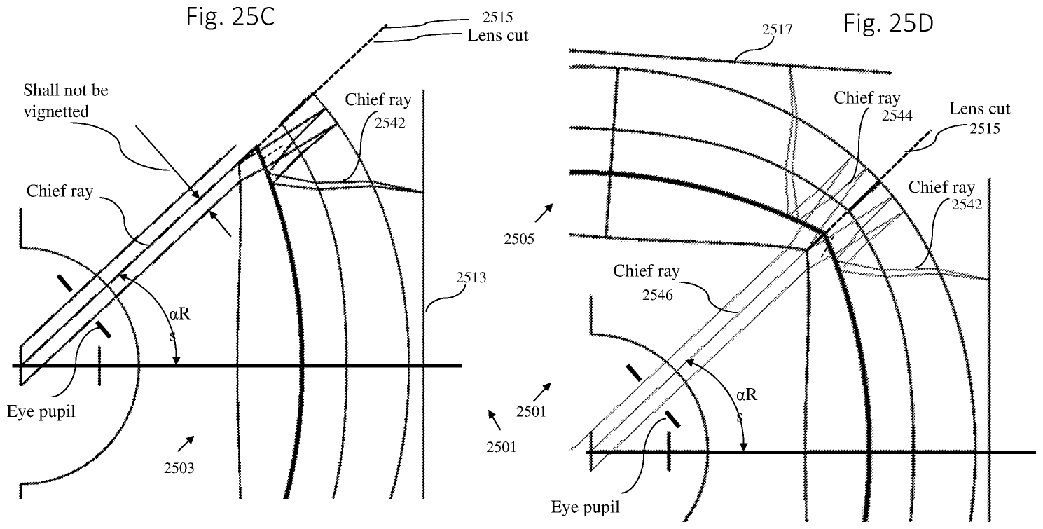

Reference is made to FIG. 25A, FIG. 25B, FIG. 25C, and FIG. 25D, which schematically illustrate the propagation of rays in a lens cutting area of a system 2501. For example, system 101 (FIG. 1) may include one or more elements of system 2501, and/or may be configured to provide the functionality of system 2501.

In one example, system 2501 may include one or more elements of system 2201 (FIG. 22), and/or may be configured to provide at least part of the functionality of system 2201 (FIG. 22).

In some demonstrative aspects, as shown in FIG. 25A, system 2501 may include a central lens 2503 configured to direct light from a central display 2513 to a pupil of an eye of a user. For example, central lens 2503 may include optical lens 100 (FIG. 1), and/or may provide at least part of the functionality of catadioptric lens 100 (FIG. 1).

In some demonstrative aspects, as shown in FIG. 25A, a ray 2532 may propagate from display 2513 to the pupil via an area of central lens 2503, e.g., close to a cut line 2515 of the central lens 2503.

In some demonstrative aspects, as shown in FIG. 25A, ray 2532 may be associated with a peripheral vision configuration.

In some demonstrative aspects, as shown in FIG. 25A, ray 2532 may not be vignetted.

In some demonstrative aspects, as shown in FIG. 25B, system 2501 may include a peripheral lens 2505 configured to direct light from a peripheral display 2517 to the pupil of the eye. For example, peripheral lens 2505 may include catadioptric lens 100 (FIG. 1) and/or may provide at least part of the functionality of catadioptric lens 100 (FIG. 1).

In some demonstrative aspects, as shown in FIG. 25B, a ray 2534 may propagate from display 2517 to the pupil via an area of lens 2505, e.g., close to the cut line 2515.

In some demonstrative aspects, as shown in FIG. 25B, ray 2534 may be associated with the peripheral vision configuration.

In some demonstrative aspects, as shown in FIG. 25B, ray 2534 may not be vignetted.

In some demonstrative aspects, as shown in FIG. 25B, ray 2532 and ray 2534 may form a chief ray 2536.

In some demonstrative aspects, as shown in FIG. 25A and FIG. 25B, system 2501 may be configured to provide a technical solution to support continues FoV at a peripheral vision configuration.

For example, as shown in FIG. 25B, rays 2532 and 2534 may form ray 2536, which may provide continues FoV and may not be vignetted.

In some demonstrative aspects, as shown in FIG. 25C, a ray 2542 may propagate from display 2513 to the pupil via an area of lens 2503, e.g., close to the cut line 2515 of the lens 2503.

In some demonstrative aspects, as shown in FIG. 25C, ray 2542 may be associated with a rotational vision configuration.

In some demonstrative aspects, as shown in FIG. 25C, ray 2542 may not be vignetted.

In some demonstrative aspects, as shown in FIG. 25D, a ray 2544 may propagate from display 2517 to the pupil via an area of lens 2505, e.g., close to the cut line 2515.

In some demonstrative aspects, as shown in FIG. 25D, ray 2544 may be associated with the rotational vision configuration.

In some demonstrative aspects, as shown in FIG. 25D, ray 2544 may not be vignetted.

In some demonstrative aspects, as shown in FIG. 25D, ray 2542 and ray 2544 may form a chief ray 2546.

In some demonstrative aspects, as shown in FIG. 25C and FIG. 25D, system 2501 may be configured to provide a technical solution to support continues FoV at a rotational vision configuration.

For example, as shown in FIG. 25D, rays 2542 and 2544 may form ray 2546, which may provide continues FoV and may not be vignetted.

Referring back to FIG. 1, in some demonstrative aspects, system 101 may be configured to utilize a central lens of system 101 including catadioptric lens 100, and a peripheral lens of system 100, which may be different from catadioptric lens 100.

In one example, the peripheral lens may include a non-pancake lens, a non-catadioptric lens, or any other type of lens,

In some demonstrative aspects, the first near-eye surface of the central lens and the second near-eye surface of the peripheral lens may form a continuous surface, e.g., as described below.

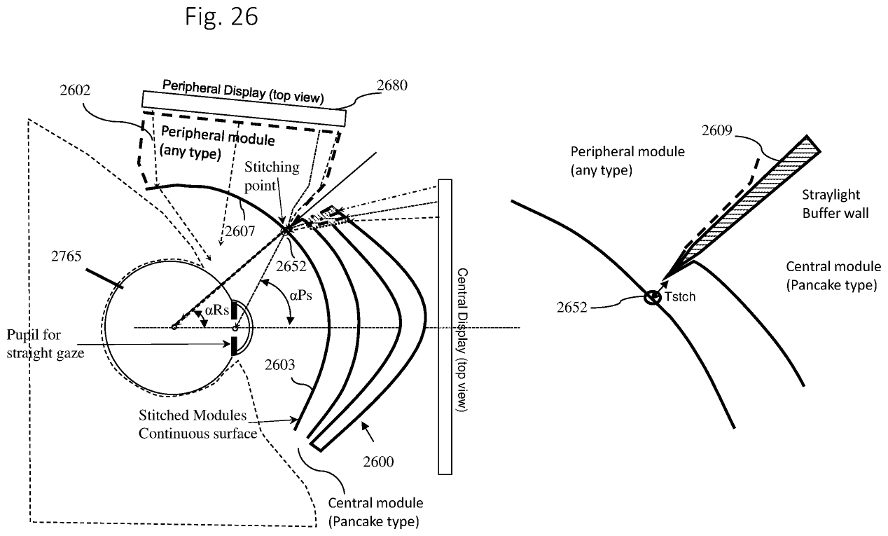

Reference is now made to FIG. 26, which schematically illustrates a system 2601, in accordance with some demonstrative aspects. For example, system 101 (FIG. 1) may include one or more elements of system 2601, and/or may be configured to perform the functionality of system 2601.

In some demonstrative aspects, as shown in FIG. 26, system 2601 may include a central lens 2600 configured to direct light from a first display 2670 to an eye 2675 of the user.

In some demonstrative aspects, the central lens 2600 may include catadioptric lens 100 (FIG. 1).

In some demonstrative aspects, as shown in FIG. 26, system 2601 may include a peripheral lens 2602 configured to direct light from a second display 2680 to the eye 2675 of the user.

In some demonstrative aspects, as shown in FIG. 26, the peripheral lens 2602 may include any suitable type of lens, for example, different from catadioptric lens 100 (FIG. 1), e.g., a non pancake lens or a non catadioptric lens.

In one example, the peripheral lens 2602 may be configured to support peripheral vision at high FoV angles, and may have a low performance with a low PPD number, for example, as human vision may not have a good resolution in a peripheral direction.

In some demonstrative aspects, as shown in FIG. 26, a near-eye surface 2603 of the central lens 2600 and a near-eye surface 2607 of the peripheral lens 2602 may be configured to form a continuous surface.

In some demonstrative aspects, as shown in FIG. 26, the central lens 2600 and the peripheral lens 2602 may share a common continuous optical surface, e.g., including the surfaces 2603 and 2607, facing the eye 2675 of the user.

In some demonstrative aspects, as shown in FIG. 26, a baffle 2609 may be provide between the central lens 2600 and the peripheral lens 2602.

In some demonstrative aspects, as shown in FIG. 26, the baffle 2609 may be positioned along peripheral and central chief ray directions, for example, such that the peripheral and central chief ray directions may be substantially colinear after intersection at stitching point 2652, which may be, for example, at a distance, denoted Tstch, from the baffle peak.

In some demonstrative aspects, the baffle 2609 may be configured to prevent optical cross-talk between lens modules and/or to limit stray light.

In some demonstrative aspects, the peripheral lens 2602 may include a Fresnel lens, e.g., as described below.

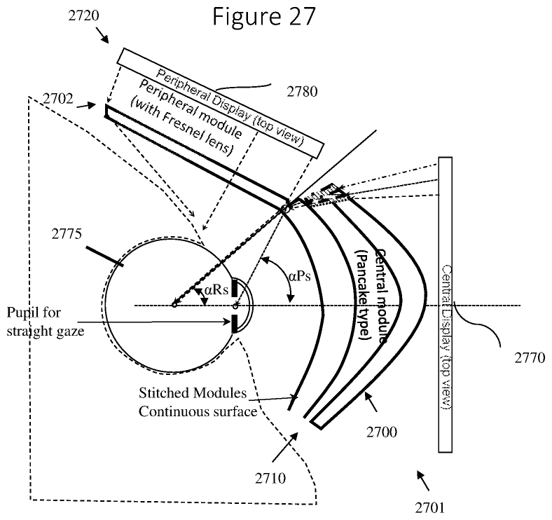

Reference is now made to FIG. 27, which schematically illustrates a system 2701, in accordance with some demonstrative aspects. For example, system 101 (FIG. 1) may include one or more elements of system 2701, and/or may be configured to perform at least part of the functionality of system 2701.

In some demonstrative aspects, as shown in FIG. 27, system 2701 may include a central lens 2700 configured to direct light from a first display 2770 to an eye 2775 of the user.

In some demonstrative aspects, as shown in FIG. 27, the central lens 2700 may include catadioptric lens 100 (FIG. 1).

In some demonstrative aspects, as shown in FIG. 27, system 2701 may include a peripheral lens 2702 configured to direct light from a second display 2780 to the eye 2775 of the user.

In some demonstrative aspects, as shown in FIG. 27, the peripheral lens 2702 may include a Fresnel lens.

In some demonstrative aspects, as shown in FIG. 27, system 2701 may include a hybrid near eye lens, e.g., including central lens 2700 and peripheral lens 2702.

In some demonstrative aspects, as shown in FIG. 27, the hybrid near eye lens may include a common near-eye surface, e.g., shared between central lens 2700 and peripheral lens 2702.

In some demonstrative aspects, as shown in FIG. 27, central lens 2700 may include a pancake lens, and peripheral lens 2702 may include a Fresnel lens, which may be opposite to the common near-eye surface.

In some demonstrative aspects, as shown in FIG. 27, the hybrid near eye lens may include a central visual module 2710, e.g., including central lens 2700 and display 2770, and a peripheral visual module 2720, e.g., including peripheral lens 2702 and display 2780.

In some demonstrative aspects, as shown in FIG. 27, an optical axis of the peripheral lens 2702 may have an offset (not shown in FIG. 27), denoted r_po, from a stitching-point, e.g., a central horizontal cross-section intersecting the stitching-curve.

In some demonstrative aspects, as shown in FIG. 27, the offset, r_po may be adjusted, for example, such that a visual acuity of the central visual module 2710 at the intersection may match with a visual acuity of the peripheral visual module 2720 at the intersection.

In some demonstrative aspects, display intensities, zoom, pre-distortions and color-gamut of displays 2770 and/or 2780 may be adjusted, for example, by controller 175 (FIG. 1), for example, to provide substantially continuous, and/or seamless panoramic vision, e.g., in combination of the central visual module 2710 and the peripheral visual module 2720.

In some demonstrative aspects, an optical axis of the central lens 2700 may be tilted by a tilting angle with respect to a direct gaze of the eye, e.g., as described below.

In some demonstrative aspects, the tilting angle may be greater than 0.5 degrees, e.g., as described below.

In other aspects, the tilting angle may include any other angle.

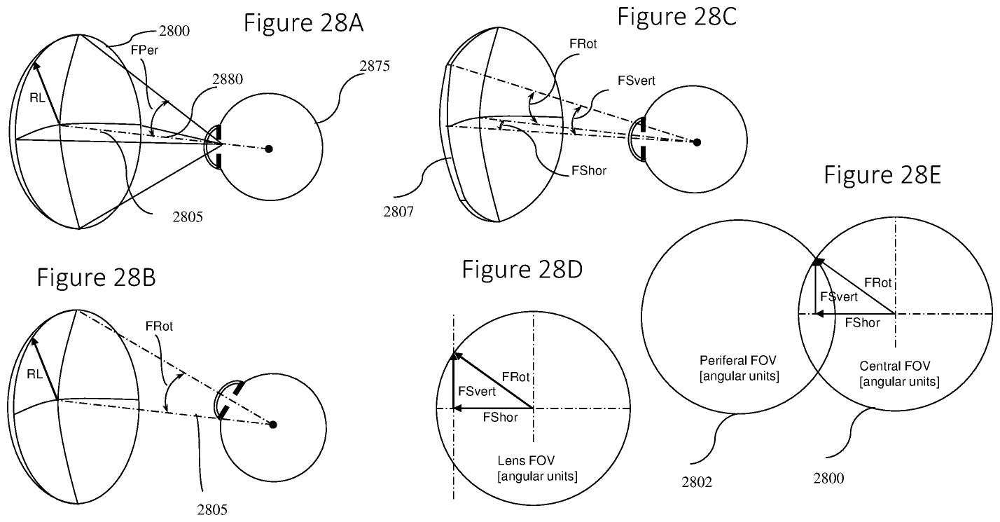

Reference is made to FIGS. 28A, 28B, 28C, 28D, and 28E, which schematically illustrate FoV angles with respect to a lens 2800, in accordance with some demonstrative aspects.

For example, as shown in FIG. 28A, lens 2800 may include a circular aperture lens with an axial symmetry.

For example, as shown in FIG. 28A, a maximal peripheral vision of an eye 2875 may form a view angle, denoted FPer, with respect to a central axis 2805 of the lens 2800.

For example, as shown in FIG. 28B, a maximal rotational vision of the eye 2875 may form a view angle, denoted Frot, with respect to the central axis 2805 of the lens 2800.

For example, the maximum peripheral view angle FPer may be defined, for example, by an optical aperture radius, denoted RL, of the lens 2800, and a distance, e.g., which may be a sum of an eye relief between the lens 2800 center and the distance from eye cornea to pupil for the angle FPer.

For example, the maximum rotational view angle FRot may be defined, for example, by the optical aperture radius RL of the lens 2800, and a distance, e.g., which may be a sum of the eye relief between the lens 2800 center and the distance from eye cornea to eye rotation center for the angle FRot.

For example, as shown in FIG. 28C, a vertical lens cut 2807 may be formed at lens 2800, for example, to allow stitching of the lens 2800 to another lens.

For example, as shown in FIG. 28C, the lens cut 2807 may be at an angle, denoted FShor, from the optical axis 2805, e.g., the straight gaze direction of the eye.

For example, as shown in FIG. 28C, there may be a maximum vertical rotational view angle, denoted FSvert, e.g., when the eye gaze is directed towards the cut line 2807.

For example, as shown in FIG. 28C, the maximum vertical rotational view angle FSvert may be defined, for example, with respect to the view angle FRot and the view angle FShor.

For example, as shown in FIG. 28D, the maximum vertical rotational view angle FSvert may be based on the view angle FRot and the view angle FShor in an angular space.

For example, as shown in FIG. 28D, the lens 2800 and a lens 2802 may be stitched at the angle Fshor, e.g., to form a combined FoV.

In one example, it may be advantageous to increase the angle Fshor as much as possible, for example, in order to move the stitching line further away from the straight gaze direction. For example, imperfections in images due to stitching may become less disturbing for the eye, e.g., as the stitching line is further away from the straight gaze direction.

In another example, when increasing the angle FShor, the maximum vertical rotational FoV angle FSvert at the stitching line may decrease. This may reduce the vertical FoV at the stitching line.

In some demonstrative aspects, system 101 (FIG. 1) may be configured to provide a technical solution to support increasing the angle FShor, for example, even without substantially reducing the maximum vertical rotational FoV angle FSvert, e.g., as described below.

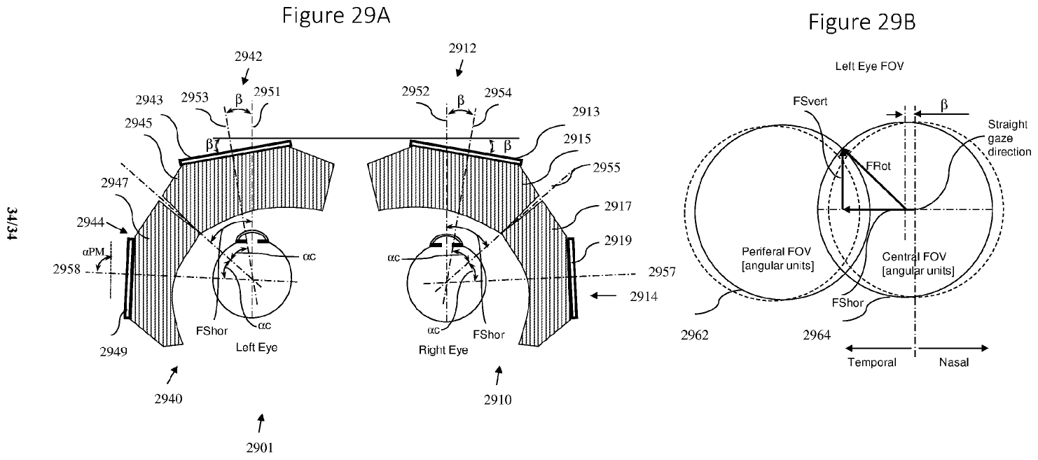

Reference is made to FIG. 29A, which schematically illustrates an HMD system 2901, in accordance with some demonstrative aspects.

In some demonstrative aspects, as shown in FIG. 29A, HMD system 2901 may include a right eye module 2910, and a left eye module 2940.

In one example, right eye module 2910 and/or left eye module 2940 may include one or more elements of system 2201 (FIG. 22), and/or may be configured to perform at least part of the functionality of system 2201 (FIG. 22).

In some demonstrative aspects, as shown in FIG. 29A, right eye module 2910 may include a central VM 2912, and a peripheral VM 2914.

In some demonstrative aspects, as shown in FIG. 29A, central VM 2912 may include a central lens 2915 and a central display 2913.

In some demonstrative aspects, as shown in FIG. 29A, peripheral VM 2914 may include a peripheral lens 2917 and a peripheral display 2919.

In some demonstrative aspects, as shown in FIG. 29A, left eye module 2940 may include a central VM 2942, and a peripheral VM 2944.

In some demonstrative aspects, as shown in FIG. 29A, central VM 2942 may include a central lens 2945 and a central display 2943.

In some demonstrative aspects, as shown in FIG. 29A, peripheral VM 2944 may include a peripheral lens 2947 and a peripheral display 2949.

In some demonstrative aspects, lens 2915, lens 2917, lens 2945 and/or lens 2947 may include one or more elements of catadioptric lens 100 (FIG. 1), and/or may be configured to provide at least part of the functionality of catadioptric lens 100 (FIG. 1).

In some demonstrative aspects, as shown in FIG. 29A, an optical axis 2954 of VM 2912 may be tilted by a tilting angle, denoted β, with respect to a direct gaze 2952 of the right eye, e.g., as described below.

For example, as shown in FIG. 29A, the optical axis 2954 of central lens 2915 may be tilted by the tilting angle β with respect to the direct gaze 2952 of the right eye.

In some demonstrative aspects, as shown in FIG. 29A, an optical axis 2953 of VM 2942 may be tilted by a tilting angle, e.g., the tilting angle β or any other tilting angle, with respect to a direct gaze 2951 of the left eye.

For example, as shown in FIG. 29A, the optical axis 2953 of central lens 2945 may be tilted by the tilting angle β with respect to the direct gaze 2951 of the left eye.

In some demonstrative aspects, as shown in FIG. 29A, there may be an angle, denoted ac, between the lens optical axis 2954 of lens 2915 and a stitching line 2955 between the lens 2917 and the lens 2915.

In some demonstrative aspects, as shown in FIG. 29A, there may be an angle, e.g., the angle αc or any other stitching angle, between the lens optical axis 2957 of lens 2917 and the stitching line 2955 between the lens 2917 and the lens 2915.

In some demonstrative aspects, as shown in FIG. 29A, the angle αc, as seen from a center of the right eye, may be the same for both central lens 2915 and the peripheral lens 2917.

In some demonstrative aspects, as shown in FIG. 29A, an angle of rotation of the optical axis 2957 of the peripheral lens 2917 with respect to the straight gaze direction 2952 of the right eye may be based on the angle β, e.g., may be equal to 2 αc+β. For example, the angle FShor may be determined by FShor=αc+β.

In some demonstrative aspects, as shown in FIG. 29A, an angle of rotation of the optical axis 2958 of the peripheral lens 2947 with respect to the straight gaze direction 2951 of the left eye may be based on the angle β, e.g., may be equal to 2 αc+β. For example, the angle FShor may be determined by FShor=αc+β.

In some demonstrative aspects, the VM 2912 may be tilted, e.g., by the angle β, and the VM 2914 may be tilted, e.g., based on the angle β, for example, to provide a technical solution to increase the angle FShor, and/or to increase the maximum vertical rotational FoV angle FSvert, e.g., as described below.

In some demonstrative aspects, the VM 2942 may be tilted, e.g., by the angle β, and the VM 2944 may be tilted, e.g., based on the angle β, for example, to provide a technical solution to increase the angle FShor, and/or to increase the maximum vertical rotational FoV angle FSvert, e.g., as described below.

Reference is made to FIG. 29B, which schematically illustrates a FoV of two stitched lenses of HMD device 2900, in accordance with some demonstrative aspects.

In some demonstrative aspects, as shown in FIG. 29B, two FOV solid circles may correspond to two respective stitched tilted lenses, e.g., as described below.

In some demonstrative aspects, as shown in FIG. 29B, a first solid FoV circle 2962 may correspond to a FoV of lens 2947.

In some demonstrative aspects, as shown in FIG. 29B, a second solid FoV circle 2964 may correspond to a FoV of lens 2945.

In some demonstrative aspects, as shown in FIG. 29B, two dashed circles may correspond to two respective stitched un-tilted lenses, e.g., the lenses 2802 and 2800 (FIG. 28), for example, where the angle β is equal to zero.

In some demonstrative aspects, the maximum vertical rotational FoV angle FSvert corresponding to a FoV of the left eye module 2940, e.g., with respect to the lens 2947 and/or the lens 2945, may be larger than the maximum vertical rotational FoV angle FSvert of FIG. 28D, for example, with respect to the two un-tilted lenses 2800 (FIG. 28) and 2802 (FIG. 28), e.g., where β=θ.

In some demonstrative aspects, as shown in FIG. 29B, when tilting the lens modules 2942 and 2944, the vertical FoV FSvert may increase, e.g., compared to the un-tilted modules, for example, while the stitching angle FShor stays the same.

In some demonstrative aspects, increasing the vertical FoV FSvert may reduce a FoV in a nasal direction. However, the FoV in the nasal direction may be smaller than temporal FoV. Accordingly, a reduction of the nasal FOV may be acceptable.

In some demonstrative aspects, as shown in FIG. 29B, the angle αc may decrease and the peripheral lens tilt αPM of peripheral lens 2947 may decrease, for example, as the angle β increases while the angle FShor stays constant.

In some demonstrative aspects, the reduced angle αc may result in the peripheral lenses 2947 and 2917 moving further away from the left and right temples of the user head, respectively, which may improve ergonomics of the HMD 2901.

In some demonstrative aspects, at least the frontal VMs 2945 and 2915 may include biconic or freeform optical surfaces, for example, such that the PPD of the front VMs may change, e.g., depending on the FOV in a different way along the vertical and horizontal directions.

In some demonstrative aspects, the maximal PPD may be configured for a 0 degree view angle, e.g., in both vertical and horizontal directions.

### Examples

The following examples pertain to further aspects.
Example 1 includes an apparatus comprising a catadioptric lens configured to direct light from a display to an eye of a user, the catadioptric lens comprising a catadioptric folder configured to fold an optical path of the catadioptric lens, the catadioptric folder comprising a first surface comprising a semi-reflective surface; a second surface comprising a reflective polarizer surface, the second surface opposite to the first surface; and a retarder between the first surface and the second surface, the retarder configured to convert a polarization of the light in a path between the first surface and the second surface, wherein the first and second surfaces are configured such that, over at least 10% of the catadioptric folder, an inter-surface distance of the catadioptric folder is monotonically decreasing with a distance from a central axis of the catadioptric lens.
Example 2 includes the subject matter of Example 1, and optionally, wherein the inter-surface distance of the catadioptric folder at a particular distance from the central axis is based on a distance between a first point and a second point, wherein the first point comprises a point on the first surface at the particular distance from the central axis, wherein the second point comprises a point on the second surface at the particular distance from the central axis, wherein the central axis, the first point and the second point are located in the same geometrical plane.
Example 3 includes the subject matter of Example 1 or 2, and optionally, wherein the inter-surface distance of the catadioptric folder at a particular distance from the central axis is based on a distance between a first point and a second point, wherein the second point comprises a point on the second surface at the particular distance from the central axis, wherein the first point comprises a point of intersection between the first surface and a normal to the second surface at the second point.
Example 4 includes the subject matter of any one of Examples 1-3, and optionally, wherein a first inter-surface distance of the catadioptric folder at a first distance from the central axis is longer than a second inter-surface distance of the catadioptric folder at a second distance from the central axis, the first distance is shorter than the second distance.
Example 5 includes the subject matter of any one of Examples 1-4, and optionally, wherein a Peripheral Eye Relief (PER) of the catadioptric lens at a particular distance from the central axis of the catadioptric lens is shorter than a Central Eye Relief (CER) of the catadioptric lens at the central axis of the catadioptric lens.
Example 6 includes the subject matter of any one of Examples 1-5, and optionally, wherein the first and second surfaces are configured such that an optical path length inside the catadioptric folder, over at least 10% of the catadioptric folder, is monotonically decreasing with the distance from the central axis.
Example 7 includes the subject matter of any one of Examples 1-6, and optionally, wherein a first optical path length inside the catadioptric folder at a first distance from the central axis is longer than a second optical path length inside the catadioptric folder at a second distance from the central axis, wherein the first distance is shorter than the second distance.
Example 8 includes the subject matter of any one of Examples 1-7, and optionally, wherein the first and second surfaces are configured such that a focal length of the catadioptric lens, over at least 10% of the catadioptric folder, is monotonically decreasing with the distance from the central axis.
Example 9 includes the subject matter of any one of Examples 1-8, and optionally, wherein a first focal length of the catadioptric lens at a first distance from the central axis is longer than a second focal length of the catadioptric lens at a second distance from the central axis, wherein the second distance is longer than the first distance.
Example 10 includes the subject matter of any one of Examples 1-9, and optionally, wherein the first and second surfaces are configured such that a number of Pixels PerDegree (PPD) of the catadioptric lens, over at least 10% of the catadioptric folder, is monotonically decreasing with the distance from the central axis.
Example 11 includes the subject matter of any one of Examples 1-10, and optionally, wherein a first number of Pixels PerDegree (PPD) of the catadioptric lens at a first distance from the central axis is higher than a second number of PPD at a second distance from the central axis, wherein the second distance is longer than the first distance.
Example 12 includes the subject matter of any one of Examples 1-11, and optionally, wherein the catadioptric lens comprises one or more of biconic optical surfaces or freeform optical surfaces such that there are two mutually orthogonal planes which include the central axis of the lens, and the lens has a symmetry relative to any of the two mutually orthogonal planes.
Example 13 includes the subject matter of Example 12, and optionally, wherein a number of Pixels PerDegree (PPD) of the catadioptric lens is different in the two orthogonal symmetry planes at a same distance from the lens central axis.
Example 14 includes the subject matter of any one of Examples 1-13, and optionally, wherein the first surface is configured to reflect light of a first-handedness circular polarization from a first direction into light of a second-handedness circular polarization in a second direction, wherein the first direction is from the second surface to the first surface and the second direction is from the first surface to the second surface, the second-handedness circular polarization is orthogonal to the first-handedness circular polarization, wherein the second surface is configured to reflect light of a first linear polarization from the second direction to the first direction and to transfer light of a second linear polarization in the second direction, the second linear polarization is orthogonal to the first linear polarization, wherein the retarder is configured to convert the light of the first linear polarization into the light of the first-handedness circular polarization in the first direction, and to convert the light of the second-handedness circular polarization into the light of the second linear polarization in the second direction.
Example 15 includes the subject matter of Example 14, and optionally, wherein the first surface is configured to transfer light from the second direction having the first-handedness circular polarization, and wherein the retarder is configured to convert the light from the second direction having the first-handedness circular polarization into the light of the first linear polarization in the second direction.
Example 16 includes the subject matter of any one of Examples 1-15, and optionally, wherein the catadioptric folder comprises a Diffractive Optical Element (DOE) between the first surface and the second surface.
Example 17 includes the subject matter of any one of Examples 1-16, and optionally, wherein the catadioptric folder comprises a segmented dioptric adjuster between the first surface and the second surface, wherein the segmented dioptric adjuster is configured to apply a plurality of diopter adjustments to a respective plurality of segments of the optical path, wherein the plurality of diopter adjustments comprise at least first and second different diopter adjustments.
Example 18 includes the subject matter of any one of Examples 1-17, and optionally, comprising a lens-display retarder configured to convert a polarization of the light from the display to the first surface.
Example 19 includes the subject matter of Example 18, and optionally, wherein the lens-display retarder is configured to convert the polarization of the light from the display into a circular polarization to be transferred by the first surface.
Example 20 includes the subject matter of Example 19, and optionally, wherein an optical axis of the retarder is orthogonal to an optical axis of the lens-display retarder.
Example 21 includes the subject matter of Example 19 or 20, and optionally, wherein the retarder and the lens-display retarder have substantially identical optical configurations.
Example 22 includes the subject matter of any one of Examples 18-21, and optionally, wherein the lens-display retarder comprises a spatially-variable optical axis orientation configured based on optical parameters of at least one of the first surface or the second surface.
Example 23 includes the subject matter of any one of Examples 18-22, and optionally, wherein the lens-display retarder comprises a spatially-variable phase delay configured based on optical parameters of at least one of the first surface or the second surface.
Example 24 includes the subject matter of Example 23, and optionally, wherein the spatially-variable phase delay comprises a phase delay, which is monotonically changing, over at least 20% of the lens-display retarder, with the distance from the central axis.
Example 25 includes the subject matter of any one of Examples 1-24, and optionally, comprising one or more reflectors at a peripheral area outside the optical path of the catadioptric lens, the one or more reflectors configured to reflect towards the display reflected light from the first surface, wherein the reflected light from the first semi-reflective surface comprises a portion of the light from the display, which is reflected by the semi-reflective surface.
Example 26 includes the subject matter of any one of Examples 1-25, and optionally, wherein a cutting line of the catadioptric lens is external to a central nasal rotation catadioptric box enclosing a folded portion of a chief ray optical path of peripheral vision folded between the first surface and the second surface, wherein the chief ray optical path is associated with a maximal nasal rotation peripheral sensation angle.
Example 27 includes the subject matter of Example 26, and optionally, wherein an eye nasal rotation angle, which defines an eye pupil position and a respective chief ray corresponding to the central nasal rotation catadioptric box, is in a range between 0.5 degrees and 50 degrees.
Example 28 includes the subject matter of any one of Examples 1-25, and optionally, wherein a cutting line of the catadioptric lens is external to a side temporal rotation catadioptric box enclosing a folded portion of a maximal-rotation optical path folded between the first surface and the second surface, wherein the maximal-rotation optical path is associated with a maximal temporal rotation peripheral sensation angle.
Example 29 includes the subject matter of any one of Examples 1-28, and optionally, comprising a first catadioptric lens and a second catadioptric lens, wherein a cutting line of the first catadioptric lens is external to a central nasal rotation catadioptric box of the first catadioptric lens enclosing a folded portion of a chief ray optical path of peripheral vision folded between a first surface of the first catadioptric lens and a second surface of the first catadioptric lens, wherein the chief ray optical path is associated with a maximal nasal rotation peripheral sensation angle, wherein a cutting line of the second catadioptric lens is external to a side temporal rotation catadioptric box of the second catadioptric lens enclosing a folded portion of a maximal-rotation optical path folded between a first surface of the second catadioptric lens and a second surface of the second catadioptric lens, wherein the maximal-rotation optical path is associated with a maximal temporal rotation peripheral sensation angle, wherein the chief ray optical path and the maximal-rotation optical path intersect at a point, which is based on the cutting line of the first catadioptric lens and the cutting line of the second catadioptric lens.
Example 30 includes the subject matter of any one of Examples 1-29, and optionally, wherein the catadioptric lens comprises a first lens and a second lens, wherein the semi-reflective surface comprises a surface of the first lens, and the reflective polarizer surface comprises a surface of the second lens.
Example 31 includes the subject matter of any one of Examples 1-29, and optionally, wherein the catadioptric folder is formed by a single lens, wherein the semi-reflective surface comprises a first surface of the single lens, the reflective polarizer surface comprises a second surface of the single lens opposite to the first surface of the single lens, wherein the retarder comprises a retarder layer between the semi-reflective surface and the reflective polarizer surface.
Example 32 includes the subject matter of any one of Examples 1-31, and optionally, wherein the second surface comprises a center surface portion and a side surface portion, wherein the side surface portion has a concave shape in a direction towards the eye, and the center surface portion has a concave shape or a convex shape in the direction towards the eye.
Example 33 includes the subject matter of Example 32, and optionally, wherein a curvature radius of the center portion of the second surface is between 13-80 millimeters.
Example 34 includes the subject matter of any one of Examples 1-33, and optionally, comprising a central lens configured to direct light from a first display to the eye of the user, and a peripheral lens configured to direct light from a second display to the eye of the user, wherein at least one of the central lens or the peripheral lens comprises the catadioptric lens.
Example 35 includes the subject matter of Example 34, and optionally, wherein a first near-eye surface of the central lens and a second near-eye surface of the peripheral lens form a continuous surface.
Example 36 includes the subject matter of Example 34 or 35, comprising a baffle between the central lens and the peripheral lens.
Example 37 includes the subject matter of any one of Examples 34-36, and optionally, wherein the peripheral lens comprises a Fresnel lens.
Example 38 includes the subject matter of any one of Examples 34-37, and optionally, wherein an optical axis of the central lens is tilted towards the temporal direction by a tilting angle with respect to a direct gaze of the eye, wherein the tilting angle is greater than 0.5 degrees.
Example 39 includes the subject matter of any one of Examples 34-38, and optionally, wherein an angle between an optical axis of the central lens and a stitching line between the central lens and the peripheral lens as measured from the eye rotation center, is substantially equal to an angle between an optical axis of the peripheral lens and the stitching line between the central lens and the peripheral lens as measured from the eye rotation center.
Example 40 includes the subject matter of any one of Examples 1-39, and optionally, wherein the retarder comprises a Quarter Wave Plate (QWP) retarder.
Example 41 includes the subject matter of any one of Examples 1-40, and optionally, wherein the catadioptric lens comprises a first lens and a second lens, wherein the retarder is between the first lens and the second lens, and wherein the retarder comprises folded or corrugated edges between inner surfaces of the first lens and the second lens.
Example 42 includes the subject matter of any one of Examples 1-40, and optionally, wherein the catadioptric lens comprises a first lens and a second lens, wherein the retarder is between the first lens and the second lens, and wherein the retarder comprises radial cuts on edges of the retarder, the radial cuts are bended between inner surfaces of the first lens and the second lens.
Example 43 includes the subject matter of any one of Examples 1-42, and optionally, wherein reflectivity or transmissivity of the first surface is based on at least one of a first angle of incidence of light from the display with respect to the first surface, or a second angle of incidence of light from the second surface to the first surface with respect to the first surface.
Example 44 includes the subject matter of any one of Examples 1-43, and optionally, wherein a first inter-surface distance of the catadioptric folder at a particular distance from the central axis is less than 99% of a second inter-surface distance of the catadioptric folder at the central axis of the catadioptric lens.
Example 45 includes the subject matter of any one of Examples 1-44, and optionally, wherein the first and second surfaces are configured such that, over at least 20% of the catadioptric folder, the inter-surface distance of the catadioptric folder is monotonically decreasing with the distance from the central axis.
Example 46 includes the subject matter of any one of Examples 1-45, and optionally, wherein the first and second surfaces are configured such that, over at least 50% of the catadioptric folder, the inter-surface distance of the catadioptric folder is monotonically decreasing with the distance from the central axis.
Example 47 includes the subject matter of any one of Examples 1-46, and optionally, wherein the first and second surfaces are configured such that, over at least 80% of the catadioptric folder, the inter-surface distance of the catadioptric folder is monotonically decreasing with the distance from the central axis.
Example 48 includes the subject matter of any one of Examples 1-47, and optionally, wherein the first and second surfaces are configured such that, over at least 90% of the catadioptric folder, the inter-surface distance of the catadioptric folder is monotonically decreasing with the distance from the central axis.
Example 49 includes the subject matter of any one of Examples 1-48, and optionally, wherein the catadioptric lens is configured to provide a substantially zero obstruction in a mixed-reality Field of View (FoV).
Example 50 includes the subject matter of any one of Examples 1-49, and optionally, wherein the catadioptric lens is configured to provide a mixed-reality Field of View (FoV), the mixed-reality FoV comprising a first FoV and a second FoV, the second FoV is adjacent to the first FoV, wherein the catadioptric lens is configured to direct to the eye light of an image from the display in the first FoV, and to direct to the eye a real image in the second FoV, wherein a transition area between the first FoV and the second FoV is configured to provide the mixed-reality FoV with substantially zero obstruction.
Example 51 includes a Head Mounted Display (HMD) device comprising a display; a controller to control images to be displayed by the display; and the apparatus of any one of Examples 1-50.
Example 52 includes an apparatus comprising means for performing any of the described operations of Examples 1-50.
Example 53 includes a method comprising any of the described operations of Examples 1-50.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

1. An apparatus comprising:
a catadioptric lens configured to direct light from a display to an eye of a user, the catadioptric lens comprising:
a catadioptric folder configured to fold an optical path of the catadioptric lens, the catadioptric folder comprising:
a first surface comprising a semi-reflective surface;
a second surface comprising a reflective polarizer surface, the second surface opposite to the first surface; and
a retarder between the first surface and the second surface, the retarder configured to convert a polarization of the light in a path between the first surface and the second surface,
wherein the first and second surfaces are configured such that, over at least 10% of the catadioptric folder, an inter-surface distance of the catadioptric folder is monotonically decreasing with a distance from a central axis of the catadioptric lens.

2. The apparatus of claim 1, wherein the inter-surface distance of the catadioptric folder at a particular distance from the central axis is based on a distance between a first point and a second point, wherein the first point comprises a point on the first surface at the particular distance from the central axis, wherein the second point comprises a point on the second surface at the particular distance from the central axis, wherein the central axis, the first point and the second point are located in the same geometrical plane.

3. The apparatus of claim 1, wherein the inter-surface distance of the catadioptric folder at a particular distance from the central axis is based on a distance between a first point and a second point, wherein the second point comprises a point on the second surface at the particular distance from the central axis, wherein the first point comprises a point of intersection between the first surface and a normal to the second surface at the second point.

4. The apparatus of claim 1, wherein a first inter-surface distance of the catadioptric folder at a first distance from the central axis is longer than a second inter-surface distance of the catadioptric folder at a second distance from the central axis, the first distance is shorter than the second distance.

5. The apparatus of claim 1, wherein a Peripheral Eye Relief (PER) of the catadioptric lens at a particular distance from the central axis of the catadioptric lens is shorter than a Central Eye Relief (CER) of the catadioptric lens at the central axis of the catadioptric lens.

6. The apparatus of claim 1, wherein the first and second surfaces are configured such that an optical path length inside the catadioptric folder, over at least 10% of the catadioptric folder, is monotonically decreasing with the distance from the central axis.

7. The apparatus of claim 1, wherein the first and second surfaces are configured such that a focal length of the catadioptric lens, over at least 10% of the catadioptric folder, is monotonically decreasing with the distance from the central axis.

8. The apparatus of claim 1, wherein the first and second surfaces are configured such that a number of Pixels PerDegree (PPD) of the catadioptric lens, over at least 10% of the catadioptric folder, is monotonically decreasing with the distance from the central axis.

9. The apparatus of claim 1, wherein the catadioptric lens comprises one or more biconic optical surfaces or freeform optical surfaces, such that there are two mutually orthogonal planes which include the central axis of the lens, and the lens has a symmetry relative to any of the two mutually orthogonal planes.

10. (canceled)

11. The apparatus of claim 1, wherein the first surface is configured to reflect light of a first-handedness circular polarization from a first direction into light of a second-handedness circular polarization in a second direction, wherein the first direction is from the second surface to the first surface and the second direction is from the first surface to the second surface, the second-handedness circular polarization is orthogonal to the first-handedness circular polarization, wherein the second surface is configured to reflect light of a first linear polarization from the second direction to the first direction and to transfer light of a second linear polarization in the second direction, the second linear polarization is orthogonal to the first linear polarization, wherein the retarder is configured to convert the light of the first linear polarization into the light of the first-handedness circular polarization in the first direction, and to convert the light of the second-handedness circular polarization into the light of the second linear polarization in the second direction.

12. The apparatus of claim 11, wherein the first surface is configured to transfer light from the second direction having the first-handedness circular polarization, and wherein the retarder is configured to convert the light from the second direction having the first-handedness circular polarization into the light of the first linear polarization in the second direction.

13. The apparatus of claim 1, wherein the catadioptric folder comprises a Diffractive Optical Element (DOE) between the first surface and the second surface.

14. The apparatus of claim 1, wherein the catadioptric folder comprises a segmented dioptric adjuster between the first surface and the second surface, wherein the segmented dioptric adjuster is configured to apply a plurality of diopter adjustments to a respective plurality of segments of the optical path, wherein the plurality of diopter adjustments comprise at least first and second different diopter adjustments.

15. (canceled)

16. (canceled)

17. (canceled)

18. (canceled)

19. The apparatus of claim 1 comprising one or more reflectors at a peripheral area outside the optical path of the catadioptric lens, the one or more reflectors configured to reflect towards the display reflected light from the first surface, wherein the reflected light from the first semi-reflective surface comprises a portion of the light from the display, which is reflected by the semi-reflective surface.

20. The apparatus of claim 1, wherein a cutting line of the catadioptric lens is external to a central nasal rotation catadioptric box enclosing a folded portion of a chief ray optical path of peripheral vision folded between the first surface and the second surface, wherein the chief ray optical path is associated with a maximal nasal rotation peripheral sensation angle.

21. (canceled)

22. The apparatus of claim 1, wherein a cutting line of the catadioptric lens is external to a side temporal rotation catadioptric box enclosing a folded portion of a maximal-rotation optical path folded between the first surface and the second surface, wherein the maximal-rotation optical path is associated with a maximal temporal rotation peripheral sensation angle.

23. The apparatus of claim 1 comprising a first catadioptric lens and a second catadioptric lens, wherein a cutting line of the first catadioptric lens is external to a central nasal rotation catadioptric box of the first catadioptric lens enclosing a folded portion of a chief ray optical path of peripheral vision folded between a first surface of the first catadioptric lens and a second surface of the first catadioptric lens, wherein the chief ray optical path is associated with a maximal nasal rotation peripheral sensation angle, wherein a cutting line of the second catadioptric lens is external to a side temporal rotation catadioptric box of the second catadioptric lens enclosing a folded portion of a maximal-rotation optical path folded between a first surface of the second catadioptric lens and a second surface of the second catadioptric lens, wherein the maximal-rotation optical path is associated with a maximal temporal rotation peripheral sensation angle, wherein the chief ray optical path and the maximal-rotation optical path intersect at a point, which is based on the cutting line of the first catadioptric lens and the cutting line of the second catadioptric lens.

24. The apparatus of claim 1, wherein the catadioptric lens comprises a first lens and a second lens, wherein the semi-reflective surface comprises a surface of the first lens, and the reflective polarizer surface comprises a surface of the second lens.

25. The apparatus of claim 1, wherein the catadioptric folder is formed by a single lens, wherein the semi-reflective surface comprises a first surface of the single lens, the reflective polarizer surface comprises a second surface of the single lens opposite to the first surface of the single lens, wherein the retarder comprises a retarder layer between the semi-reflective surface and the reflective polarizer surface.

26. The apparatus of claim 1, wherein the second surface comprises a center surface portion and a side surface portion, wherein the side surface portion has a concave shape in a direction towards the eye, and the center surface portion has a concave shape or a convex shape in the direction towards the eye.

27. The apparatus of claim 1 comprising a central lens configured to direct light from a first display to the eye of the user, and a peripheral lens configured to direct light from a second display to the eye of the user, wherein at least one of the central lens or the peripheral lens comprises the catadioptric lens.

28. (canceled)

29. (canceled)

30. (canceled)

31. (canceled)

32. The apparatus of claim 1, wherein the catadioptric lens comprises a first lens and a second lens, wherein the retarder is between the first lens and the second lens, and wherein the retarder comprises folded or corrugated edges between inner surfaces of the first lens and the second lens.

33. The apparatus of claim 1, wherein the catadioptric lens comprises a first lens and a second lens, wherein the retarder is between the first lens and the second lens, and wherein the retarder comprises radial cuts on edges of the retarder, the radial cuts are bended between inner surfaces of the first lens and the second lens.

34. The apparatus of claim 1, wherein reflectivity or transmissivity of the first surface is based on at least one of a first angle of incidence of light from the display with respect to the first surface, or a second angle of incidence of light from the second surface to the first surface with respect to the first surface.

35. (canceled)

36. The apparatus of claim 1, wherein the catadioptric lens is configured to provide a mixed-reality Field of View (FoV), the mixed-reality FoV comprising a first FoV and a second FoV, the second FoV is adjacent to the first FoV, wherein the catadioptric lens is configured to direct to the eye light of an image from the display in the first FoV, and to direct to the eye a real image in the second FoV, wherein a transition area between the first FoV and the second FoV is configured to provide the mixed-reality FoV with substantially zero obstruction.

37. A Head Mounted Display (HMD) comprising:
a display;
a controller to control images to be displayed by the display; and,
a catadioptric lens configured to direct light from the display to an eye of a user, the catadioptric lens comprising:
a catadioptric folder configured to fold an optical path of the catadioptric lens, the catadioptric folder comprising:
a first surface comprising a semi-reflective surface;
a second surface comprising a reflective polarizer surface, the second surface opposite to the first surface; and
a retarder between the first surface and the second surface, the retarder configured to convert a polarization of the light in a path between the first surface and the second surface,
wherein the first and second surfaces are configured such that, over at least 10% of the catadioptric folder, an inter-surface distance of the catadioptric folder is monotonically decreasing with a distance from a central axis of the catadioptric lens.

38. The HMD of claim 37, wherein the inter-surface distance of the catadioptric folder at a particular distance from the central axis is based on a distance between a first point and a second point, wherein the first point comprises a point on the first surface at the particular distance from the central axis, wherein the second point comprises a point on the second surface at the particular distance from the central axis, wherein the central axis, the first point and the second point are located in the same geometrical plane.
